(19) United States
(12) Patent Application Publication
(10) Pub. No.: US 2025/0269539 A1
(43) Pub. Date: Aug. 28, 2025

(54) CLUTTER TIDYING ROBOT FOR NON-STANDARD STORAGE LOCATIONS

(71) Applicants: Clutterbot NZ Limited, Lower Hutt (NZ); Clutterbot, Inc., Claymont, DE (US)

(72) Inventor: Justin David Hamilton, Wellington (NZ)

(73) Assignees: Clutterbot NZ Limited, Lower Hutt, OT (NZ); Clutterbot, Inc., Claymont, DE (US)

(21) Appl. No.: 19/065,432

(22) Filed: Feb. 27, 2025

Related U.S. Application Data
(63) Continuation of application No. 18/590,153, filed on Feb. 28, 2024.
(60) Provisional application No. 63/558,818, filed on Feb. 28, 2024.

(51) Int. Cl. B25J 11/00; B25J 13/08; G05D 1/223; G05D 1/246; G05D 101/20; G05D 105/10; G05D 107/40; G06T 7/10; G06T 7/73; G06V 10/75; G06V 10/94; G06V 20/40; G06V 20/50; G06V 20/70

(52) U.S. Cl. CPC B25J 11/008; B25J 13/089; G05D 1/223; G05D 1/2465; G06T 7/10; G06T 7/74; G06V 10/757; G06V 10/945; G06V 20/41; G06V 20/49; G06V 20/50; G06V 20/70; G05D 2101/20; G05D 2105/10; G05D 2107/40; G06T 2207/10016; G06T 2207/10028; G06T 2207/20092; G06T 2207/30244

(57) ABSTRACT

A method and computing apparatus are disclosed for allowing a tidying robot to organize objects into non-standard categories and deposit them at non-standard locations that match a user's needs. The tidying robot navigates an environment using cameras to map the type, size, and location of toys, clothing, obstacles, furniture, structural elements, and other objects. The robot comprises a neural network to determine the type, size, and location of objects based on input from a sensing system. An augmented reality view allows user interaction to refine and customize areas within the environment to be tidied, object categories, object home locations, and operational task rules controlling robot operations.

### CROSS-REFERENCE TO RELATED APPLICATIONS

This application claims the benefit of U.S. provisional patent application Ser. No. 63/558,818, filed on Feb. 28, 2024, and U.S. patent application Ser. No. 18/590,153, filed on Feb. 28, 2024, each of which is incorporated herein by reference in their entirety.

### BACKGROUND

Objects underfoot represent not only a nuisance but also a safety hazard. Thousands of people each year are injured in a fall at home. A floor cluttered with loose objects may represent a danger, but many people have limited time in which to address the clutter in their homes. Automated cleaning or tidying robots may represent an effective solution.

Tidying robots conventionally organize objects into standard categories based on an object's type and other attributes that may be determined with classification. However, users often want objects organized into non-standard categories that cannot be determined using simple classification. Conventional approaches using, for example, a deep learning model on an image to perform classification, object detection, or similar, may be insufficient to meet users' needs.

There is, therefore, a need for a robotic vacuum system capable of dealing with obstacles it encounters while traversing an area to be vacuumed, and capable of organizing into non-standard categories, thus supporting movement of objects to home locations that are more complex to access than may be possible for conventional solutions.

### BRIEF SUMMARY

A method is disclosed that includes initializing a global map of an environment to be tidied with bounded areas, navigating a tidying robot to a bounded area entrance, identifying static objects, moveable objects, and tidyable objects within the bounded area, identifying closed storage locations and open storage locations, performing an identifying feature inspection subroutine, performing a closed storage exploration subroutine, performing an automated organization assessment subroutine, developing non-standard location categories and non-standard location labels based on results from the identifying feature inspection subroutine, the closed storage exploration subroutine, and the automated organization assessment subroutine, adding the non-standard location labels to the global map, and applying the appropriate non-standard location labels as home location attributes for detected tidyable objects.

Also disclosed is a tidying robotic system, including a robot having a scoop, pusher pad arms with pusher pads, at least one of a hook on a rear edge of at least one pusher pad, a gripper arm with a passive gripper, and a gripper arm with an actuated gripper, at least one wheel or one track for mobility of the robot, robot cameras, a processor, and a memory storing instructions that, when executed by the processor, allow operation and control of the robot. The tidying robotic system further includes a robotic control system in at least one of the robot and a cloud server and logic to execute the disclosed method.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1A and FIG. 1B illustrate a tidying robot 100 in accordance with one embodiment. FIG. 1A shows a side view and FIG. 1B shows a top view.

FIG. 1C and FIG. 1D illustrate a simplified side view and top view of a chassis 102 of the tidying robot 100, respectively.

FIG. 2A and FIG. 2B illustrate a left side view and a top view of a base station 200, respectively, in accordance with one embodiment.

FIG. 3A illustrates a lowered scoop position and lowered pusher position 300a for the tidying robot 100 in accordance with one embodiment.

FIG. 3B illustrates a lowered scoop position and raised pusher position 300b for the tidying robot 100 in accordance with one embodiment.

FIG. 3C illustrates a raised scoop position and raised pusher position 300c for the tidying robot 100 in accordance with one embodiment.

FIG. 3D illustrates a tidying robot 100 with pusher pads extended 300d in accordance with one embodiment.

FIG. 3E illustrates a tidying robot 100 with pusher pads retracted 300e in accordance with one embodiment.

FIG. 4A illustrates a lowered scoop position and lowered pusher position 400a for the tidying robot 100 in accordance with one embodiment.

FIG. 4B illustrates a lowered scoop position and raised pusher position 400b for the tidying robot 100 in accordance with one embodiment.

FIG. 4C illustrates a raised scoop position and raised pusher position 400c for the tidying robot 100 in accordance with one embodiment.

FIG. 5A illustrates a lowered scoop position and lowered pusher position 500a for the tidying robot 100 in accordance with one embodiment.

FIG. 5B illustrates a lowered scoop position and raised pusher position 500b for the tidying robot 100 in accordance with one embodiment.

FIG. 5C illustrates a raised scoop position and raised pusher position 500c for the tidying robot 100 in accordance with one embodiment.

FIG. 6 illustrates a front dump action 700 for the tidying robot 100 in accordance with one embodiment.

FIG. 7 illustrates a tidying robot 100 performing a front dump in accordance with one embodiment.

FIG. 8 illustrates a tidying robotic system interaction 800 in accordance with one embodiment.

FIG. 9 illustrates a tidying robot 900 in accordance with one embodiment.

FIG. 10A-FIG. 10D illustrate a tidying robot interacting with drawers 1000 in accordance with one embodiment.

FIG. 11 illustrates a tidying robot 1100 in accordance with one embodiment.

FIG. 12 illustrates a tidying robot 1200 in accordance with one embodiment.

FIG. 13 illustrates a tidying robot 1100 in accordance with one embodiment.

FIG. 14 illustrates a tidying robot 1400 in accordance with one embodiment.

FIG. 15 illustrates a map configuration routine 1500 in accordance with one embodiment.

FIG. 16A illustrates a starting state for a floor map 1600 in accordance with one embodiment.

FIG. 16B illustrates a floor map 1600 with areas identified by a user in accordance with one embodiment.

FIG. 16C illustrates a floor map 1600 with rules established by a user in accordance with one embodiment.

FIG. 17 illustrates a non-standard location categorization routine 1700 in accordance with one embodiment.

FIG. 18 illustrates an identifying feature inspection subroutine 1800 in accordance with one embodiment.

FIG. 19 illustrates a closed storage exploration subroutine 1900 in accordance with one embodiment.

FIG. 20 illustrates an automated organization assessment subroutine 2000 in accordance with one embodiment.

FIG. 21A-FIG. 21E illustrate an obstruction placement procedure 2100 in accordance with one embodiment.

FIG. 22A-FIG. 22D illustrate a process for tidying tidyable objects from a table into a bin 2200 in accordance with one embodiment.

FIG. 23A-FIG. 23D illustrate a portable bin placement procedure 2300 in accordance with one embodiment.

FIG. 24A-FIG. 24C illustrate a process for emptying tidyable objects from a bin and sorting them on the floor 2400 in accordance with one embodiment.

FIG. 25 illustrates an embodiment of a robotic control system 2500 to implement components and process steps of the system described herein.

FIG. 26 illustrates sensor input analysis 2600 in accordance with one embodiment.

FIG. 27 illustrates an image processing routine 2700 in accordance with one embodiment.

FIG. 28 illustrates a video-feed segmentation routine 2800 in accordance with one embodiment.

FIG. 29 illustrates a static object identification routine 2900 in accordance with one embodiment.

FIG. 30 illustrates a movable object identification routine 3000 in accordance with one embodiment.

FIG. 31 illustrates a tidyable object identification routine 3100 in accordance with one embodiment.

FIG. 32A and FIG. 32B illustrate object identification with fingerprints 3200 in accordance with one embodiment.

FIG. 33 depicts a robotic control algorithm 3300 in accordance with one embodiment.

FIG. 34 illustrates an Augmented Reality (AR) user routine 3400 in accordance with one embodiment.

FIG. 35 illustrates a tidyable object home location identification routine 3500 in accordance with one embodiment.

FIG. 36A-FIG. 36I illustrate user interactions with an AR user interface 3600 in accordance with one embodiment.

FIG. 37 illustrates a robot operation state diagram 3700 in accordance with one embodiment.

FIG. 38 illustrates a routine 3800 in accordance with one embodiment.

FIG. 39 illustrates a basic routine 3900 in accordance with one embodiment.

FIG. 40 illustrates an action plan to move object(s) aside 4000 in accordance with one embodiment.

FIG. 41 illustrates an action plan to pick up objects in path 4100 in accordance with one embodiment.

FIG. 42 illustrates an action plan to drop object(s) at a drop location 4200 in accordance with one embodiment.

FIG. 43 illustrates an action plan to drive around object(s) 4300 in accordance with one embodiment.

FIG. 44 illustrates a capture process 4400 portion of the disclosed algorithm in accordance with one embodiment.

FIG. 45 illustrates a deposition process 4500 portion of the disclosed algorithm in accordance with one embodiment.

FIG. 46 illustrates a main navigation, collection, and deposition process 4600 in accordance with one embodiment.

FIG. 47 illustrates strategy steps for isolation strategy, pickup strategy, and drop strategy 4700 in accordance with one embodiment.

FIG. 48 illustrates process for determining an action from a policy 4800 in accordance with one embodiment.

FIG. 49 depicts a robotics system 4900 in accordance with one embodiment.

FIG. 50 depicts a robotic process 5000 in accordance with one embodiment.

FIG. 51 depicts another robotic process 5100 in accordance with one embodiment.

FIG. 52 depicts a state space map 5200 for a robotic system in accordance with one embodiment.

FIG. 53 depicts a robotic control algorithm 5300 for a robotic system in accordance with one embodiment.

FIG. 54 depicts a robotic control algorithm 5400 for a robotic system in accordance with one embodiment.

FIG. 55 illustrates a system environment 5500 in accordance with one embodiment.

FIG. 56 illustrates a computing environment 5600 in accordance with one embodiment.

FIG. 57 illustrates a set of functional abstraction layers 5700 in accordance with one embodiment.

### DETAILED DESCRIPTION

Embodiments of a robotic system are disclosed that operate a robot to navigate an environment using cameras to map the type, size, and location of toys, clothing, obstacles, and other objects. The robot comprises a neural network to determine the type, size, and location of objects based on input from a sensing system, such as images from a forward camera, a rear camera, forward and rear left/right stereo cameras, or other camera configurations, as well as data from inertial measurement unit (IMU), lidar, odometry, and actuator force feedback sensors. The robot chooses a specific object to pick up, performs path planning, and navigates to a point adjacent to and facing the target object. Actuated pusher pad arms move other objects out of the way and maneuver pusher pads to move the target object onto a scoop to be carried. The scoop tilts up slightly and, if needed, pusher pads may close in front to keep objects in place, while the robot navigates to the next location in the planned path, such as the deposition destination.

In some embodiments, the system may include a robotic arm to reach and grasp elevated objects and move them down to the scoop. A companion “portable elevator” robot may also be utilized in some embodiments to lift the main robot up onto countertops, tables, or other elevated surfaces, and then lower it back down onto the floor. Some embodiments may utilize an up/down vertical lift (e.g., a scissor lift) to change the height of the scoop when dropping items into a container, shelf, or other tall or elevated location.

Some embodiments may also utilize one or more of the following components:
Left/right rotating brushes on actuator arms that push objects onto the scoop.
An actuated gripper that grabs objects and moves them onto the scoop
A rotating wheel with flaps that push objects onto the scoop from above.
One servo or other actuator to lift the front scoop up into the air and another separate actuator that tilts the scoop forward and down to drop objects into a container
A variation on a scissor lift that lifts the scoop up and gradually tilts it backward as it gains height
Ramps on the container with the front scoop on a hinge so that the robot just pushes items up the ramp such that the objects drop into the container with gravity at the top of the ramp
A storage bin on the robot for additional carrying capacity such that target objects are pushed up a ramp into the storage bin instead of using a front scoop and the storage bin tilts up and back like a dump truck to drop items into a container

The robotic system may be utilized for automatic organization of surfaces where items left on the surface are binned automatically into containers on a regular schedule. In one specific embodiment, the system may be utilized to automatically neaten a children's play area (e.g., in a home, school, or business) where toys and/or other items are automatically returned to containers specific to different types of objects after the children are done playing. In other specific embodiments, the system may be utilized to automatically pick clothing up off the floor and organize the clothing into laundry basket(s) for washing, or to automatically pick up garbage off the floor and place it into a garbage bin or recycling bin(s), e.g., by type (plastic, cardboard, glass). Generally, the system may be deployed to efficiently pick up a wide variety of different objects from surfaces and may learn to pick up new types of objects.

A solution is disclosed that allows tidying robots such as are described above to organize objects into non-standard categories that match a user's needs. Examples of tasks based on non-standard categories that a user may wish the robot to perform may include:
Understanding ownership of objects such as what toys belong to what child and hence what bedroom those toys are to be placed in.
Understanding that users may want objects organized into non-standard categories that are not predefined such as having one bin for normal LEGO and one bin for pink LEGO.
Understanding what housewares belong in the kitchen and what housewares belong in the kids' play area as toys.
Understanding what objects are considered garbage, what objects are considered recycling, and what objects are to be placed in a bin for arts and crafts.
Understanding custom user-created categories such as keeping Disney princesses separate from other dolls or figurines.
Understanding how organizational systems may evolve over time such as placing snowman and Santa stuffed toys on a shelf in December, placing pumpkin and black cat stuffed toys on a shelf in October, or placing bunny rabbit stuffed toys on a shelf in April.
Understanding how some toys are to be left out for an activity while other toys are to be put away in a bin.
Understanding how some objects are to be left in a place that's accessible while putting other objects away in storage such as leaving out a set of clean clothing to wear the next day but putting most clean clothing away on a shelf or in the closet.
Understanding when it is to tidy and vacuum an area after people have gone away, and situations where it is to stop tidying and vacuuming if people enter the area. For example, tidying and vacuuming after dinner but stopping if people come back into the dining room for dessert.
Learning to tidy and organize based on non-standard object attributes such as organizing striped socks separate from graphic pattern socks, or organizing crochet stuffed animals separate from sewn plushies.

A map of an indoor environment is generated that detects and separates objects (including structural elements) into three high-level categories based on how they may be moved and interacted with:
Static Objects: The term “Static object” in this disclosure refers to elements of a scene that are not expected to change over time, typically because they are rigid and immovable. Some composite objects may be split into a movable part and a static part. Examples include door frames, bookshelves, walls, countertops, floors, couches, dining tables, etc.
Movable Objects: The term “Movable object” in this disclosure refers to elements of the scene that are not desired to be moved by the robot (e.g., because they are decorative, too large, or attached to something), but that may be moved or deformed in the scene due to human influence. Some composite objects may be split into a movable part and a static part. Examples include doors, windows, blankets, rugs, chairs, laundry baskets, storage bins, etc.
Tidyable Objects: The term “tidyable object” in this disclosure refers to elements of the scene that may be moved by the robot and put away in a home location. These objects may be of a type and size such that the robot may autonomously put them away, such as toys, clothing, books, stuffed animals, soccer balls, garbage, remote controls, keys, cellphones, etc.

In situations where part of an object is rigidly fixed in the environment but another part may move (e.g., an oven with an oven door or a bed with a blanket), then the static and movable parts may be considered separate objects. Generally, structural non-moving elements of an indoor environment may be considered static along with heavy furniture that cannot be easily moved by a human.

Tidyable objects may need to be of an appropriate size, shape, and material such that they may be picked up and manipulated by a tidying robot. They may need to be non-breakable. They may also need to not be attached to other objects in a way that prevents them from being moved around by the tidying robot in the environment. For example, a light switch or power button are not tidyable.

This framework of classifying objects (including structural elements) from a visually detected environment as being static, movable, or tidyable may be used during initial robot setup, robot configuration, and robot operation.
Initial Robot Setup: Users may use an app on their mobile device with an augmented reality (AR) user interface to map the environment and choose an organizational system for tidyable objects. A home location for a tidyable object may be set to be inside a specific movable object (such as a bin or a drawer), or the home location may be set relative to a static object (such as next to a bed).
Robot Configuration: Users may use an app on their mobile device with an AR user interface to modify the organizational system being used for tidyable objects, such as changing the home location for a tidyable object to be in a drawer instead of a bin.
Robot Operation: The robot may use static objects (including structural elements) to localize itself in the environment while understanding that movable objects and tidyable objects may change locations. The robot may pick up and move tidyable objects in the environment in order to bring them to a home location and may interact with movable objects in the environment, such as placing a tidyable object in a bin or a drawer.

As disclosed herein, a general purpose tidying robot may navigate within different bounded areas (i.e., rooms) in an environment to be tidied, and may inspect the objects it encounters. The tidying robot may also open closed storage locations, such as cabinets, drawers, wardrobes, cupboards, armoires, closets, etc., and may inspect the contents therein, whether lose or further contained within shelving or bins. In this manner the tidying robot may automatically determine non-standard tidying rules without need for manual input or human intervention. Such non-standard tidying rules may include robot-generated non-standard location labels, which may be applied to tidyable objects detected in the environment to be tidied for use as drop locations when the robot encounters the tidyable objects while it executes a tidying strategy.

For example, the tidying robot may open a cabinet, drawer, closet, etc., and remove objects from the closed storage location, including removing objects from shelves or removing bins from their storage locations in order to deposit their contents in a staging area. Such removed objects may be taken to this staging area, such as a counter top or a portion of the floor, so that the robot may inspect the objects, determine, assign, or reassign a home or drop location for each, and return the objects to the bins and or other locations in which they were found, including returning the bins to their original location.

Additionally, the robot may observe that the contents of a room, closed storage location, bin, etc., are in fact improperly organized (disorganized or under-organized). For example, the robot may detect when objects have simply been placed out of sight without adherence to a consistent organizational system. In such cases, the robot may determine a categorization system based on the inventory of tidyable objects it observes and the organizational locations available. The robot may be configured to use its organizational system in future tasks, or may be configured to present the system for user approval through a user interface, such as a mobile application. This operation may be of particular utility where a number of different types of tidyable objects are found on, in, or near a fixed number of shelves and/or bins, without suitable drop location attributes assigned. In such a case, object types may not exactly correspond with the fixed number of available storage locations. The robot so configured may be able to develop custom, non-standard categories for the tidyable objects and potential home locations in order to solve this organizational dilemma.

In one embodiment, the robot may be able to detect objects that might be damaged, expired, low-quality, underused, garbage, or lacking in practical value. Upon encountering such objects, the robot may be able to designate an home location appropriate to the amount, type, and condition of these objects. For example, infant clothing that is detected in a dresser drawer, and which may be determined to have not been used for a certain time period, or found alongside toddler clothing, etc., may be gathered into a bin designated for donations.

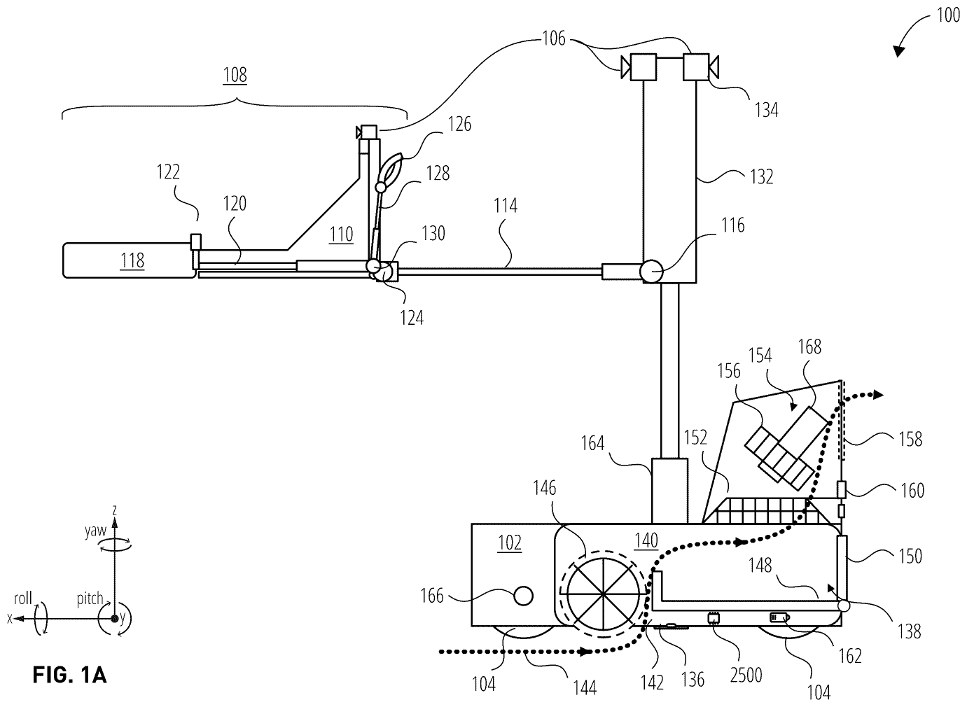

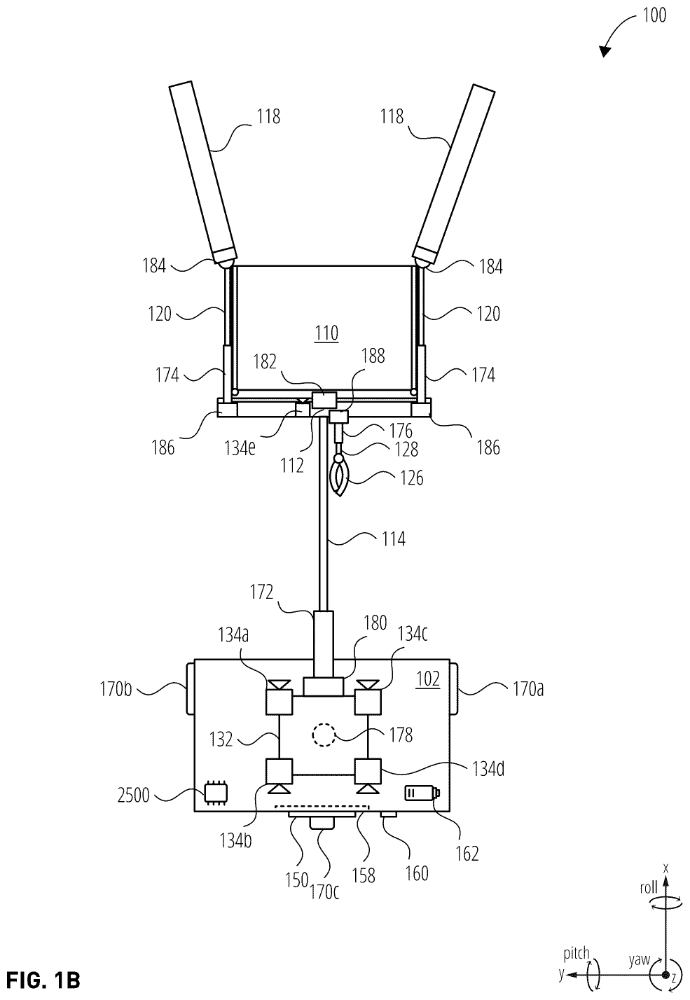

FIG. 1A-FIG. 1D illustrate a tidying robot 100 in accordance with one embodiment. FIG. 1A shows a side view and FIG. 1B shows a top view. The tidying robot 100 may comprise a chassis 102, a mobility system 104, a sensing system 106, a capture and containment system 108, and a robotic control system 2500. The capture and containment system 108 may further comprise a scoop 110, a scoop pivot point 112, a scoop arm 114, a scoop arm pivot point 116, two pusher pads 118 with pad pivot points 122, two pusher pad arms 120 with pad arm pivot points 124, an actuated gripper 126, a gripper arm 128 with a gripper pivot point 130, and a lifting column 132 to raise and lower the capture and containment system 108 to a desired height. In one embodiment, the gripper arm 128 may include features for gripping and/or gripping surfaces in lieu of or in addition to an actuated gripper 126.

The tidying robot 100 may further include a mop pad 136, and robot vacuum system 138. The robot vacuum system 138 may include a vacuum compartment 140, a vacuum compartment intake port 142, a cleaning airflow 144, a rotating brush 146, a dirt collector 148, a dirt release latch 150, a vacuum compartment filter 152, and a vacuum generating assembly 154 that includes a vacuum compartment fan 156, a vacuum compartment motor 168, and a vacuum compartment exhaust port 158. The tidying robot 100 may include a robot charge connector 160, a battery 162, and number of motors, actuators, sensors, and mobility components as described in greater detail below, and a robotic control system 2500 providing actuation signals based on sensor signals and user inputs.

The chassis 102 may support and contain the other components of the tidying robot 100. The mobility system 104 may comprise wheels as indicated, as well as caterpillar tracks, conveyor belts, etc., as is well understood in the art. The mobility system 104 may further comprise motors, servos, or other sources of rotational or kinetic energy to impel the tidying robot 100 along its desired paths. Mobility system 104 components may be mounted on the chassis 102 for the purpose of moving the entire robot without impeding or inhibiting the range of motion needed by the capture and containment system 108. Elements of a sensing system 106, such as cameras, lidar sensors, or other components, may be mounted on the chassis 102 in positions giving the tidying robot 100 clear lines of sight around its environment in at least some configurations of the chassis 102, scoop 110, pusher pad 118, and pusher pad arm 120 with respect to each other.

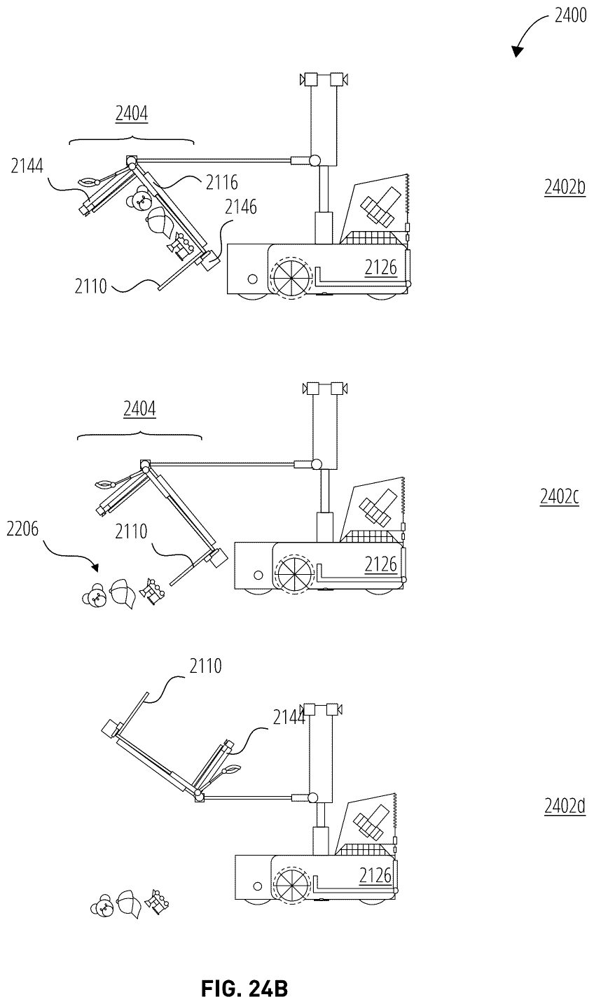

The chassis 102 may house and protect all or portions of the robotic control system 2500, (portions of which may also be accessed via connection to a cloud server) comprising in some embodiments a processor, memory, and connections to the mobility system 104, sensing system 106, and capture and containment system 108. The chassis 102 may contain other electronic components such as batteries 162, wireless communications 194 devices, etc., as is well understood in the art of robotics. The robotic control system 2500 may function as described in greater detail with respect to FIG. 25. The mobility system 104 and or the robotic control system 2500 may incorporate motor controllers used to control the speed, direction, position, and smooth movement of the motors. Such controllers may also be used to detect force feedback and limit maximum current (provide overcurrent protection) to ensure safety and prevent damage.

The capture and containment system 108 may comprise a scoop 110 with an associated scoop motor 182 to rotate the scoop 110 into different positions at the scoop pivot point 112. The capture and containment system 108 may also include a scoop arm 114 with an associated scoop arm motor 180 to rotate the scoop arm 114 into different positions around the scoop arm pivot point 116, and a scoop arm linear actuator 172 to extend the scoop arm 114. Pusher pads 118 of the capture and containment system 108 may have pusher pad motors 184 to rotate them into different positions around the pad pivot points 122. Pusher pad arms 120 may be associated with pusher pad arm motors 186 that rotate them around pad arm pivot points 124, as well as pusher pad arm linear actuators 174 to extend and retract the pusher pad arms 120. The gripper arm 128 may include a gripper arm motor 188 to move the gripper arm 128 around a gripper pivot point 130, as well as a gripper arm linear actuator 176 to extend and retract the gripper arm 128. In this manner the gripper arm 128 may be able to move and position itself and/or the actuated gripper 126 to perform the tasks disclosed herein.

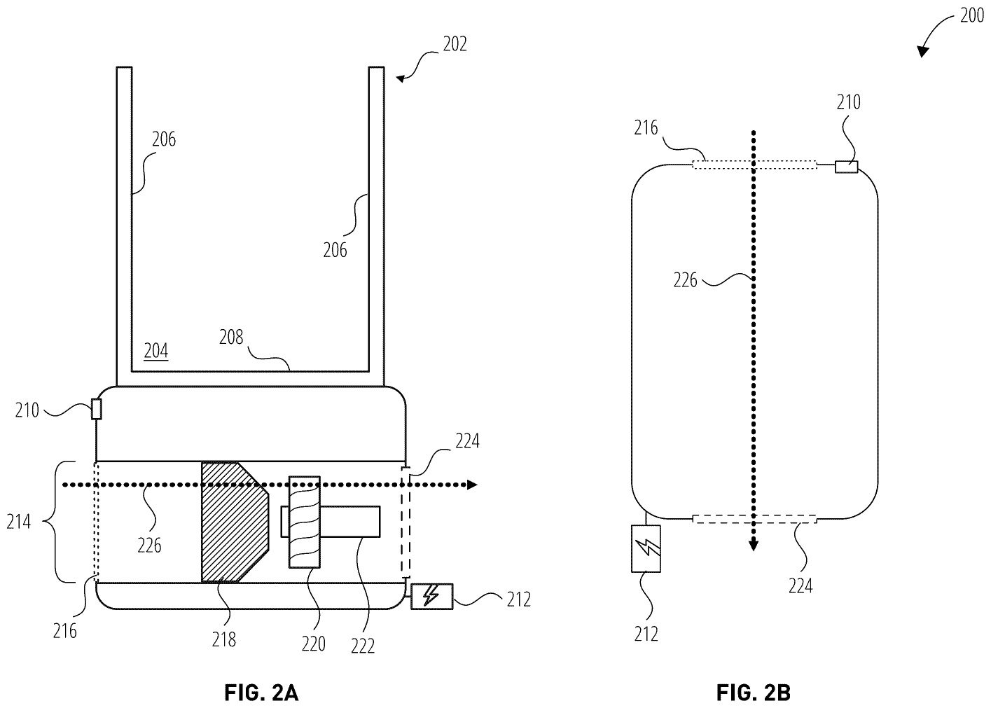

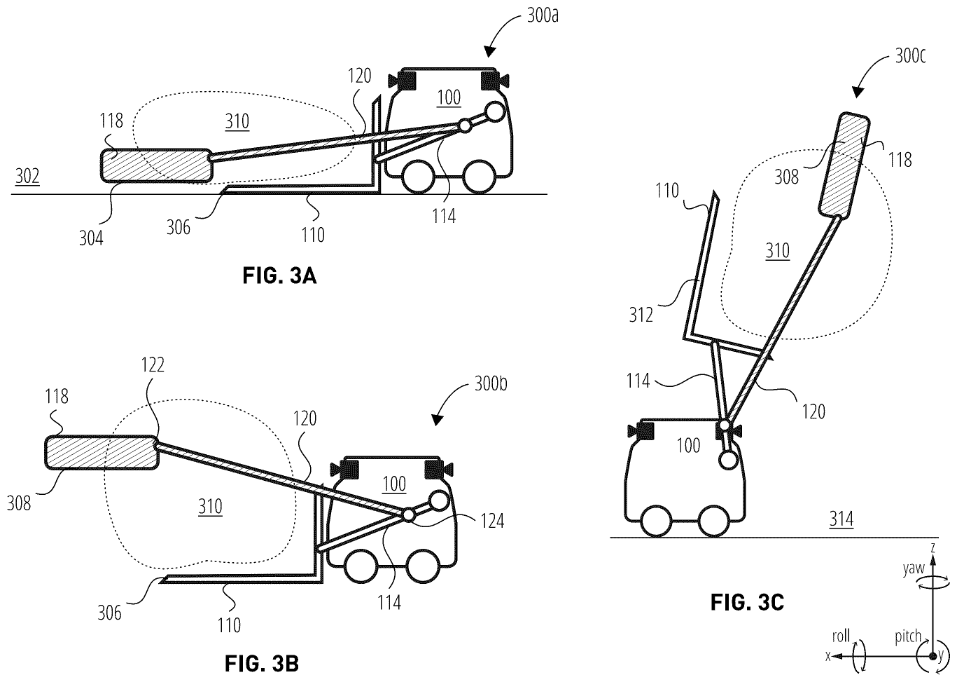

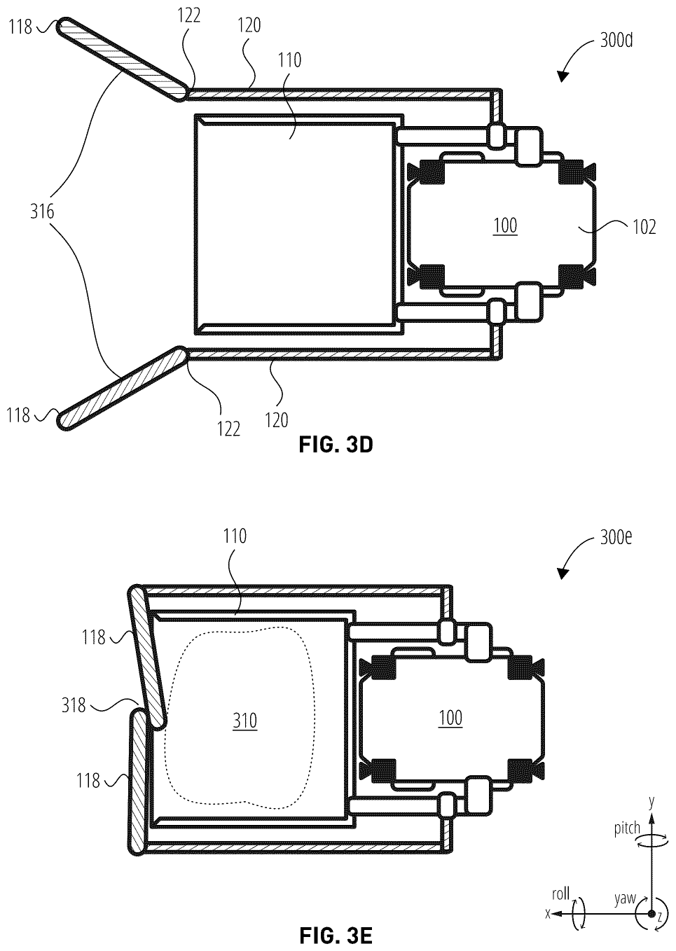

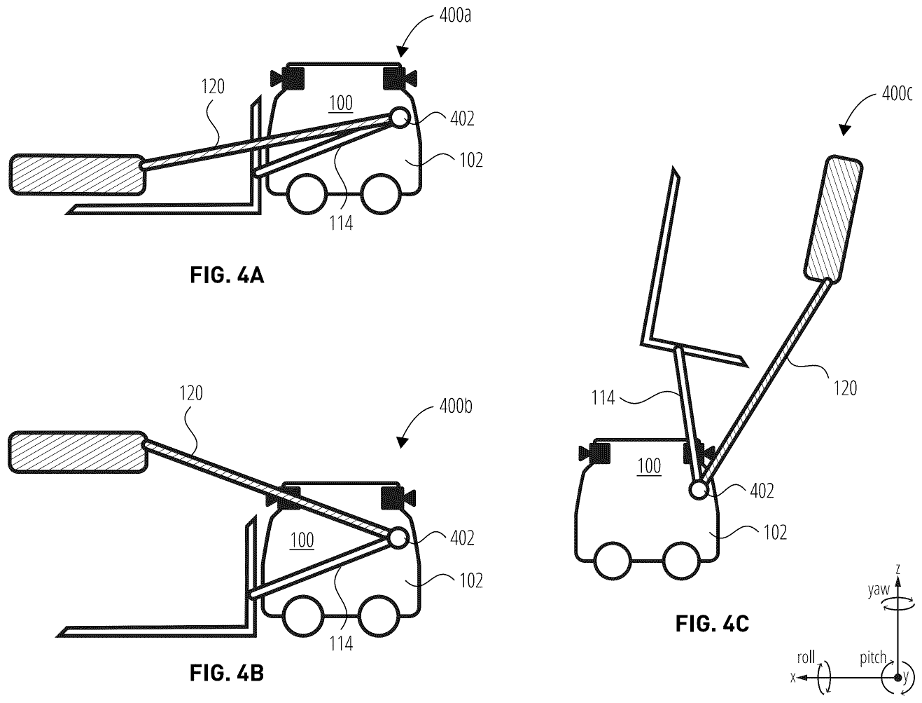

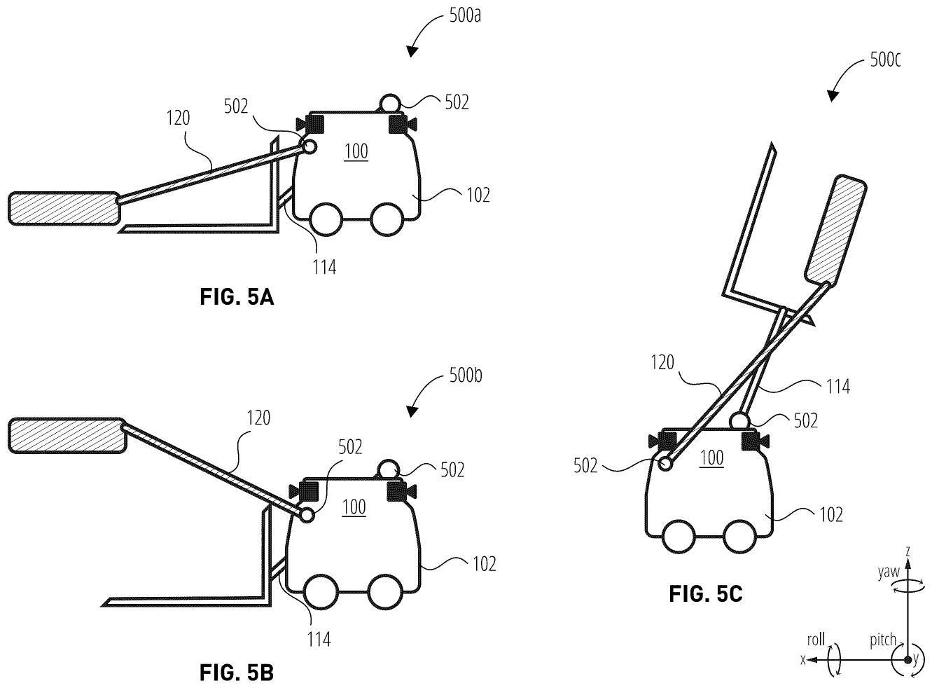

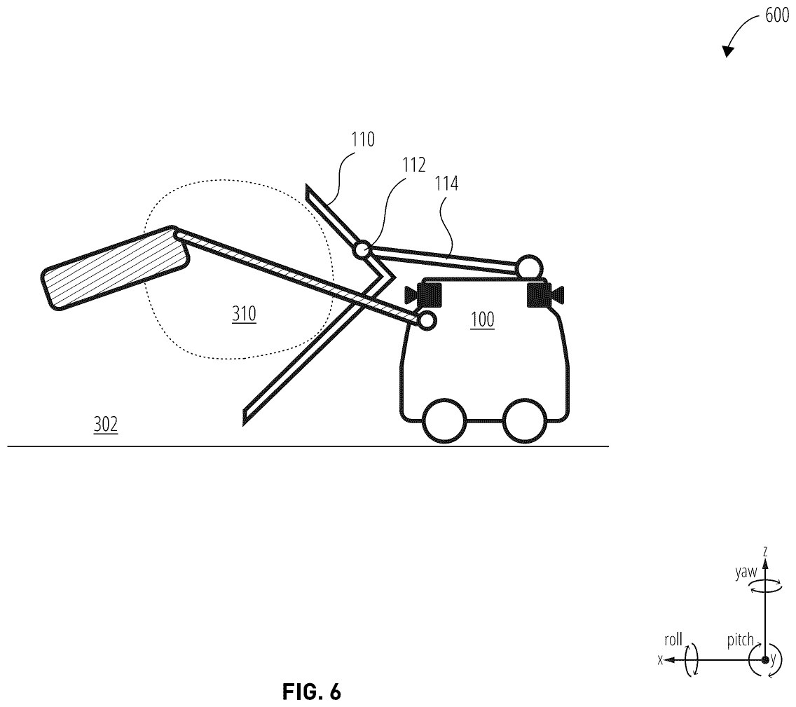

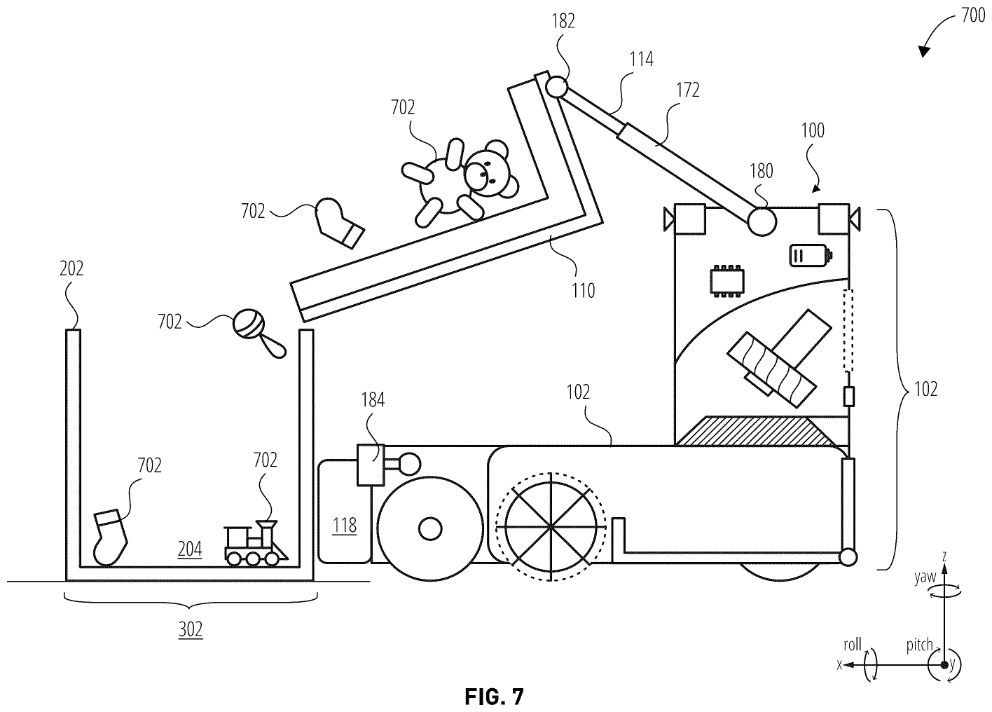

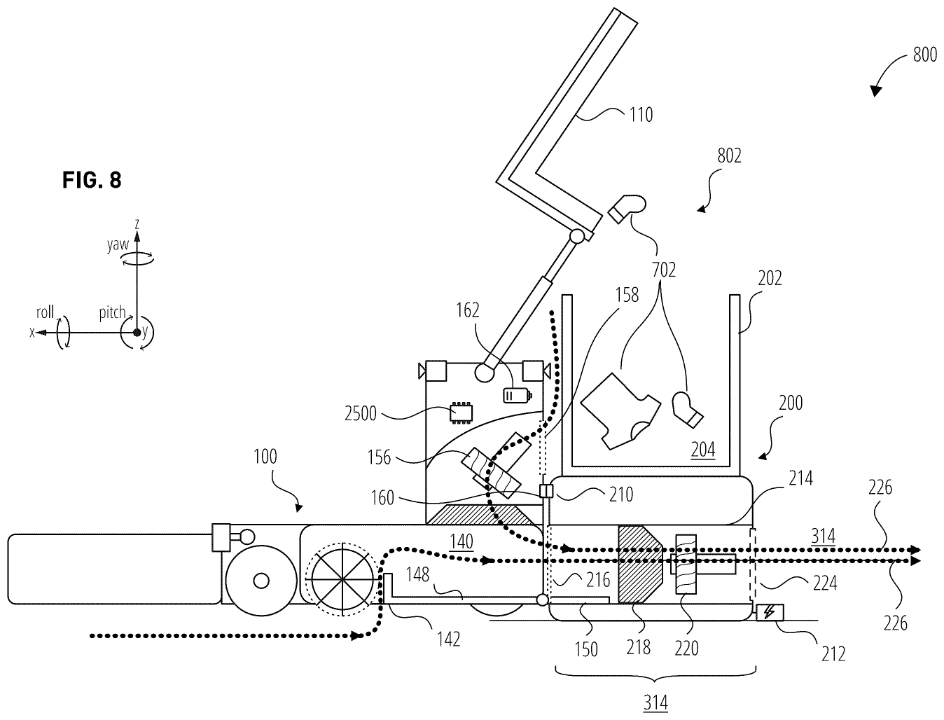

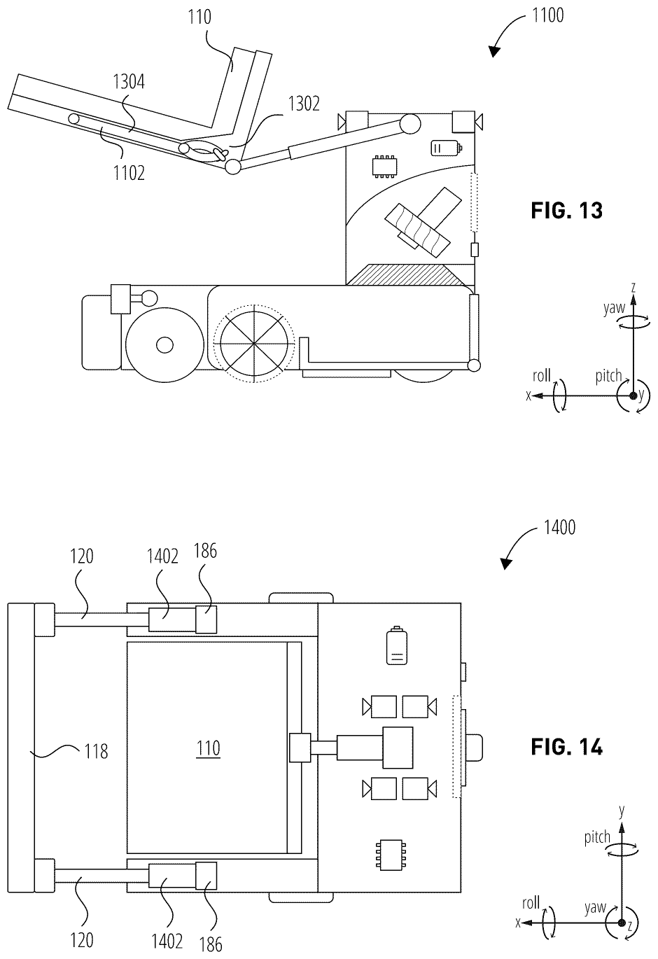

Points of connection shown herein between the scoop arms and pusher pad arms are exemplary positions and are not intended to limit the physical location of such points of connection. Such connections may be made in various locations as appropriate to the construction of the chassis and arms, and the applications of intended use. In some embodiments, the pusher pad arms 120 may attach to the scoop 110, as shown here. In other embodiments, the pusher pad arm 120 may attach to the chassis 102 as shown, for example, in FIG. 4A or FIG. 7. It will be well understood by one of ordinary skill in the art that the configurations illustrated may be designed to perform the basic motions described with respect to FIG. 3A-FIG. 8 and the processes illustrated elsewhere herein.

The geometry of the scoop 110 and the disposition of the pusher pads 118 and pusher pad arms 120 with respect to the scoop 110 may describe a containment area, illustrated more clearly in FIG. 3A-FIG. 3E, in which objects may be securely carried. Servos, direct current (DC) motors, or other actuators at the scoop arm pivot point 116, pad pivot points 122, and pad arm pivot points 124 may be used to adjust the disposition of the scoop 110, pusher pads 118, and pusher pad arms 120 between fully lowered scoop and pusher pad positions and raised scoop and pusher pad positions, as illustrated with respect to FIG. 3A-FIG. 3C.

In some embodiments, gripping surfaces may be configured on the sides of the pusher pads 118 facing inward toward objects to be lifted. These gripping surfaces may provide cushion, grit, elasticity, or some other feature that increases friction between the pusher pads 118 and objects to be captured and contained. In some embodiments, the pusher pad 118 may include suction cups in order to better grasp objects having smooth, flat surfaces. In some embodiments, the pusher pads 118 may be configured with sweeping bristles. These sweeping bristles may assist in moving small objects from the floor up onto the scoop 110. In some embodiments, the sweeping bristles may angle down and inward from the pusher pads 118, such that, when the pusher pads 118 sweep objects toward the scoop 110, the sweeping bristles form a ramp, allowing the foremost bristles to slide beneath the object, and direct the object upward toward the pusher pads 118, facilitating capture of the object within the scoop and reducing a tendency of the object to be pressed against the floor, increasing its friction and making it more difficult to move.

The capture and containment system 108, as well as some portions of the sensing system 106, may be mounted atop a lifting column 132, such that these components may be raised and lowered with respect to the ground to facilitate performance of complex tasks. A lifting column linear actuator 164 may control the elevation of the capture and containment system 108 by extending and retracting the lifting column 132. A lifting column motor 178 may allow the lifting column 132 to rotate so that the capture and containment system 108 may be moved with respect to the tidying robot 100 base or chassis 102 in all three dimensions.

The tidying robot 100 may include floor cleaning components such as a mop pad 136 and a vacuuming system. The mop pad 136 may be able to raise and lower with respect to the bottom of the tidying robot 100 chassis 102, so that it may be placed in contact with the floor when desired. The mop pad 136 may include a drying element to dry wet spots detected on the floor. In one embodiment, the tidying robot 100 may include a fluid reservoir, which may be in contact with the mop pad 136 and able to dampen the mop pad 136 for cleaning. In one embodiment, the tidying robot 100 may be able to spray cleaning fluid from a fluid reservoir onto the floor in front of or behind the tidying robot 100, which may then be absorbed by the mop pad 136.

The vacuuming system may include a vacuum compartment 140, which may have a vacuum compartment intake port 142 allowing cleaning airflow 144 into the vacuum compartment 140. The vacuum compartment intake port 142 may be configured with a rotating brush 146 to impel dirt and dust into the vacuum compartment 140. Cleaning airflow 144 may be induced to flow by a vacuum compartment fan 156 powered by a vacuum compartment motor 168. cleaning airflow 144 may pass through the vacuum compartment 140 from the vacuum compartment intake port 142 to a vacuum compartment exhaust port 158, exiting the vacuum compartment 140 at the vacuum compartment exhaust port 158. The vacuum compartment exhaust port 158 may be covered by a grating or other element permeable to cleaning airflow 144 but able to prevent the ingress of objects into the chassis 102 of the tidying robot 100.

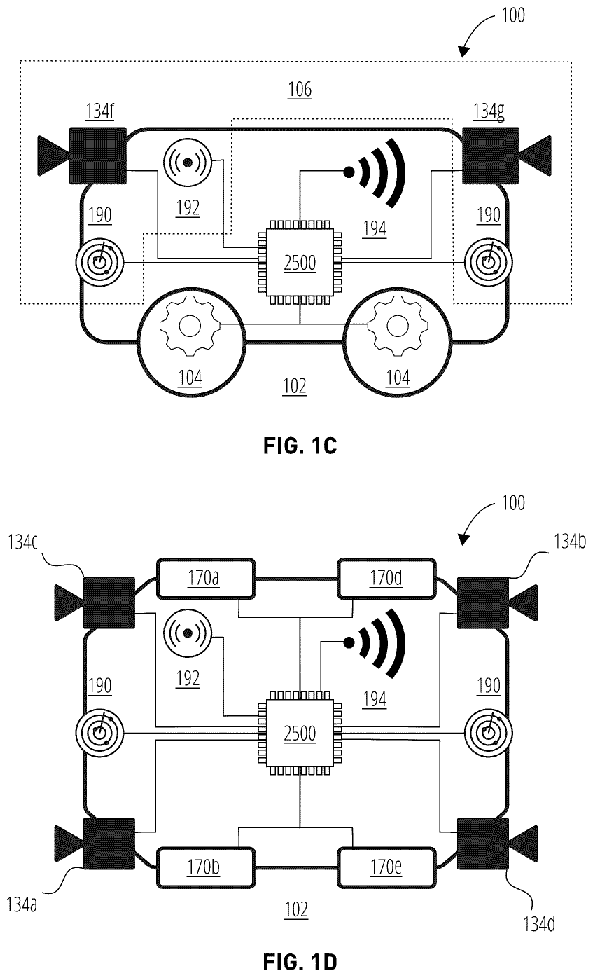

A vacuum compartment filter 152 may be disposed between the vacuum compartment intake port 142 and the vacuum compartment exhaust port 158. The vacuum compartment filter 152 may prevent dirt and dust from entering and clogging the vacuum compartment fan 156. The vacuum compartment filter 152 may be disposed such that blocked dirt and dust are deposited within a dirt collector 148. The dirt collector 148 may be closed off from the outside of the chassis 102 by a dirt release latch 150. The dirt release latch 150 may be configured to open when the tidying robot 100 is docked at a base station 200 with a vacuum emptying system 214, as is illustrated in FIG. 2A and FIG. 2B and described below. A robot charge connector 160 may connect the tidying robot 100 to a base station charge connector 210, allowing power from the base station 200 to charge the tidying robot 100 battery 162.

FIG. 1C and FIG. 1D illustrate a simplified side view and top view of a chassis 102, respectively, in order to show in more detail aspects of the mobility system 104, the sensing system 106, and the communications 194, in connection with the robotic control system 2500. In some embodiments, the communications 194 may include the network interface 2512 described in greater detail with respect to robotic control system 2500.

In one embodiment, the mobility system 104 may comprise a left front wheel 170b and a right front wheel 170a powered by mobility system motor 166, and a single rear wheel 170c, as illustrated in FIG. 1A and FIG. 1B. The single rear wheel 170c may be actuated or may be a passive roller or caster providing support and reduced friction with no driving force.

In one embodiment, the mobility system 104 may comprise a right front wheel 170a, a left front wheel 170b, a right rear wheel 170d, and a left rear wheel 170e. The tidying robot 100 may have front-wheel drive, where right front wheel 170a and left front wheel 170b are actively driven by one or more actuators or motors, while the right rear wheel 170d and left rear wheel 170e spin on an axle passively while supporting the rear portion of the chassis 102. In another embodiment, the tidying robot 100 may have rear-wheel drive, where the right rear wheel 170d and left rear wheel 170e are actuated and the front wheels turn passively. In another embodiment, the tidying robot 100 may have additional motors to provide all-wheel drive, may use a different number of wheels, or may use caterpillar tracks or other mobility devices in lieu of wheels.

The sensing system 106 may further comprise cameras 134 such as the front left camera 134a, rear left camera 134b, front right camera 134c, rear right camera 134d, and scoop camera 134c as illustrated in FIG. 1B. In one embodiment, the sensing system 106 may include a front camera 134f and a rear camera 134g. Other configurations of cameras 134 may be utilized. The sensing system 106 may further include light detecting and ranging (LIDAR) sensors such as lidar sensors 190 and inertial measurement unit (IMU) sensors, such as IMU sensors 192. In some embodiments, there may be a single front camera and a single rear camera. Additional sensors in support of the tidying robot 100 performing the actions disclosed herein may readily suggest themselves to one of ordinary skill in the art.

FIG. 2A and FIG. 2B illustrate a base station 200 in accordance with one embodiment. FIG. 2A shows a left side view and FIG. 2B shows a top view. The base station 200 may comprise an object collection bin 202 with a storage compartment 204 to hold tidyable objects, heavy dirt and debris, or other obstructions. The storage compartment 204 may be formed by bin sides 206 and a bin base 208. The term “tidyable object” in this disclosure refers to elements of the scene that may be moved by the robot and put away in a home location. These objects may be of a type and size such that the robot may autonomously put them away, such as toys, clothing, books, stuffed animals, soccer balls, garbage, remote controls, keys, cellphones, etc. The base station 200 may further comprise a base station charge connector 210, a power source connection 212, and a vacuum emptying system 214 including a vacuum emptying system intake port 216, a vacuum emptying system filter bag 218, a vacuum emptying system fan 220, a vacuum emptying system motor 222, and a vacuum emptying system exhaust port 224.

The object collection bin 202 may be configured on top of the base station 200 so that a tidying robot 100 may deposit objects from the scoop 110 into the object collection bin 202. The base station charge connector 210 may be electrically coupled to the power source connection 212. The power source connection 212 may be a cable connector configured to couple through a cable to an alternating current (AC) or direct current (DC) source, a battery, or a wireless charging port, as will be readily apprehended by one of ordinary skill in the art. In one embodiment, the power source connection 212 is a cable and male connector configured to couple with 120V AC power, such as may be provided by a conventional U.S. home power outlet.

The vacuum emptying system 214 may include a vacuum emptying system intake port 216 allowing vacuum emptying airflow 226 into the vacuum emptying system 214. The vacuum emptying system intake port 216 may be configured with a flap or other component to protect the interior of the vacuum emptying system 214 when a tidying robot 100 is not docked. A vacuum emptying system filter bag 218 may be disposed between the vacuum emptying system intake port 216 and a vacuum emptying system fan 220 to catch dust and dirt carried by the vacuum emptying airflow 226 into the vacuum emptying system 214. The vacuum emptying system fan 220 may be powered by a vacuum emptying system motor 222. The vacuum emptying system fan 220 may pull the vacuum emptying airflow 226 from the vacuum emptying system intake port 216 to the vacuum emptying system exhaust port 224, which may be configured to allow the vacuum emptying airflow 226 to exit the vacuum emptying system 214. The vacuum emptying system exhaust port 224 may be covered with a grid to protect the interior of the vacuum emptying system 214.

FIG. 3A illustrates a tidying robot 100 such as that introduced with respect to FIG. 1A disposed in a lowered scoop position and lowered pusher position 300a. In this configuration, the pusher pads 118 and pusher pad arms 120 rest in a lowered pusher position 304, and the scoop 110 and scoop arm 114 rest in a lowered scoop position 306 at the front 302 of the tidying robot 100. In this position, the scoop 110 and pusher pads 118 may roughly describe a containment area 310 as shown.

FIG. 3B illustrates a tidying robot 100 with a lowered scoop position and raised pusher position 300b. Through the action of servos or other actuators at the pad pivot points 122 and pad arm pivot points 124, the pusher pads 118 and pusher pad arms 120 may be raised to a raised pusher position 308 while the scoop 110 and scoop arm 114 maintain a lowered scoop position 306. In this configuration, the pusher pads 118 and scoop 110 may roughly describe a containment area 310 as shown, in which an object taller than the scoop 110 height may rest within the scoop 110 and be held in place through pressure exerted by the pusher pads 118.

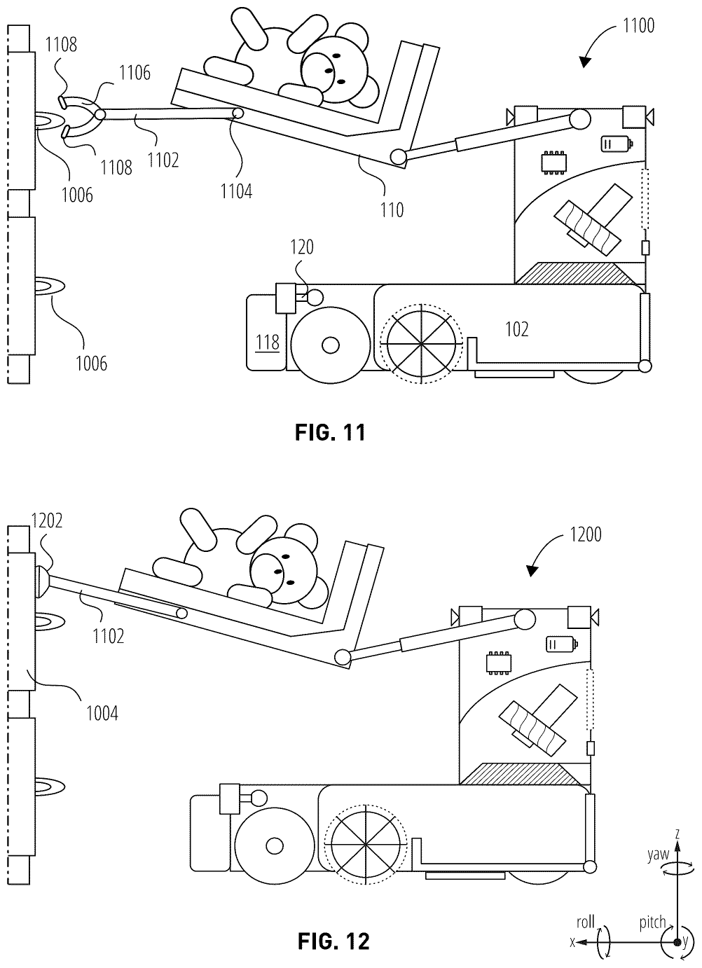

Pad arm pivot points 124, pad pivot points 122, scoop arm pivot points 116 and scoop pivot points 112 (as shown in FIG. 6) may provide the tidying robot 100 a range of motion of these components beyond what is illustrated herein. The positions shown in the disclosed figures are illustrative and not meant to indicate the limits of the robot's component range of motion.

FIG. 3C illustrates a tidying robot 100 with a raised scoop position and raised pusher position 300c. The pusher pads 118 and pusher pad arms 120 may be in a raised pusher position 308 while the scoop 110 and scoop arm 114 are in a raised scoop position 312. In this position, the tidying robot 100 may be able to allow objects drop from the scoop 110 and pusher pad arms 120 to an area at the rear 314 of the tidying robot 100.

The carrying position may involve the disposition of the pusher pads 118, pusher pad arms 120, scoop 110, and scoop arm 114, in relative configurations between the extremes of lowered scoop position and lowered pusher position 300a and raised scoop position and raised pusher position 300c.

FIG. 3D illustrates a tidying robot 100 with pusher pads extended 300d. By the action of servos or other actuators at the pad pivot points 122, the pusher pads 118 may be configured as extended pusher pads 316 to allow the tidying robot 100 to approach objects as wide or wider than the robot chassis 102 and scoop 110. In some embodiments, the pusher pads 118 may be able to rotate through almost three hundred and sixty degrees, to rest parallel with and on the outside of their associated pusher pad arms 120 when fully extended.

FIG. 3E illustrates a tidying robot 100 with pusher pads retracted 300e. The closed pusher pads 318 may roughly define a containment area 310 through their position with respect to the scoop 110. In some embodiments, the pusher pads 118 may be able to rotate farther than shown, through almost three hundred and sixty degrees, to rest parallel with and inside of the side walls of the scoop 110.

FIG. 4A-FIG. 4C illustrate a tidying robot 100 such as that introduced with respect to FIG. 1A. In such an embodiment, the pusher pad arms 120 may be controlled by a servo or other actuator at the same point of connection 402 with the chassis 102 as the scoop arms 114. The tidying robot 100 may be seen disposed in a lowered scoop position and lowered pusher position 400a, a lowered scoop position and raised pusher position 400b, and a raised scoop position and raised pusher position 400c. This tidying robot 100 may be configured to perform the algorithms disclosed herein.

The point of connection shown between the scoop arms 114/pusher pad arms 120 and the chassis 102 is an exemplary position and is not intended to limit the physical location of this point of connection. Such connection may be made in various locations as appropriate to the construction of the chassis 102 and arms, and the applications of intended use.

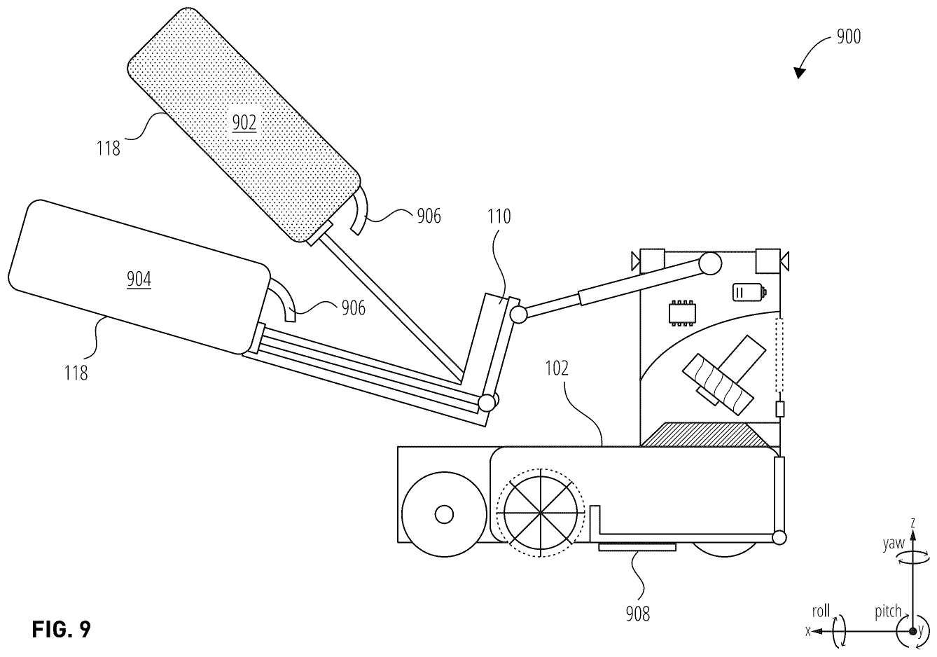

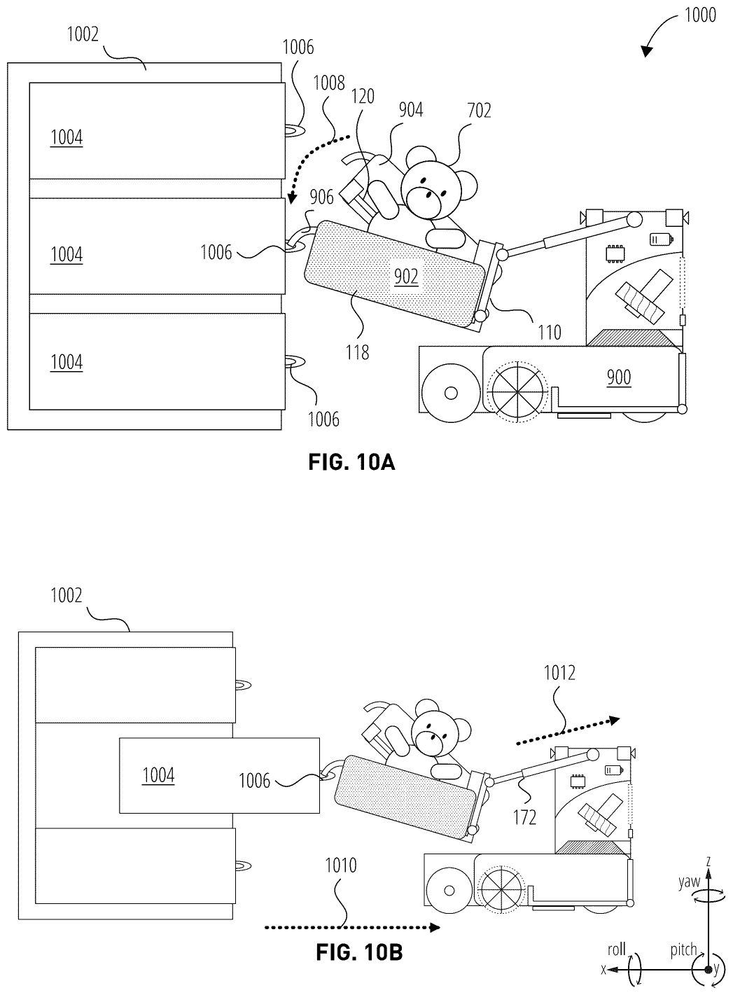

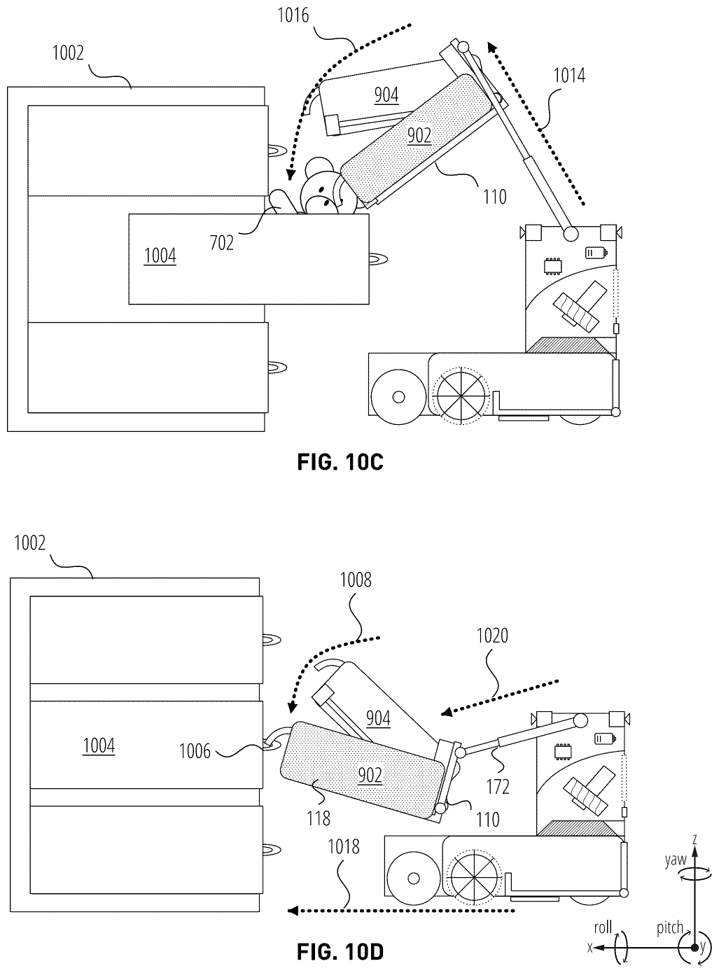

FIG. 5A-FIG. 5C illustrate a tidying robot 100 such as that introduced with respect to FIG. 1A. In such an embodiment, the pusher pad arms 120 may be controlled by a servo or servos (or other actuators) at different points of connection 502 with the chassis 102 from those controlling the scoop arm 114. The tidying robot 100 may be seen disposed in a lowered scoop position and lowered pusher position 500a, a lowered scoop position and raised pusher position 500b, and a raised scoop position and raised pusher position 500c. This tidying robot 100 may be configured to perform the algorithms disclosed herein.

The different points of connection 502 between the scoop arm and chassis and the pusher pad arms and chassis shown are exemplary positions and not intended to limit the physical locations of these points of connection. Such connections may be made in various locations as appropriate to the construction of the chassis and arms, and the applications of intended use.

FIG. 6 illustrates a tidying robot 100 such as was previously introduced in a front drop position 600. The arms of the tidying robot 100 may be positioned to form a containment area 310 as previously described.

The tidying robot 100 may be configured with a scoop pivot point 112 where the scoop 110 connects to the scoop arm 114. The scoop pivot point 112 may allow the scoop 110 to be tilted forward and down while the scoop arm 114 is raised, allowing objects in the containment area 310 to slide out and be deposited in an area to the front 302 of the tidying robot 100.

FIG. 7 illustrates how the positions of the components of the tidying robot 100 may be configured such that the tidying robot 100 may approach an object collection bin 202 and perform a front dump action 700. The scoop 110 may be raised by scoop arm motor 180, extended by scoop arm linear actuator 172, and tilted by scoop motor 182 so that tidyable objects 702 carried in the scoop 110 may be deposited into the storage compartment 204 of the object collection bin 202 positioned to the front 302 of the tidying robot 100, as is also described with respect to the front drop position 600 of FIG. 6.

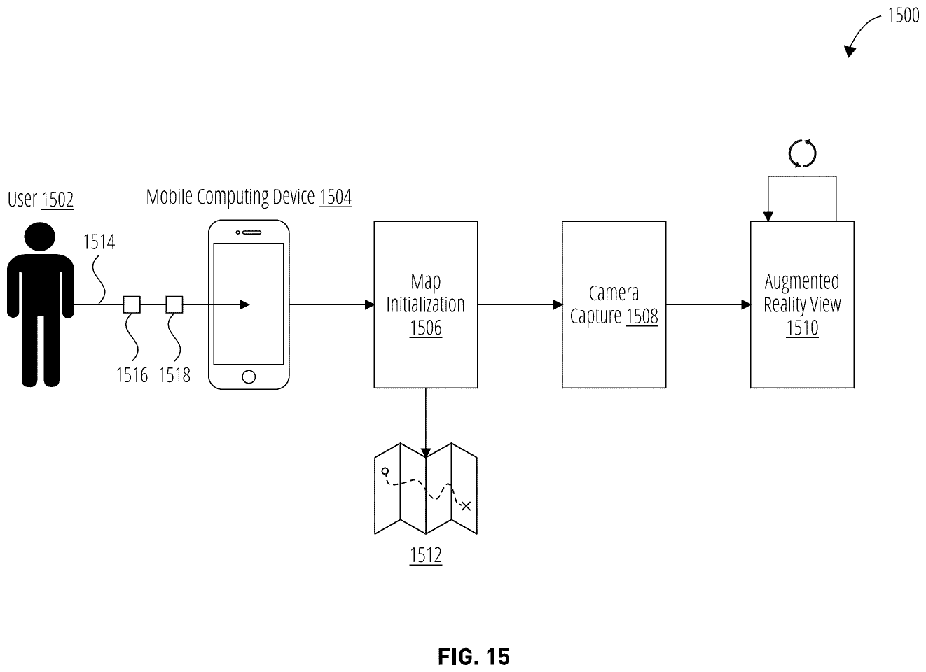

FIG. 8 illustrates a tidying robotic system interaction 800 in accordance with one embodiment. The tidying robotic system may include the tidying robot 100, the base station 200, a robotic control system 2500, and logic 2514 that when executed directs the robot to perform the disclosed method. When the tidying robot 100 is docked at a base station 200 having an object collection bin 202, the scoop 110 may be raised and rotated up and over the tidying robot 100 chassis 102, allowing tidyable objects 702 in the scoop 110 to drop into the storage compartment 204 of the object collection bin 202 to the rear 314 of the tidying robot 100 in a rear dump action 802, as is also described with respect to the raised scoop position and raised pusher position 300c and raised scoop position and raised pusher position 400c described with respect to FIG. 3C and FIG. 4C, respectively.

In a docked state, the robot charge connector 160 may electrically couple with the base station charge connector 210 such that electrical power from the power source connection 212 may be carried to the battery 162, and the battery 162 may be recharged toward its maximum capacity for future use.

When the tidying robot 100 docks at its base station 200, the dirt release latch 150 may lower, allowing the vacuum compartment 140 to interface with the vacuum emptying system 214. Where the vacuum emptying system intake port 216 is covered by a protective element, the dirt release latch 150 may interface with that element to open the vacuum emptying system intake port 216 when the tidying robot 100 is docked. The vacuum compartment fan 156 may remain inactive or may reverse direction, permitting or compelling vacuum emptying airflow 226 through the vacuum compartment exhaust port 158, into the vacuum compartment 140, across the dirt collector 148, over the dirt release latch 150, into the vacuum emptying system intake port 216, through the vacuum emptying system filter bag 218, and out the vacuum emptying system exhaust port 224, in conjunction with the operation of the vacuum emptying system fan 220. The action of the vacuum emptying system fan 220 may also pull vacuum emptying airflow 226 in from the vacuum compartment intake port 142, across the dirt collector 148, over the dirt release latch 150, into the vacuum emptying system intake port 216, through the vacuum emptying system filter bag 218, and out the vacuum emptying system exhaust port 224. In combination, vacuum emptying airflow 226 and vacuum emptying airflow 226 may pull dirt and dust from the dirt collector 148 into the vacuum emptying system filter bag 218, emptying the dirt collector 148 for future vacuuming tasks. The vacuum emptying system filter bag 218 may be manually discarded and replaced on a regular basis.

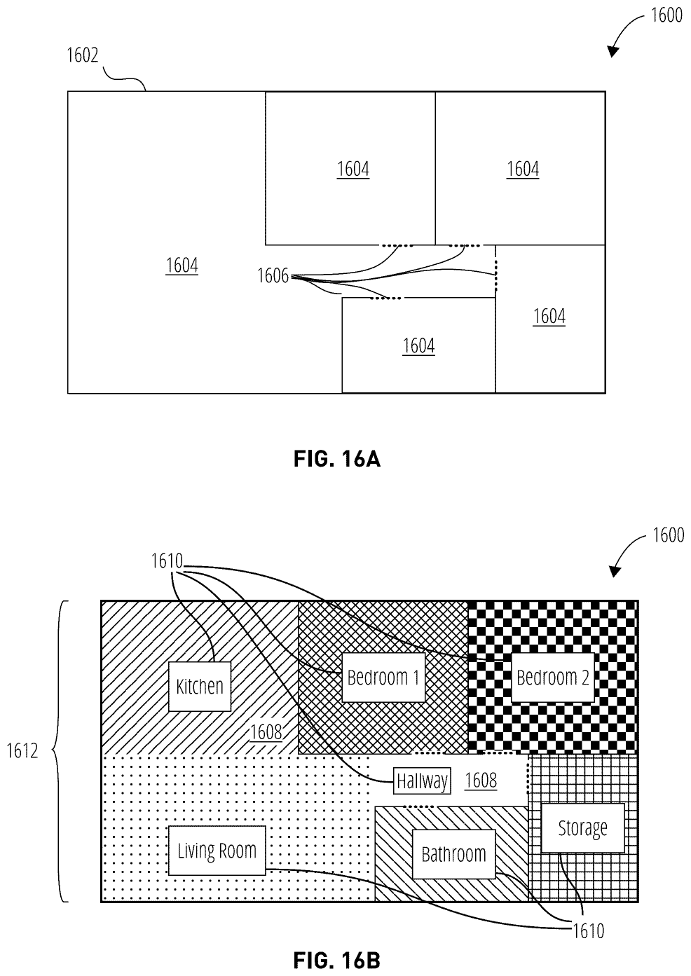

FIG. 9 illustrates a tidying robot 900 in accordance with one embodiment. The tidying robot 900 may be configured as described previously with respect to the tidying robot 100 introduced with respect to FIG. 1A. In addition, the tidying robot 900 may also include hooks 906 attached to its pusher pads 118 and a mop pad 908.

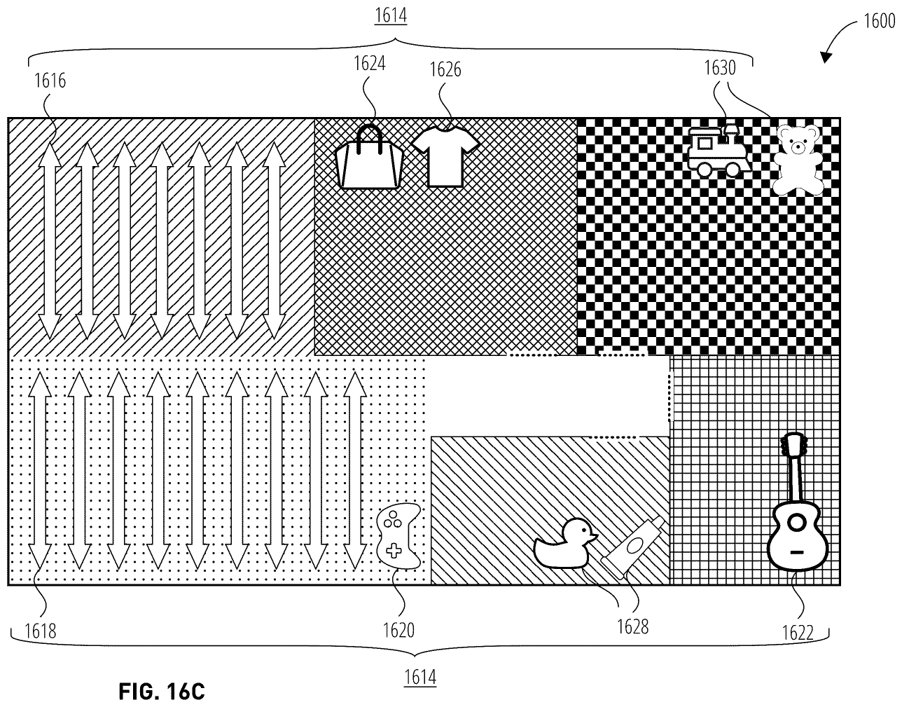

In one embodiment, the pusher pads 118 may be attached to the back of the scoop 110 as shown, instead of being attached to the chassis 102 of the tidying robot 900. There may be a hook on each of the pusher pads 118 such that, when correctly positioned, the hook 906 may interface with a handle in order to open or close a drawer, as illustrated with respect to FIG. 10A-FIG. 10D. Alternatively, there may be an actuated gripper on the back of the pusher arms that may similarly be used to grasp a handle to open or close drawers. When the pusher pads 118 are being used to push or sweep objects into the scoop 110, the pusher pad inner surfaces 902 may be oriented inward, as indicated by pusher pad inner surface 902 (patterned) and pusher pad outer surface 904 (solid) as illustrated in FIG. 9, keeping the hooks 906 from impacting surrounding objects. When the hooks 906 are needed, the pusher pads 118 may fold out and back against the scoop such that the solid pusher pad outer surfaces 904 face inward, the patterned pusher pad inner surfaces 902 face outward, and the hooks are oriented forward for use, as shown in FIG. 10A.

In one embodiment, the tidying robot 900 may include a mop pad 908 that may be used to mop a hard floor such as tile, vinyl, or wood during the operation of the tidying robot 900. The mop pad 908 may be a fabric mop pad that may be used to mop the floor after vacuuming. The mop pad 908 may be removably attached to the bottom of the tidying robot 900 chassis 102 and may need to be occasionally removed and washed or replaced when dirty.

In one embodiment, the mop pad 908 may be attached to an actuator to raise and lower it onto and off of the floor. In this way, the tidying robot 900 may keep the mop pad 908 raised during operations such as tidying objects on carpet, but may lower the mop pad 908 when mopping a hard floor. In one embodiment, the mop pad 908 may be used to dry mop the floor. In one embodiment, the tidying robot 900 may be able to detect and distinguish liquid spills or sprayed cleaning solution and may use the mop pad 908 to absorb spilled or sprayed liquid. In one embodiment, a fluid reservoir may be configured within the tidying robot 900 chassis 102, and may be opened or otherwise manipulated to wet the mop pad 908 with water or water mixed with cleaning fluid during a mopping task. In another embodiment, such a fluid reservoir may couple to spray nozzles at the front of the chassis 102, which may wet the floor in front of the mop pad 908, the mop pad 908 then wiping the floor and absorbing the fluid.

FIG. 10A-FIG. 10D illustrate a tidying robot interacting with drawers 1000 in accordance with one embodiment. When tidyable objects 702 in the scoop 110 of the tidying robot 900 belong in a drawer 1004 of a cabinet 1002, the tidying robot 900 may move one of its pusher pads 118 to engage 1008 its hook 906 with the handle 1006 of the drawer 1004. The tidying robot 900 may then drive backward 1010 to pull the drawer 1004 open. Alternatively, the scoop arm linear actuator 172 may pull inward 1012 to retract the scoop 110 and open the drawer 1004.

With the drawer 1004 open, the tidying robot 900 may raise 1014 and rotate 1016 the scoop 110 to deposit tidyable objects 702 into the drawer 1004. Once the tidyable objects 702 are deposited in the drawer 1004, the tidying robot 900 may once again move one of its pusher pads 118 to engage 1008 its hook 906 with the handle 1006 of the drawer 1004. The tidying robot 900 may then drive forward 1018 to push the drawer 1004 closed. Alternatively, the scoop arm linear actuator 172 may push outward 1020 to extend the scoop 110 and close the drawer 1004.

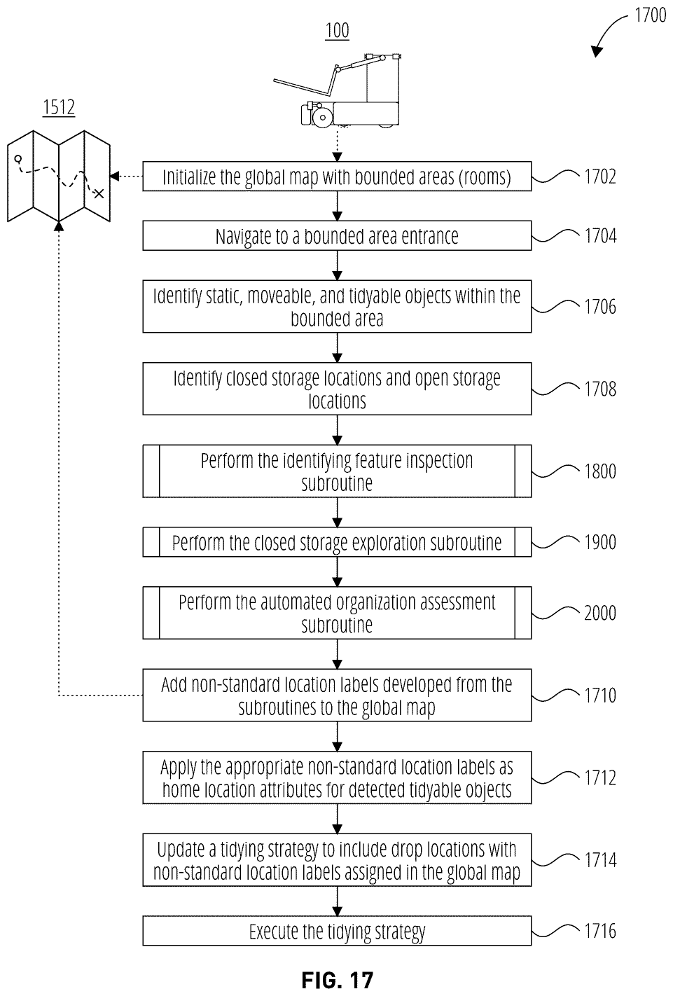

FIG. 11 illustrates a tidying robot 1100 in accordance with one embodiment. The tidying robot 1100 may be configured to perform the actions illustrated in FIG. 10A through FIG. 10D with respect to the tidying robot interacting with drawers 1000. In contrast to the hooks 906 shown on the pusher pads 118 of the tidying robot 900 illustrated in FIG. 9, the tidying robot 1100 may comprise a gripper arm 1102 attached to the scoop 110 at a gripper pivot point 1104. The pusher pads 118, rather than being attached to the scoop 110, may be attached via pusher pad arms 120 to the chassis 102, as shown. The gripper arm 1102 may be configured with an actuated gripper 1106 that may be manipulated to open and close in order to hook onto or grip objects such as the handles 1006 shown. To improve gripping abilities, the actuated gripper 1106 may include gripper tips 1108. The gripper tips 1108 may be of a shape to increase friction force at the ends of the actuated gripper 1106. The gripper tips 1108 may be made from a high-grip substance such as rubber or silicone. In one embodiment, the gripper tips 1108 may be magnetic. In one embodiment, a second gripper arm 1102 may connect to the other side of the scoop 110, providing two grippers for improved performance when manipulating large or heavy objects.

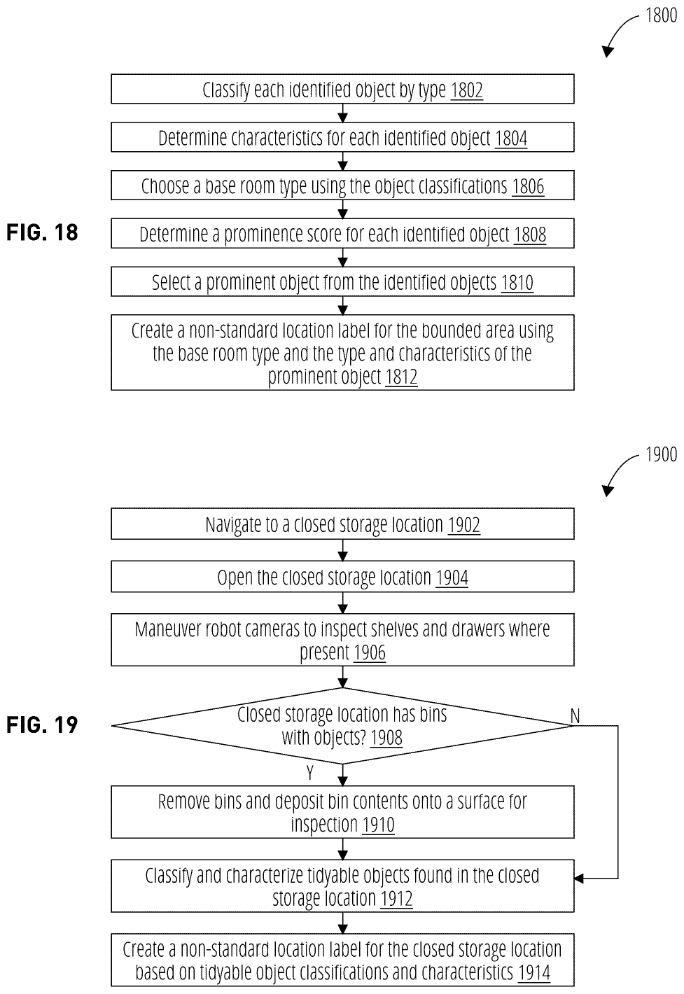

FIG. 12 illustrates a tidying robot 1200 in accordance with one embodiment. Similar to the tidying robot 1100 illustrated in FIG. 11, the tidying robot 1200 may be configured with one or more gripper arms 1102 as shown. The gripper arms 1102 of the tidying robot 1200 may be configured with passive grippers 1202. The passive grippers 1202 may be suction cups or magnets or may have similar features to attach temporarily to a surface of an object, such as a drawer 1004, for the purpose of manipulating that object.

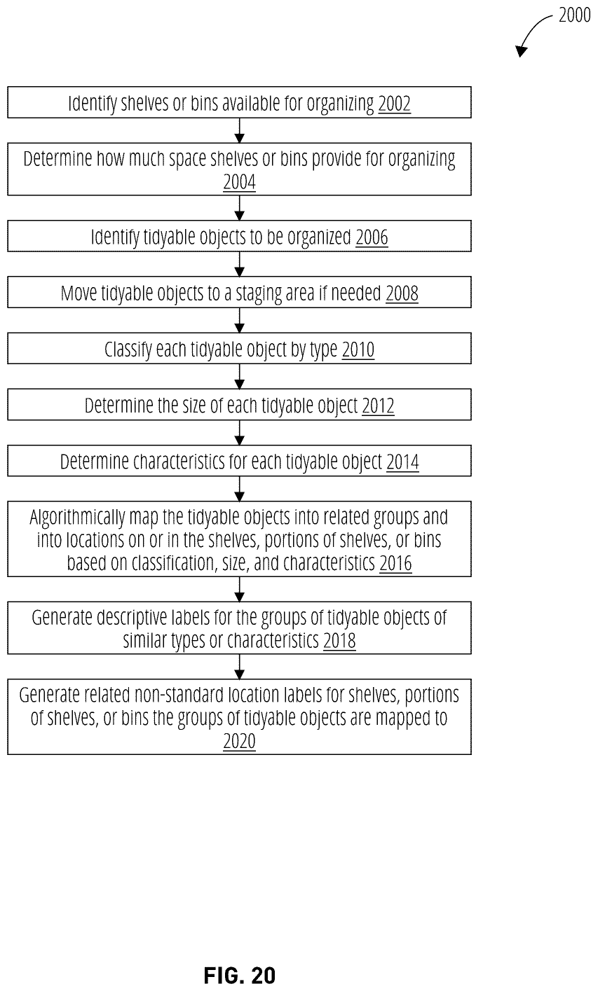

FIG. 13 illustrates a tidying robot 1100 in an alternative position in accordance with one embodiment. The shape of the scoop 110 may include a recessed area 1302, allowing the gripper arm 1102 of either the tidying robot 1100 or the tidying robot 1200, along with its gripping attachments, to be configured in a stowed position 1304 as shown.

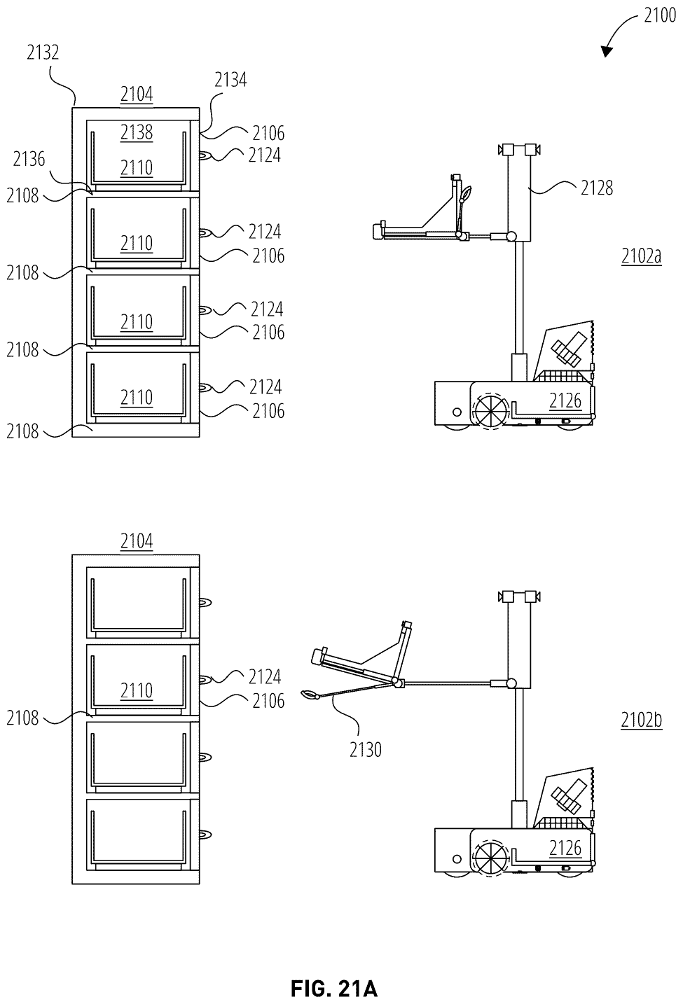

FIG. 14 illustrates a tidying robot 1400 in accordance with one embodiment. The tidying robot 1400 may be configured similarly to other robots illustrated herein, but may have a single pusher pad 118 spanning the width of the tidying robot 1400. The pusher pad 118 may be able to raise and lower in conjunction with or separately from the scoop 110 through the action of one or more pusher pad arm motors 186. One or more linear actuators 1402 may be configured to extend and retract the pusher pad 118, allowing it to sweep objects into the scoop 110.

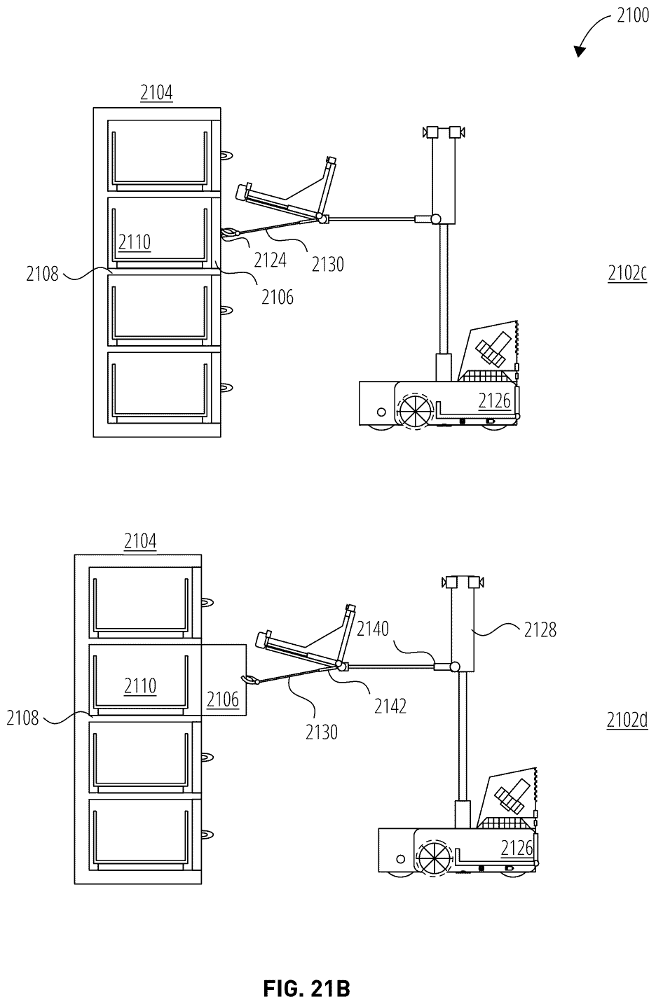

FIG. 15 illustrates a map configuration routine 1500 in accordance with one embodiment. User 1502 may use a mobile computing device 1504 to perform map initialization at block 1506. In this manner, the environment to be tidied may be mapped either starting from a blank map or from a previously saved map to generate a new or updated global map 1512.

In one embodiment, the user 1502 may use a mobile computing device 1504 to perform map initialization at block 1506, and in this manner, a portion of the environment to be tidied may be mapped either starting from a blank map or from a previously saved map to generate a new or updated local map.

A camera on the mobile computing device 1504 may be used to perform the camera capture at block 1508, providing a live video feed. The live video feed from the mobile device's camera may be processed to create an augmented reality interface that user 1502 may interact with. The augmented reality display may show users 1502 existing operational task rules such as:
Push objects to side: Selects group of objects (e.g., based on object type or an area on map) to be pushed or placed along the wall, into an open closet, or otherwise to an area out of the way of future operations.
Sweep Pattern: Marks an area on the map for the robot to sweep using pusher pads and scoop.
Vacuum pattern: Marks an area on the map for the robot to vacuum.
Mop pattern: Marks an area on the map for the robot to mop.
Tidy cluster of objects: Selects groups of objects (e.g., based on object type or an area on the map) to be tidied and dropped at a home location.
Sort on floor: Selects groups of objects (e.g., based on object type or an area on the map) to be organized on the floor based on a sorting rule.
Tidy specific object: Selects a specific object to be tidied and dropped at a home location.

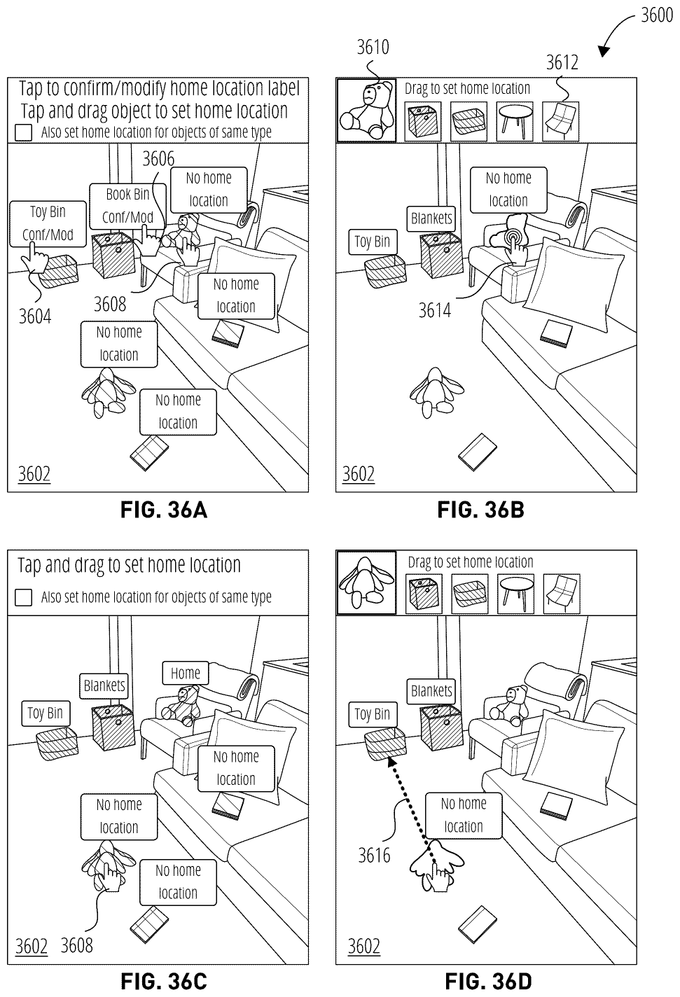

The augmented reality view may be displayed to the user 1502 on their mobile computing device 1504 as they map the environment and at block 1510. Using an augmented reality view such as that displayed with respect to FIG. 36A, along with a top-down, two-dimensional map, the user 1502 may configure different operational task rules through user input signals 1514.

TABLE 1

| Task | Target | Home |
|---|---|---|
| High-level information | Specifies what objects and | Specifies the home location |
| describing the task to be | locations are to be tidied or | where tidied objects are to be |
| completed. | cleaned. | placed. |
| Task Type | Target Object Identifier | Home Object Label |
| Task Priority | Target Object Type | Home Object Identifier |
| Task Schedule | Target Object Pattern | Home Object Type |
| | Target Area | Home Area |
| | Target Marker Object | Home Position |

User input signals 1514 may indicate user selection of a tidyable object detected in the environment to be tidied, identification of a home location for the selected tidyable object, custom categorization of the selected tidyable object, identification of a portion of the global map as a bounded area, generation of a label for the bounded area to create a named bounded area, and definition of at least one operational task rule that is an area-based rule using the named bounded area, wherein the area-based rule controls the performance of the robot operation when the tidying robot is located in the named bounded area.

User input signals 1514 may in one embodiment indicate user selection of a tidyable object detected in the environment to be tidied, identification of a home location for the selected tidyable object, custom categorization of the selected tidyable object, identification of a portion of a local map as a bounded area, generation of a label for the bounded area to create a named bounded area, and definition of at least one operational task rule that is an area-based rule using the named bounded area, wherein the area-based rule controls the performance of the robot operation when the tidying robot is located in the named bounded area.

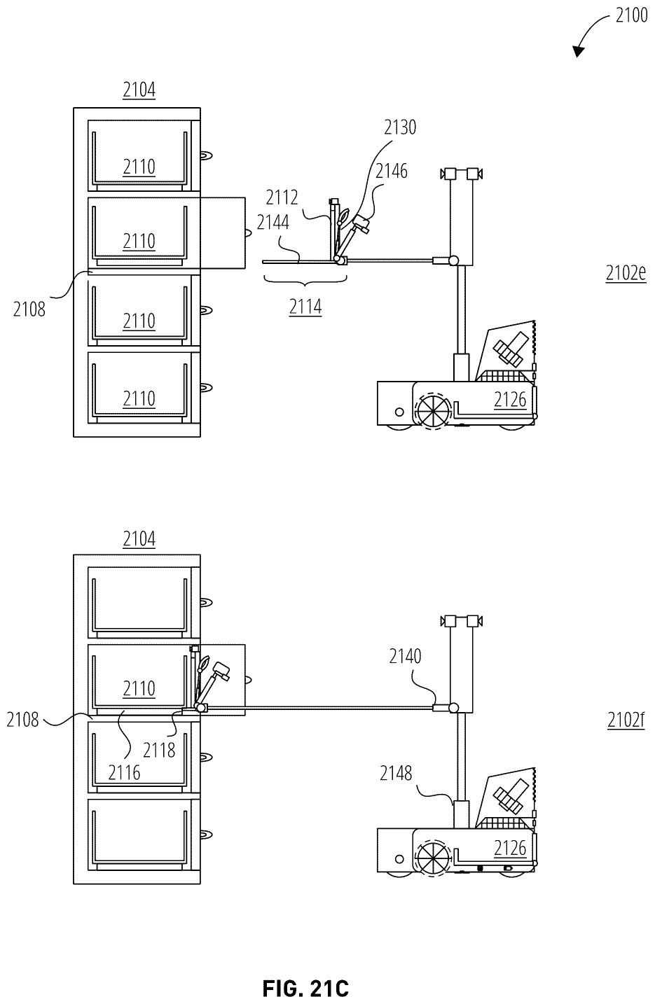

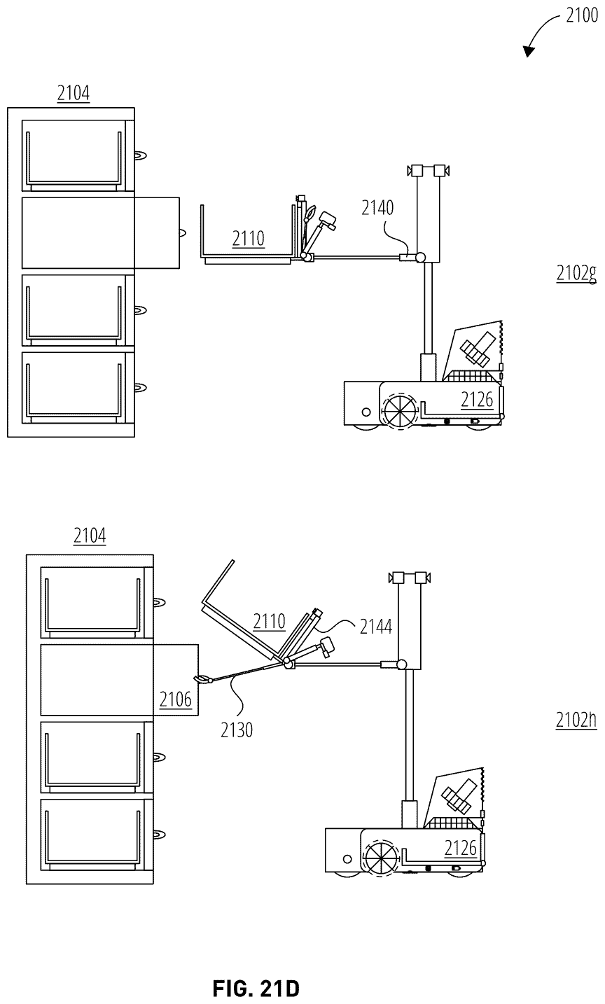

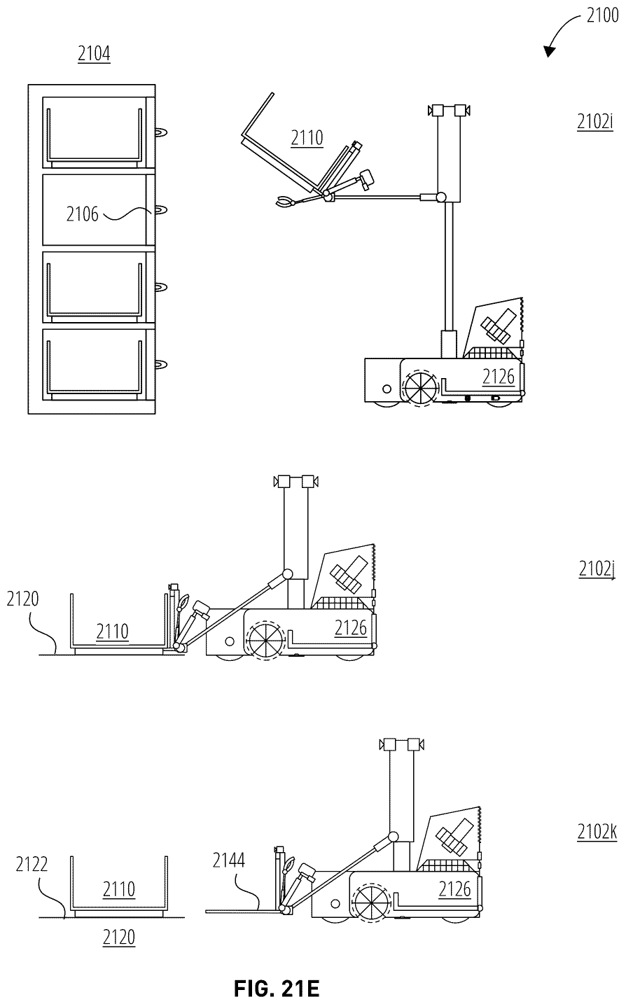

Determining bounded areas and area-based rules is described in additional detail with respect to FIG. 16A-FIG. 16C. Other elements of the disclosed solution may also be configured or modified based on user input signals 1514, as will be well understood by one of ordinary skill in the art.

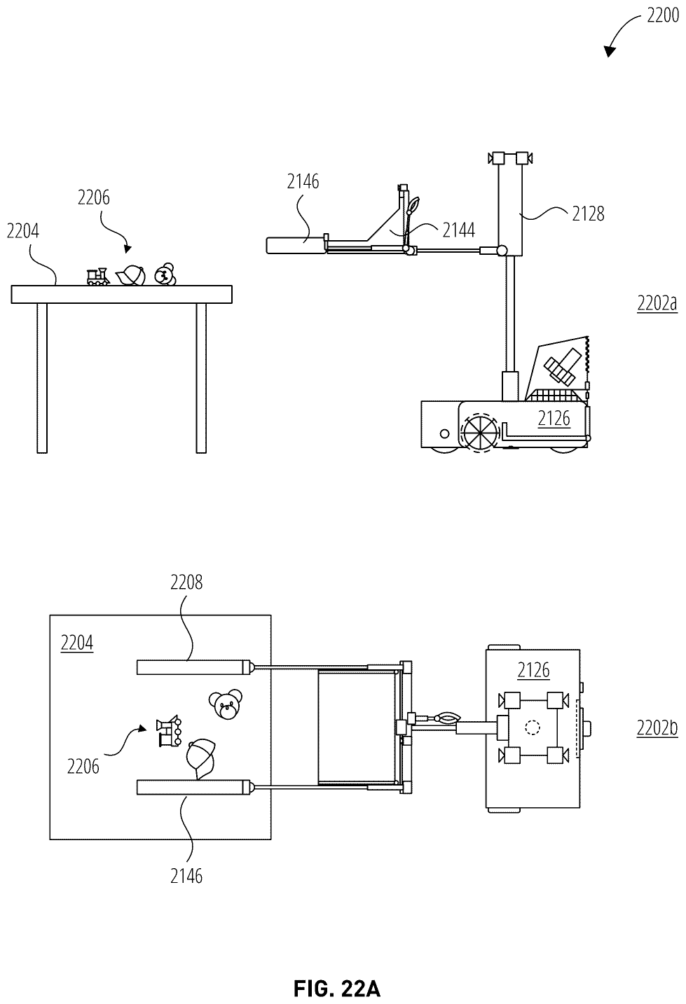

In one embodiment, the camera may be a camera 134 of a robot such as those previously disclosed, and these steps may be performed similarly based on artificial intelligence analysis of known floor maps of tidying areas and detected objects, rather than an augmented reality view. In one embodiment, rules may be pre-configured within the robotic control system or may be provided to the tidying robot through voice commands detected through a microphone configured as part of the sensing system 106. Such a process is described in greater detail with respect to FIG. 17.

FIG. 16A-FIG. 16C illustrate a floor map 1600 in accordance with one embodiment. In one embodiment, the floor map 1600 may be generated based on the basic room structure detected by a mobile device according to the process illustrated in static object identification routine 2900. FIG. 16A shows a starting state 1602 with initial bounded areas 1604 accessible in some instances by bounded area entrances 1606. FIG. 16B shows additional bounded areas 1608 as well as area labels 1610 applied to form named bounded areas 1612, which may indicate a base room type such as “kitchen,” “bedroom,” etc. FIG. 16C shows area-based rules 1614 for the areas.

Users may name areas on the map and then create operational task rules based on these areas. At its starting state 1602, the floor map 1600 may have no areas assigned or may have some initial bounded areas 1604 identified based on detected objects, especially static objects such as walls, windows, and doorframes that indicate where one area ends and another area begins. Users may subdivide the map by providing bounded area selection signals 1516 to set area boundaries and, in one embodiment, may mark additional bounded areas 1608 on the map using their mobile device by providing label selection signals 1518 as illustrated in FIG. 15. Area labels 1610 may be applied by the user or may be generated based on detected objects as described below to form named bounded areas 1612.

The panoptic segmentation model may include object types for both static objects and moveable objects. When such objects are detected in a location associated with an area on the floor map 1600, such objects may be used to generate suggested area names based on what objects appear in that given area. For example:
Oven+Fridge+Microwave⇒Kitchen.
Bed Frame+Mattress⇒Bedroom.
Toilet+Shower⇒Bathroom
Couch+Television⇒Living Room

The named bounded areas 1612 may then be used to establish area-based rules 1614. For example, area-based rules 1614 may include a time rule 1616, such as a rule to sweep the kitchen if the robot is operating between 8:00 PM and 9:00 PM on weekdays. A similar time rule 1618 may be created to also vacuum the living room if the robot is operating between 8:00 PM and 9:00 PM on weekdays.

Additional area-based rules 1614 may be created around tidying up a specific object or tidying up objects of a certain type and setting the drop off location to be within a home area. For example, an object rule 1620 may be created to place a game console remote at a specific home location in the living room area. Another object rule 1622 may be created to place a guitar in a storage closet. Category rule 1624 and category rule 1626 may be created such that objects of a specific category (such as “bags” and “clothing”, respectively) are placed in a first bedroom. Category rule 1628 may call for “bathroom items” to be placed in the bathroom. Category rule 1630 may instruct the robot to place “toys” in a second bedroom

The following describes a set of different operational task rules that may be used to configure the robot's tidying behavior.

TABLE 2

| Field | Description | Values |
|---|---|---|
| Task Type | Type of operational task robot | Task List |
| | may take | [TIDY_OBJECT], |
| | | [TIDY_CLUSTER], [VACUUM], |
| | | [SWEEP], [PUSH_TO_SIDE], |
| | | [SORT_ON_FLOOR], |
| | | [RETURN_TO_DOCK] |
| Task Priority | Relative priority of when | Priority List |
| | operational task is to be taken | [PRIORITY_1], [PRIORITY_2], |
| | | . . . , |
| | | [PRIORITY_10] |
| Task Schedule | Schedule in terms of what time(s) | Time(s) |
| | and what day(s) when task may | Start Time, End Time |
| | be performed | Day(s) |
| | | All Days, Days of Week, Days of |
| | | Month, Days of Year |
| Target Object | Used to select object(s) during | Re-identification fingerprint |
| Identifier | pickup. | Embedding 1: [A1, B1, C1, . . . Z1] |
| | Identifier that may visually | Embedding 2: [A2, B2, C2, . . . Z2] |
| | uniquely identify a specific object | Embedding 3: [A3, B3, C3, . . . Z3] |
| | in the environment to be picked | . . . |
| | up. | Embedding N: [AN, BN, CN, . . . |
| | A technique called meta learning | ZN] |
| | may be used for this where | |
| | several embeddings are generated | |
| | that allow us to measure visual | |
| | similarity against a reference set. | |
| | This set of embeddings may be | |
| | called a re-identification | |
| | fingerprint. | |
| Target Object Type | Used to select object(s) during | Type List |
| | pickup. | [CLOTHES], |
| | Identifier that classifies objects | [MAGNETIC_TILES], [DOLLS], |
| | based on their semantic type that | [PLAY_FOOD], [SOFT_TOYS], |
| | allows us to specify a collection | [BALLS], [BABY_TOYS], |
| | of similar objects to be picked up. | [TOY_ANIMALS], [BLOCKS], |
| | This may be from a list of | [LEGOS], [BOOKS], |
| | predefined types, or a user may | [TOY_VEHICLES], [MUSIC], |
| | create a custom type. | [ARTS_CRAFTS], [PUZZLES], |
| | | [DRESS_UP], [PET_TOYS], |
| | | [SPORTS], [GAMES], |
| | | [PLAY_TRAINS], |
| | | [TOY_DINOSAURS], [KITCHEN], |
| | | [TOOLS], [SHOES], [GARBAGE], . . . , |
| | | [MISCELLANEOUS] |
| Target Object Pattern | Used to select object(s) during | Pattern List |
| | pickup. | [COLOR], |
| | Specialized pattern matching | [SOLID_STRIPES_PLAID], |
| | classification rule that may be | [WOOD_PLASTIC_METAL], . . . , |
| | used to further sort objects | [CROCHET_KNIT_SEWN] |
| | beyond just type in selecting what | |
| | objects to pick up. | |
| | This may be from a list of | |
| | predefined patterns, or a user may | |
| | create a custom pattern. | |
| Target Object Size | Used to select object(s) during | Size List |
| | pickup. | [X_SMALL], [SMALL], |
| | Group objects based on their size | [MEDIUM], [LARGE], |
| | by looking at whether they would | [X_LARGE], [XX_LARGE] |
| | fit within a given volume. | |
| | (E.g. X_SMALL: fits in a 0.5 cm | |
| | radius sphere, SMALL: fits in a | |
| | 3 cm radius sphere, MEDIUM: fits | |
| | in a 6 cm radius sphere, LARGE: | |
| | fits in a 12 cm radius sphere, | |
| | X_LARGE: fits in a 24 cm radius | |
| | sphere, XX_LARGE: doesn't fit | |
| | in 24 cm radius sphere) | |
| Target Area | Used to select object(s) during | Area List |
| | pickup. | [ANY_AREA], [LIVING_ROOM], |
| | Users may mark areas on a saved | [KITCHEN], [DINING ROOM], |
| | map of the environment such as | [PLAY_AREA], [BEDROOM_1], |
| | assigning names to rooms or even | [BEDROOM_2], [BEDROOM_3], |
| | marking specific sections within a | [BATHROOM_1], |
| | room. | [BATHROOM_2], . . . , |
| | This may be from a list of | [ENTRANCE] |
| | predefined areas, or a user may | |
| | create a custom area. | |
| Target Marker Object | Used to select object(s) during | Re-identification fingerprint |
| | pickup. | Embedding 1: [A1, B1, C1, . . . Z1] |
| | Identifier that may visually | Embedding 2: [A2, B2, C2, . . . Z2] |
| | uniquely identify a specific object | Embedding 3: [A3, B3, C3, . . . Z3] |
| | in the environment to be used as a | . . . |
| | marker where adjacent objects | Embedding N: [AN, BN, CN, . . . |
| | may be picked up. For example, a | ZN] |
| | marker may be a specific mat or | |
| | chair holding objects desired to | |
| | be picked up. Typically markers | |
| | may not be picked up themselves. | |
| | A technique called meta learning | |
| | may be used for this where | |
| | several embeddings are generated | |
| | that allow us to measure visual | |
| | similarity against a reference set. | |
| | This set of embeddings may be | |
| | called a re-identification | |
| | fingerprint. | |
| Home Object Label | Used to identify a home location | Destination Label |
| | for drop off. | [CLOTHES], |
| | Label is attached to a destination | [MAGNETIC_TILES], [DOLLS], |
| | home object where target | [PLAY_FOOD], [SOFT_TOYS], |
| | object(s) are to be dropped off. | [BALLS], [BABY_TOYS], |
| | Often such a destination home | [TOY_ANIMALS], [BLOCKS], |
| | object will be a bin. | [LEGOS], [BOOKS], |
| | Bin label may be be a human | [TOY_VEHICLES], [MUSIC], |
| | readable label with a category | [ARTS_CRAFTS], [PUZZLES], |
| | type such as “Clothes” or | [DRESS_UP], [PET_TOYS], |
| | “Legos”, or it might be a machine | [SPORTS], [GAMES], |
| | readable label such as a quick | [PLAY_TRAINS], |
| | response (QR) code. | [TOY_DINOSAURS], [KITCHEN], |
| | This may be from a list of | [TOOLS], [SHOES], [GARBAGE], |
| | predefined types, or a user may | . . . , [MISCELLANEOUS] |
| | create a custom type. | |
| Home Object Identifier | Used to identify a home location | Re-identification fingerprint |
| | for drop off. | Embedding 1: [A1, B1, C1, . . . Z1] |
| | Identifier that may visually | Embedding 2: [A2, B2, C2, . . . Z2] |
| | uniquely identify a specific object | Embedding 3: [A3, B3, C3, . . . Z3] |
| | in the environment where target | . . . |
| | object(s) are to be dropped off. | Embedding N: [AN, BN, CN, . . . |
| | Often such a destination home | ZN] |
| | object will be a bin. | |
| | A technique called meta learning | |
| | may be used for this where | |
| | several embeddings are generated | |
| | that allow us to measure visual | |
| | similarity against a reference set. | |
| | This set of embeddings may be | |
| | called a re-identification | |
| | fingerprint. | |
| Home Object Type | Used to identify a home location | Type List |
| | for drop off. | [BIN], [FLOOR], [BED], [RUG], |
| | Identifier that classifies objects | [MAT], [SHELF], [WALL], |
| | based on their semantic type that | [COUNTER], [CHAIR], . . . , |
| | allows us to create rules for a | [COUCH] |
| | destination type where target | |
| | object(s) are to be dropped off. | |
| | This may be from a list of | |
| | predefined types, or a user may | |
| | create a custom type. | |
| Home Area | Used to identify a home location | Area List |
| | for drop off. | [ANY_AREA], [LIVING_ROOM], |
| | Users may mark areas on a saved | [KITCHEN], [DINING ROOM], |
| | map of the environment such as | [PLAY_AREA], [BEDROOM_1], |
| | assigning names to rooms or even | [BEDROOM_2], [BEDROOM_3], |
| | marking specific sections within a | [BATHROOM_1], |
| | room where target object(s) are to | [BATHROOM_2], . . . , |
| | be dropped off. | [ENTRANCE] |
| | This may be from a list of | |
| | predefined areas, or a user may | |
| | create a custom area. | |
| Home Position | Used to identify a home location | Position |
| | for drop off. | [FRONT_CENTER], |
| | Users may mark a specific | [FRONT_LEFT], |
| | position relative to a destination | [FRONT_RIGHT], |
| | home object where an object is to | [MID_CENTER], [MID_LEFT], |
| | be dropped off. | [MID_RIGHT], [BACK_CENTER], |
| | This will typically be relative to a | [BACK_LEFT], . . . , |
| | standard home object orientation | [BACK_RIGHT] |
| | such as a bin or a shelf having a | |
| | clear front, back, left, and right | |
| | when approached by the robot. | |
| | This may be from a list of | |
| | predefined positions, or a user | |
| | may create a custom position. | |

FIG. 17 illustrates a non-standard location categorization routine 1700 in accordance with one embodiment. The non-standard location categorization routine 1700 may be performed by the tidying robot 100 through use of its mobility system 104, sensing system 106, capture and containment system 108, and robotic control system 2500 as disclosed herein. Although the example non-standard location categorization routine 1700 depicts a particular sequence of operations, the sequence may be altered without departing from the scope of the present disclosure. For example, some of the operations depicted may be performed in parallel or in a different sequence that does not materially affect the function of the non-standard location categorization routine 1700. In other examples, different components of an example device or system that implements the non-standard location categorization routine 1700 may perform functions at substantially the same time or in a specific sequence.

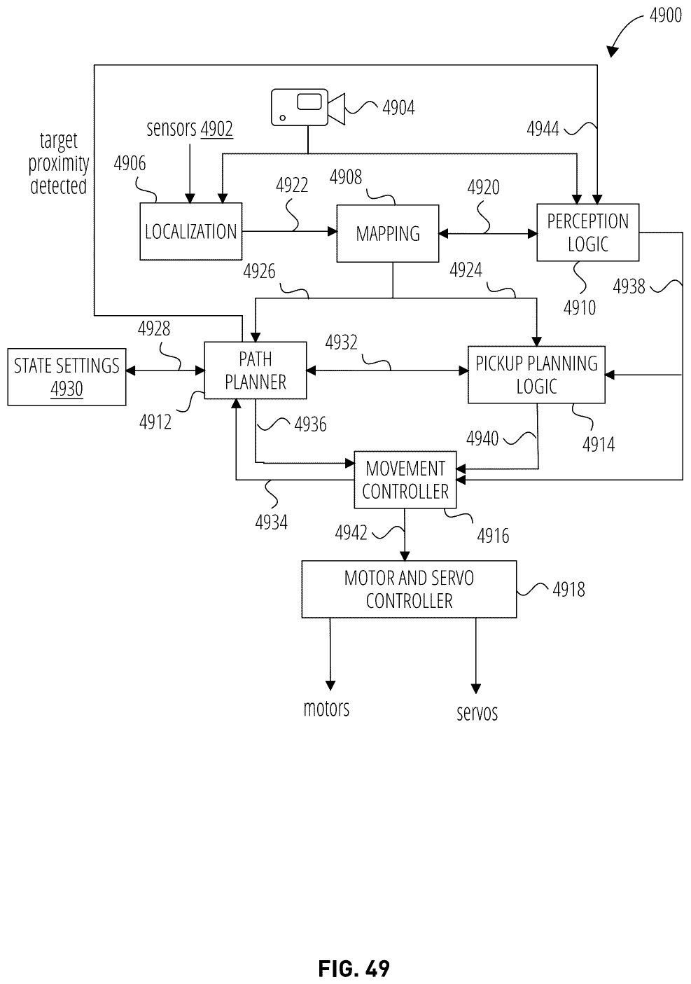

In one embodiment, the robotic control system 2500 and the logic used to execute this non-standard location categorization routine 1700, including localization logic 4906, mapping logic 4908, and perception logic 4910 (as illustrated in and described with respect to FIG. 49), may be utilized in conjunction with the robot cameras 134 and other sensors of the sensing system 106 to perform the non-standard location categorization routine 1700.

In one embodiment, the robotic control system 2500 and the logic used to execute this non-standard location categorization routine 1700, including localization logic 4906, mapping logic 4908, and perception logic 4910 (as illustrated in and described with respect to FIG. 49), may be utilized in conjunction with the cameras and sensors incorporated into a mobile computing device 1504, such as was introduced with respect to FIG. 15, to perform the non-standard location categorization routine 1700.

In one embodiment, the robotic control system 2500 and the logic used to execute this non-standard location categorization routine 1700, including localization logic 4906, mapping logic 4908, and perception logic 4910 (as illustrated in and described with respect to FIG. 49), may be implemented using hardware on the tidying robot 100.

In one embodiment, the robotic control system 2500 and the logic used to execute this non-standard location categorization routine 1700, including localization logic 4906, mapping logic 4908, and perception logic 4910 (as illustrated in and described with respect to FIG. 49), may be implemented on a network-connected interface such as a local computer or a cloud server in communication with the tidying robot 100. This communication may be supported by the communications 194 of FIG. 1C and the network interface 2512 of FIG. 25.

In one embodiment, the robotic control system 2500 and the logic used to execute this non-standard location categorization routine 1700, including localization logic 4906, mapping logic 4908, and perception logic 4910 (as illustrated in and described with respect to FIG. 49), may be implemented on the mobile computing device 1504 of FIG. 15. This mobile computing device 1504 may be in communication with the tidying robot 100. This communication may be supported by the communications 194 of FIG. 1C and the network interface 2512 of FIG. 25.

In one embodiment, the robotic control system 2500 and the logic used to execute this non-standard location categorization routine 1700, including localization logic 4906, mapping logic 4908, and perception logic 4910 (as illustrated in and described with respect to FIG. 49), may be implemented in hardware on any two or three of the tidying robot 100, a network-connected interface such as a local computer or a cloud server, or a mobile computing device 1504.

According to some examples, the method includes initializing the global map with bounded areas such as rooms at block 1702. The environment to be tidied may be mapped cither starting from a blank map or from a previously saved map to generate a new or updated global map 1512. The initialization of bounded areas may result in a floor map 1600 such as the starting state 1602 of unlabeled initial bounded areas 1604 shown in FIG. 16A. In one embodiment, the bounded areas may be determined by detecting areas surrounded by static objects in the environment to be tidied.

According to some examples, the method includes initializing a local map with bounded areas such as rooms at block 1702. The environment to be tidied may be mapped either starting from a blank map or from a previously saved map to generate a new or updated local map. The initialization of bounded areas may result in a floor map 1600 such as the starting state 1602 of unlabeled initial bounded areas 1604 shown in FIG. 16A. In one embodiment, the bounded areas may be determined by detecting areas surrounded by static objects in the environment to be tidied.

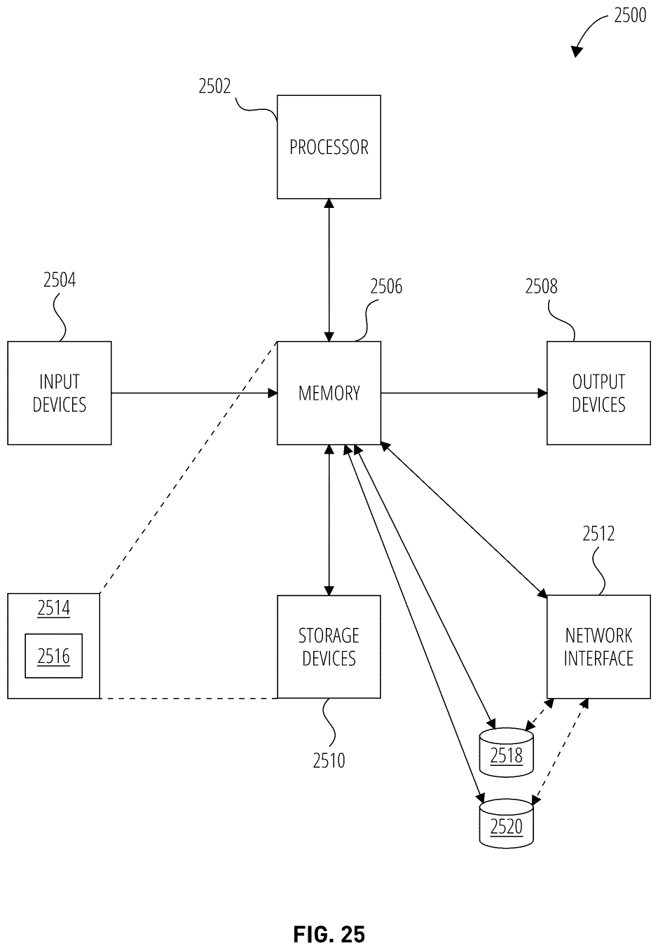

According to some examples, the method includes navigating to a bounded area entrance at block 1704. The entrance to a bounded area may be detected through the identification of static objects 2816 such as walls and moveable objects such as doors that may be used to delimit the bounded areas during block 1702. According to some examples, the method then includes identifying static objects, moveable objects, and tidyable objects within the bounded area at block 1706. This may be accomplished in one embodiment through the routines illustrated in and described with respect to FIG. 27-FIG. 31.

According to some examples, the method includes identifying closed storage locations and open storage locations at block 1708. This may be accomplished in one embodiment using the static and moveable objects identified in block 1706. In particular, static objects such as furniture and walls, moveable objects such as doors and drawers, and moveable objects such as bins and hampers, portions of the floor that are clear of other objects, etc., may be categorized as open storage locations and closed storage locations. A closed storage location may be considered a storage location that resides behind a door, within a drawer, or is otherwise obscured by all or a portion of one or more moveable objects, such as a door, drawer, cabinet, etc. Open storage locations may be considered those that are immediately perceptible to the sensors (e.g., cameras) of a tidying robot 100 upon examining a bounded area, such as bins, hampers, clear floor areas, etc. Classification and identification may be performed by the tidying robot 100 through the image processing routine 2700, video-feed segmentation routine 2800, movable object identification routine 3000, and other processes described herein.

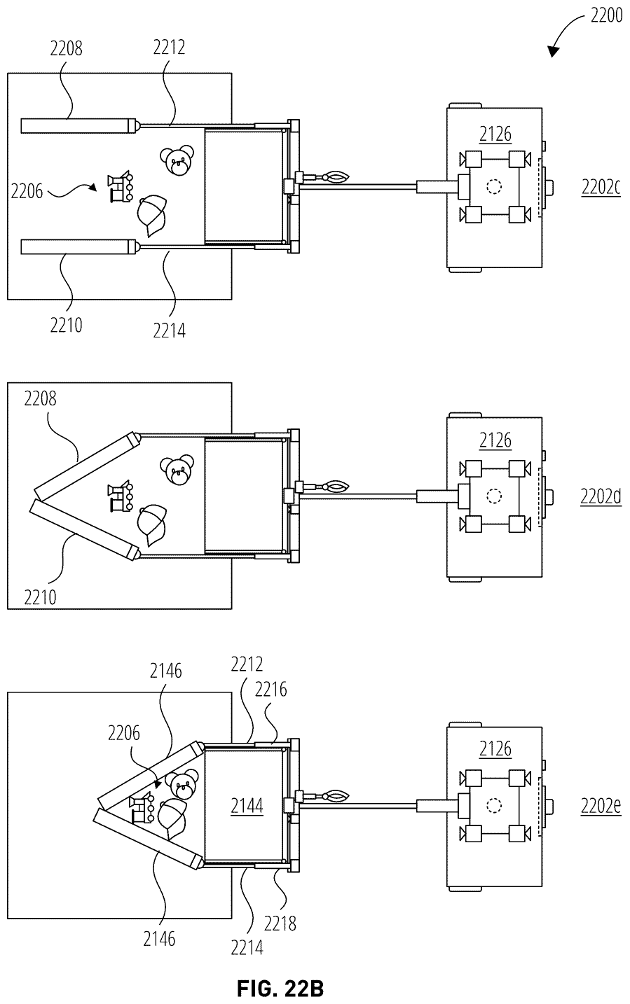

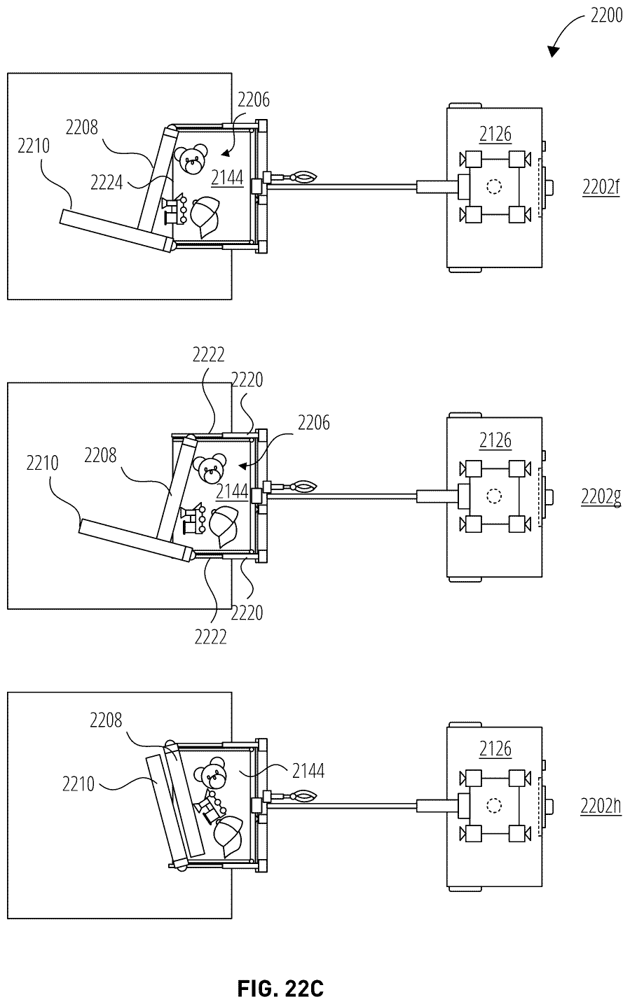

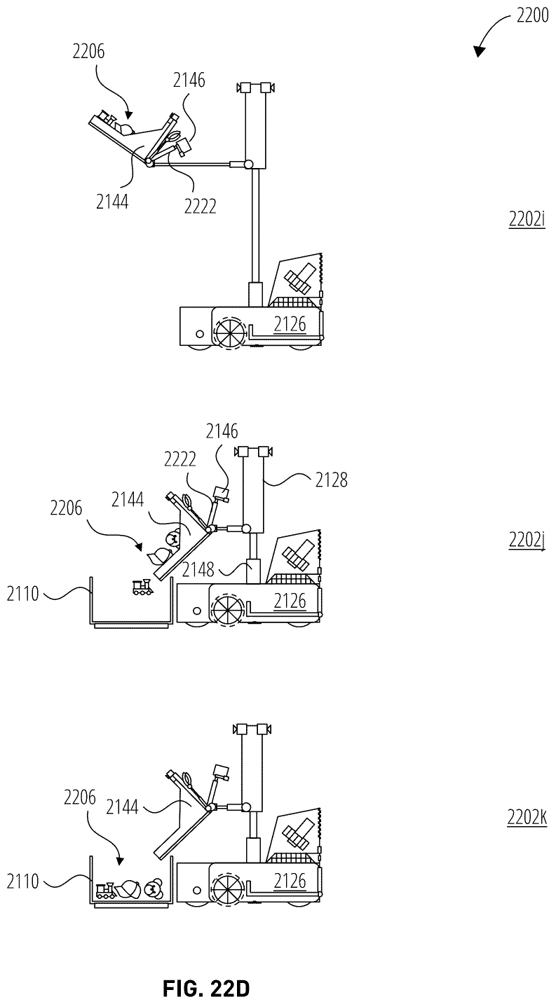

With objects within the bounded area identified, the non-standard location categorization routine 1700 may continue with the performance of identifying feature inspection subroutine 1800, closed storage exploration subroutine 1900, and automated organization assessment subroutine 2000, described below with respect to FIG. 18, FIG. 19, and FIG. 20, respectively. Through the performance of these subroutines, the tidying robot 100 may develop non-standard location categories and labels that may be applied to tidyable objects as attributes indicating the appropriate drop location for each object when it is encountered by the tidying robot 100 during a tidying task.

According to some examples, the method includes adding non-standard location labels to the global map at block 1710. These non-standard location labels may be generated as previously stated though the completion of any one or more of the identifying feature inspection subroutine 1800, the closed storage exploration subroutine 1900, and/or the automated organization assessment subroutine 2000. The non-standard location labels may then be used as the area labels 1610 to created the named bounded areas 1612 within the global map or floor map 1600 as shown in FIG. 16B. The global map 1512 may thus be updated using the non-standard location labels so generated.

According to some examples, the method includes applying the appropriate non-standard location labels as home location attributes for detected tidyable objects at block 1712. These home location attributes may be the fields described above with respect to the operational task rules that may be used to configure the robot's tidying behavior. For example, non-standard location labels may be used for the Home Object Label, Home Object Identifier, Home Object Type, Home Area, and Home Position fields described in Table 2 above.

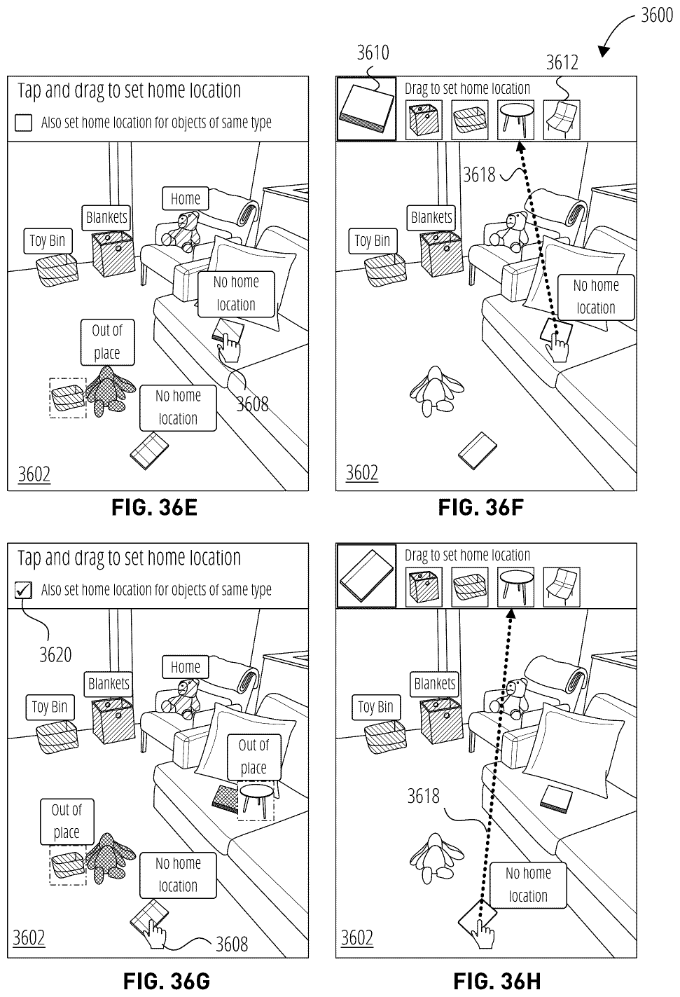

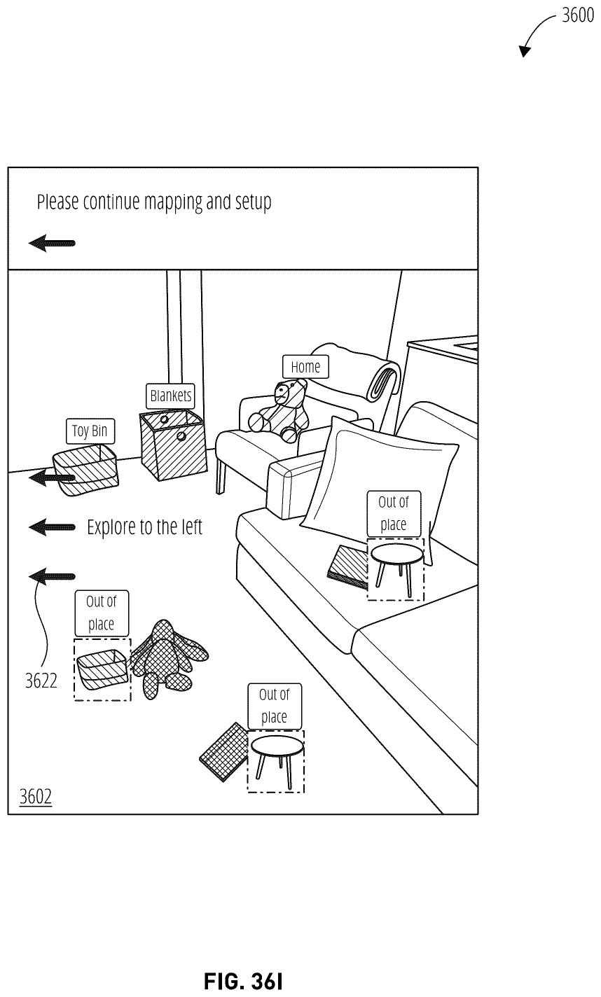

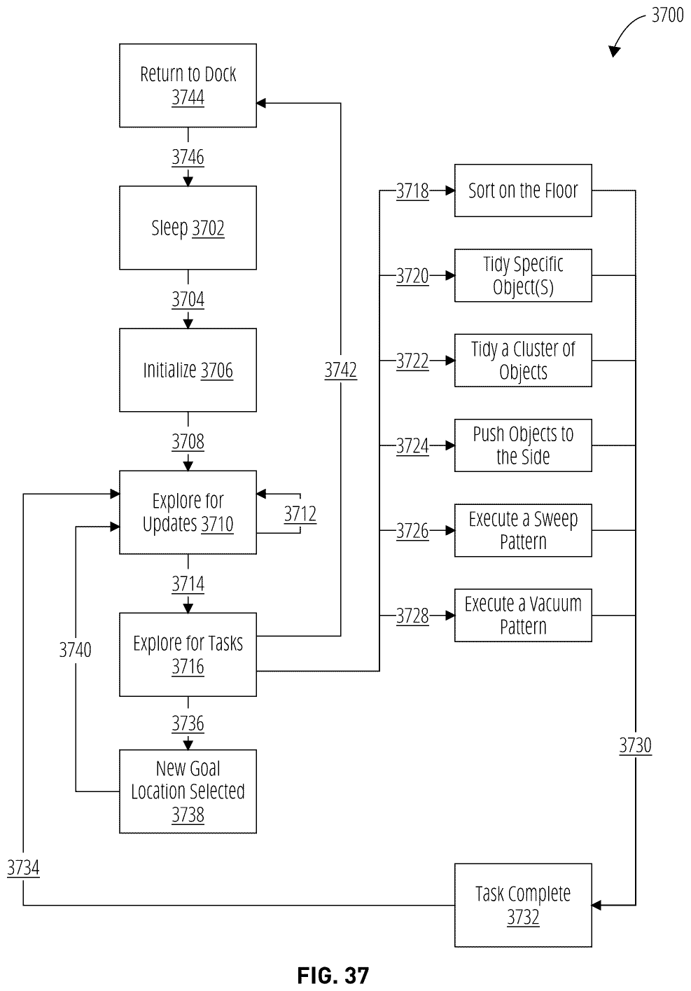

According to some examples, the method includes updating a tidying strategy to include drop locations with non-standard location labels assigned in the global map at block 1714. The tidying strategy may be such as is described with respect to the robot operation state diagram 3700 of FIG. 37, the routine 3800 of FIG. 38, and the basic routine 3900 of FIG. 39. According to some examples, the method includes executing the tidying strategy at block 1716. Execution of the tidying strategy may be directed by control logic as part of the robotic control system 2500, either configured on hardware local to the tidying robot 100 and/or available through a wireless connection to a cloud server, a mobile device, or other computing device.

FIG. 18 illustrates an identifying feature inspection subroutine 1800 in accordance with one embodiment. The identifying feature inspection subroutine 1800 may be performed by the tidying robot 100 through use of its mobility system 104, sensing system 106, capture and containment system 108, and robotic control system 2500 as disclosed herein. Although the example identifying feature inspection subroutine 1800 depicts a particular sequence of operations, the sequence may be altered without departing from the scope of the present disclosure. For example, some of the operations depicted may be performed in parallel or in a different sequence that does not materially affect the function of the identifying feature inspection subroutine 1800. In other examples, different components of an example device or system that implements the identifying feature inspection subroutine 1800 may perform functions at substantially the same time or in a specific sequence.

According to some examples, the method includes classifying each identified object by type at block 1802. For example, a detected object may be classified as a toilet, a sink, a mirror, a painting, a chair, etc. Types may in turn belong to sub-types, or super-types. For example, an object of type “chair” may be of a super-type “furniture” and a sub-type “rocking chair.” According to some examples, the method includes determining characteristics for each identified object at block 1804. Object characteristics may include color, size, shape, detected text, subject, etc. For example, a characteristics for a toilet ma include color: “white” and material: “porcelain”, a sink may have the characteristics shape: “circular”, the mirror may have shape: “rectangular”, the painting may have subject: “polar bear” and color: “white”, the chair may have color: “green” and sub-type: “side chair”, etc.

According to some examples, the method includes choosing a base room type using the object classifications at block 1806. The panoptic segmentation model may support classification of object types for both static objects and moveable objects. When such objects are detected in a location associated with an area on the floor map 1600, such objects may be used to generate suggested area names based on what objects appear in that given area. For example:
Oven+Fridge+Microwave⇒Kitchen.
Bed Frame+Mattress⇒Bedroom.
Toilet+Shower⇒Bathroom
Couch+Television⇒Living Room

A base room type may be determined through probabilities based on object types (both qualifying and disqualifying. For example, the detected and classified objects may indicate an 80% chance the room is a bathroom, a 20% chance the room is a kitchen, and a 0% chance the room is a dining room, based on the presence of a sink, a bathtub, a toilet, etc. In this case, “bathroom” may be chosen as the base room type for use in generating a descriptive label for the room.

According to some examples, the method includes determining a prominence score for each identified object at block 1808. In one embodiment, static objects in particular, such as large furniture pieces and features of or on walls may be considered. A classifier may be used to determine the prominence score based in particular on the uniqueness of static objects detected. For example, a painting may receive a high prominence score of, for example, 80% based on it having features unmatched by other known objects. A chair may, on the other hand, be given a moderate to low prominence score, such as 40%, as having attributes matching other known objects. The prominence classifier may in one embodiment be trained by asking human labelers what object(s) in a room they think stand out, and would be most descriptive.

According to some examples, the method includes selecting a prominent object from the identified objects at block 1810. The prominent object may be selected as a static object having the highest prominence score determined in block 1808. For example, the painting having a score of 80% may be selected over the chair having a score of 40%.

According to some examples, the method includes creating a non-standard location label for the bounded area using the base room type and the type and characteristics of the prominent object at block 1812. The non-standard location label may be generated using the object type and characteristics of the prominent object selected in block 1810 along with the base room type determined in block 1806. For example, an unnamed bounded area or room may be determined by the presence of a sink, toilet, and bathtub, to be of a “bathroom” base room type. A feature detected on a wall in the bounded area may be determined to be a painting of a polar bear. The label “polar bear bathroom” may be generated for the room in question through execution of the identifying feature inspection subroutine 1800. Other examples may include “Alice's bedroom” for a room with a bed and nightstand having the name “Alice” appearing in art on the wall or door, as well as combinations such as “green chair bathroom”, “bathroom with sauna”, “bunk bed bedroom”, “board game room”, “flower garden room”, etc.

FIG. 19 illustrates a closed storage exploration subroutine 1900 in accordance with one embodiment. The closed storage exploration subroutine 1900 may be performed by the tidying robot 100 through use of its mobility system 104, sensing system 106, capture and containment system 108, and robotic control system 2500 as disclosed herein. Although the example closed storage exploration subroutine 1900 depicts a particular sequence of operations, the sequence may be altered without departing from the scope of the present disclosure. For example, some of the operations depicted may be performed in parallel or in a different sequence that does not materially affect the function of the closed storage exploration subroutine 1900. In other examples, different components of an example device or system that implements the closed storage exploration subroutine 1900 may perform functions at substantially the same time or in a specific sequence.

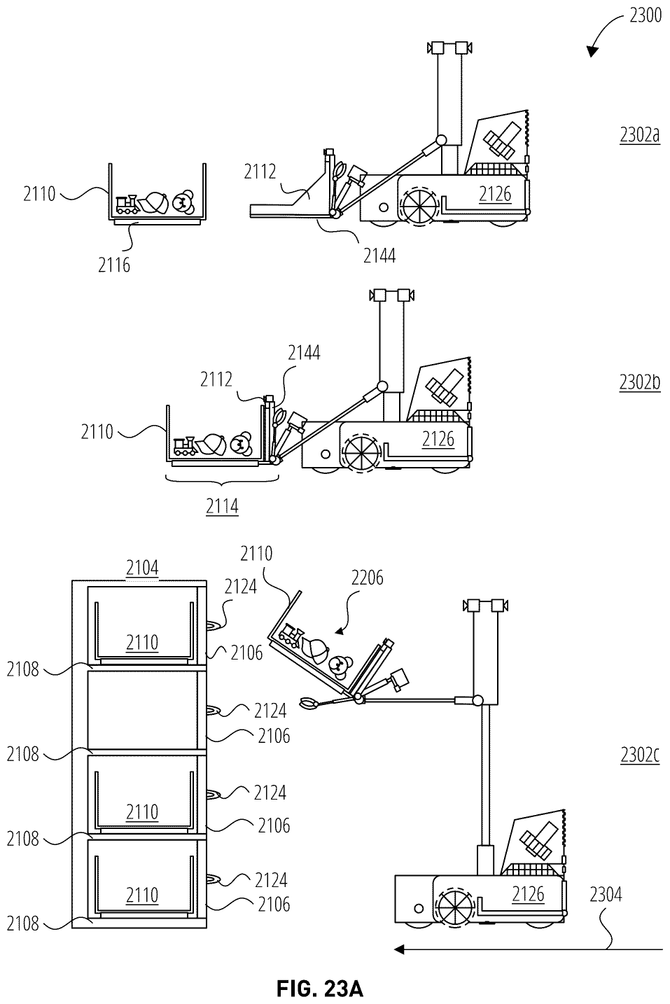

According to some examples, the method includes navigating to a closed storage location at block 1902. The mobility system 104 and sensing system 106 of the tidying robot 100 may support navigation to closed storage locations. According to some examples, the method includes opening the closed storage location at block 1904. The capture and containment system 108 of the tidying robot 100 may be configured with a gripping device such as the hook 906 shown in FIG. 9 or the gripper arm 1102 and its gripping attachments shown in FIG. 11. The tidying robot 100 may use these gripping devices to open and close the doors and drawers of closed storage locations as illustrated in FIG. 10A-FIG. 10D, FIG. 11, FIG. 12, FIG. 21A-FIG. 21E, and elsewhere herein.

According to some examples, the method includes maneuvering robot cameras to inspect shelves and drawers where present at block 1906. The tidying robot 100 may be equipped with cameras 134, and these may be mounted atop a chassis 102 or as part of a lifting column 132, as illustrated previously. In particular, where cameras 134 are mounted atop a lifting column 132 and/or in conjunction with the scoop 110 (such as the scoop camera 134c described above), the mobility of the lifting column 132 and scoop 110 may support the maneuvering of the tidying robot 100 cameras 134 in order to examine the shelves and drawers of closed storage locations.

Where it is determined at decision block 1908 that the closed storage location includes object collection bins containing tidyable objects, the closed storage exploration subroutine 1900 may continue to block 1910. Where it is determined at decision block 1908 that the closed storage location does not contain object collection bins, or it is determined that the object collection bins are empty, the closed storage exploration subroutine 1900 may skip to block 1912.

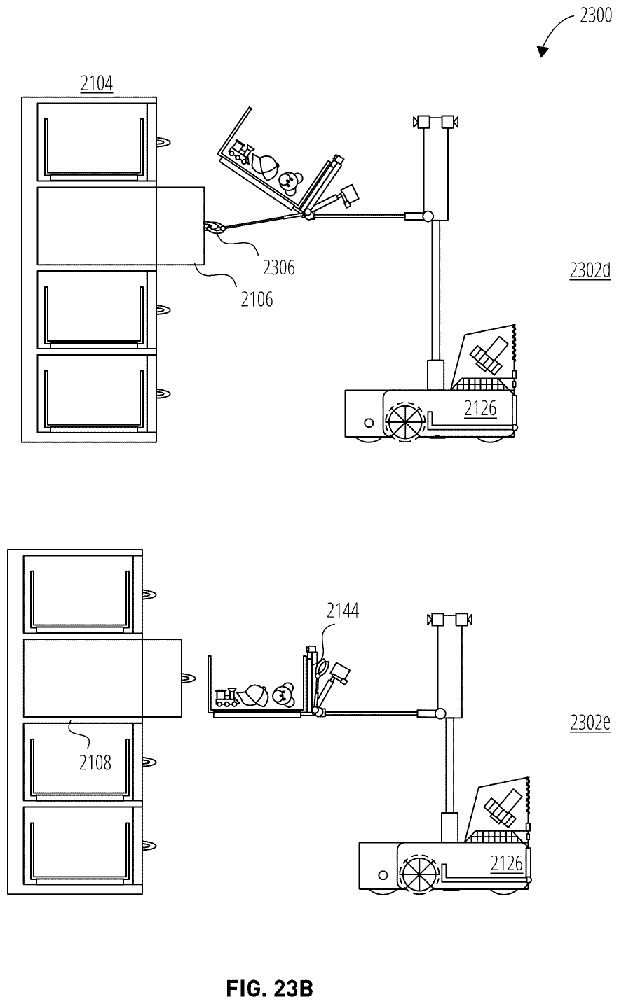

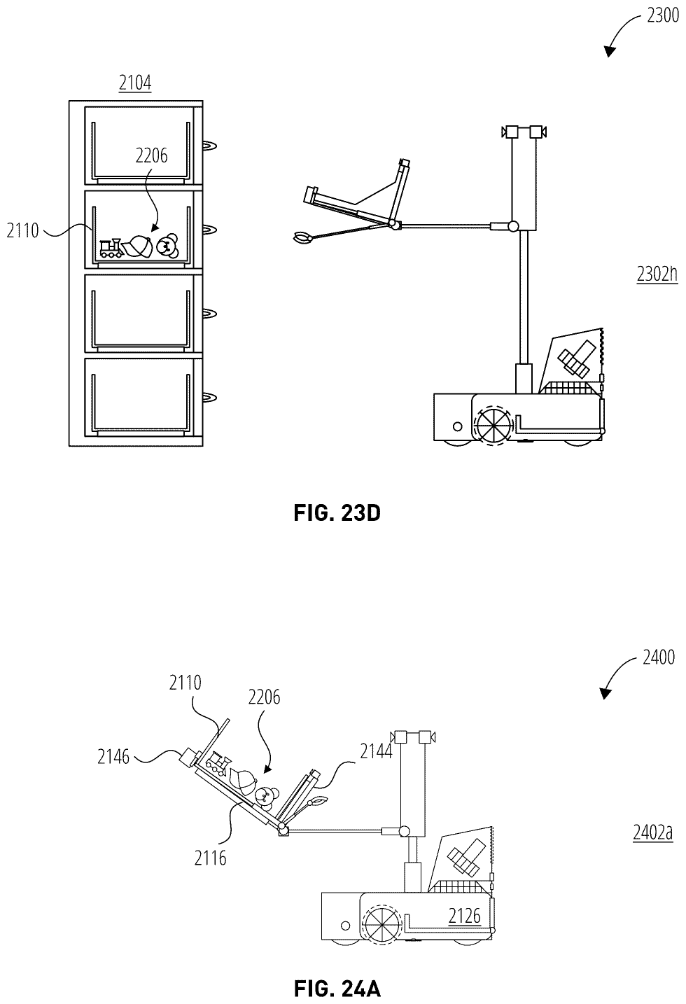

According to some examples, the method includes removing bins and depositing bin contents onto a surface for inspection at block 1910. Such an operation may be seen with respect to FIG. 24A-FIG. 24C, where tidyable objects are dumped from a bin ad sorted on the floor. Similarly, objects may be dumped on a surface such as a table or countertop similar to the tidyable objects 2206 shown in FIG. 22A-FIG. 22C.

According to some examples, the method includes classifying and characterize tidyable objects found in the closed storage location at block 1912. This may be accomplished through processes such as the image processing routine 2700, the video-feed segmentation routine 2800, and the tidyable object identification routine 3100 described in greater detail below.

According to some examples, the method includes creating a non-standard location label for the closed storage location based on the pertinent static object, moveable object, and tidyable object classifications and characteristics at block 1914. For example, if a preponderance of electrical equipment, switches, cables, and cords are found in a closed storage location identified as a cabinet, the cabinet may be designated the “electrical cabinet”. In one embodiment, where three shelves are detected in such cabinet, labels such as “electrical cabinet top shelf”, “electrical cabinet middle shelf”, and “electrical cabinet bottom shelf” may be used. In one embodiment, shelves may be divided into left sides, center sides, right sides, etc., and these attributes included in non-standard location labels.

FIG. 20 illustrates an automated organization assessment subroutine 2000 in accordance with one embodiment. The automated organization assessment subroutine 2000 may be performed by the tidying robot 100 through use of its mobility system 104, sensing system 106, capture and containment system 108, and robotic control system 2500 as disclosed herein. Although the example automated organization assessment subroutine 2000 depicts a particular sequence of operations, the sequence may be altered without departing from the scope of the present disclosure. For example, some of the operations depicted may be performed in parallel or in a different sequence that does not materially affect the function of the automated organization assessment subroutine 2000. In other examples, different components of an example device or system that implements the automated organization assessment subroutine 2000 may perform functions at substantially the same time or in a specific sequence.

According to some examples, the method includes identifying shelves or bins available for organizing at block 2002. These may include shelves and bins that are partially or completely empty, as determined through examination of images from the cameras of the tidying robot.

According to some examples, the method includes determining how much space shelves or bins provide for organizing at block 2004. This may be accomplished using spatial estimation algorithms such as are well known in the art. Available space may be calculated by analyzing and aggregating unoccupied surface area on shelves and unfilled volume within bins.

According to some examples, the method includes identifying tidyable objects to be organized at block 2006. According to some examples, the method includes moving tidyable objects to a staging area if needed at block 2008. An area of the floor, a table, or a countertop may be used as such a staging area. The contents of a bin may be dumped out onto the staging area and inspected and organized as described elsewhere herein. According to some examples, the method includes classifying each tidyable object by type at block 2010. This may be accomplished through at least the tidyable object identification routine 3100 described below.

According to some examples, the method includes determining the size of each tidyable object at block 2012. A footprint area and/or a volume for each tidyable object may be determined. Where it is known that a tidyable object is best stored on a shelf, the footprint area may be used to determine where among available shelves or portions of shelves the object may fit. Where a bin is determined to be the better storage solution, the volume of the object may be used. In some cases, the best location, shelf or bin, may be determined based on which of these parameters may be best accommodated by the available storage space.

According to some examples, the method includes determining characteristics for each tidyable object at block 2014. For example, attributes such as color, size, shape, text, subject, sub-type, super-type, etc., may be determined. According to some examples, the method includes algorithmically mapping the tidyable objects into related groups and into locations on or in the shelves, portions of shelves, or bins at block 2016 based on classification, size, and characteristics, as determined in the previous blocks. In one embodiment, a constrained clustering algorithm to map objects to shelves or bins. The goal of block 2016 may be to map tidyable objects, singly or in groups, to shelf and bin space using a one-to-one mapping where the combined size of a clustered group or single object is less than the size of the space available on the shelf or in the bin.

In one embodiment, constrained k-means clustering may be used to algorithmically map tidyable objects into related groups. “Constrained clustering” refers to a class of data clustering algorithms that incorporate “must-link constraints” and/or “cannot-link constraints.” Both must-link and cannot-link constraints define a relationship between two data instances among the data instances to be clustered. A must-link constraint may specify that the two instances in the must-link relation may be associated with the same cluster. A cannot-link constraint may specify that the two instances in the cannot-link relation may not be associated with the same cluster. Together, these sets of constraints may act as a guide for the algorithm to determine clusters in the dataset which satisfy the specified constraints. (Paraphrased from “Constrained clustering”, Wikipedia, The Free Encyclopedia, https://en.wikipedia.org/wiki/Constrained_clustering, as edited on 18 Jan. 2025 at 5:57 (UTC).)

“k-means clustering” refers to a method of vector quantization that partitions n observations into k clusters in which each observation belongs to the cluster with the nearest mean (cluster center or centroid), which may serve as a prototype of the cluster. This form of clustering may minimize variance among members of the cluster. Given a set of observations (x₁, x₂, . . . , xₙ), where each observation is a d-dimensional real vector, k-means clustering aims to partition the n observations into k (≤n) sets S={S₁, S₂, . . . , Sₖ} so as to minimize the within-cluster sum of squares (WCSS) (i.e. variance). This may minimize the pairwise squared deviations of points in the same cluster. Since the total variance is constant, this may maximize the sum of squared deviations between members of different clusters. (Paraphrased from “k-means clustering”, Wikipedia, The Free Encyclopedia, https://en.wikipedia.org/wiki/K-means_clustering, as edited on 5 Feb. 2025 at 5:57 (UTC).)

In other embodiments, alternative clustering algorithms may be implemented. Such alternatives may include k-modes clustering, which may have advantages in handling categorical data using modes (most common occurrences) rather than means (averages). K-medoids clustering may be used, which clusters around existing points, called medoids, instead of creating new centroid points. Hierarchical clustering may be implemented in some embodiments to recursively merge smaller clusters. This may be helpful in handling must-link and cannot-link constraints. In one embodiment, constrained spectral clustering, a clustering algorithm based on graph theory, may also be beneficial for use with must-link and cannot-link constraints. Density-based spatial clustering of applications with noise (DBSCAN) may be used in one embodiment. DBSCAN groups points based on density and may be beneficial in handling outliers. In another embodiment, Gaussian mixture models, which are probabilistic models of clustering, may be used. Other models may be implemented as will be readily understood by one of ordinary skill in the art.

In the present disclosure, a data instance undergoing clustering may be a vector representation of the characteristics of a tidyable object. Each tidyable object detected may be assigned numerical values for various characteristics such as color, size, etc., and these vectors may be algorithmically compared for similarity and thus processed into clusters. Various characteristics and classifications determined for detected tidyable objects as disclosed herein may be used to develop the constraints and the cluster means or centers described above in order to algorithmically map the objects into groups via constrained k-means clustering. Clustering may be performed with some attributes and characteristics weighted more strongly than others. For example, object type, sub-type, and super-type may be weighted more strongly than color, size, shape, text, subject, etc. Pseudocode provided in Code Example 1 through Code Example 5 below may be used to implement the disclosed solution using constrained k-means clustering.

Specific constraints may be applied by the constrained k-means clustering algorithm to improve how k-means clustering works in addressing the groups of objects detected for organization by the tidying robot 100 through the automated organization assessment subroutine 2000. In one embodiment, a number of clusters may be specified that matches a number of bins or shelves available for organization. For example, where there are five shelves available, k-means clustering may be run into five clusters, or into a range such as three to five clusters. K-means clustering may be rerun clustering varying n_clusters in order to determine an optimal number of clusters for the scenario, or to determine a number of clusters with silhouette analysis.

Footprint or volume constraints may be placed on the k-means clustering in order to ensure that each cluster may fit onto one shelf, one portion of a shelf, or into one bin. Shelves and bins may vary in footprint and volume, respectively. As such, this may not be a uniform constraint. For example, three clusters may be identified as needing to fit into bins that are 30 cm cubes and two clusters may need to fit into 25 cm cube bins. There may also be size constraints on the count or number of items that go into each bin or onto each shelf.

In one embodiment, “anchor items” may be used to guide the clustering algorithm with a combination of must-link constraints and cannot-link constraints. For example, a user may indicate one or a few items that they want to go on a specific shelf or into a specific bin. Items the user wants on the same shelf/bin may have must-link constraints, and items the user places on different shelves/bins may have cannot-link constraints. In one embodiment, the tidying robot 100 may also run a classification algorithm (or use an item type lookup table) to identify common anchor items, which may be definitive items that represent common categories (e.g., a cellphone for electronics, a shirt for clothing, or a plate for dishware). A large language model may also be used to select anchor items by asking which specific item types (from a list of items being organized) would be best to represent intuitive categories.

In one embodiment, a bin-label constraint or a shelf-label constraint may be used. In such a case, items that have a type that matches the label may be constrained to go into that bin or onto that shelf if there is sufficient space available.

According to some examples, the method includes generating descriptive labels for the groups of tidyable objects of similar types or characteristics at block 2018. The descriptive label may incorporate multiple attributes of objects in the group. A list of common attributes shared by all or most of the objects in a group may be determined. If no common attributes for all objects are detected, the attributes most frequently detected among members of the group may be noted. Among these attributes, the most descriptive or specific and non-overlapping may be examined. For example, object sub-type may be used instead of object type. The chosen attributes may be used to generate the descriptive label. In one embodiment, a conjunction may be included in the descriptive label where a group has two or more competing attributes. For example, “dress socks” may be developed as a descriptive label in one case. In another, “socks and underwear” may be determined upon. A label of “LEGO and action figures” may be selected rather than “toys” in another instance.

According to some examples, the method includes generating related non-standard location labels for the shelves, portions of shelves, or bins that the groups of tidyable objects are mapped to at block 2020. These non-standard location labels may include the type of storage space used and the descriptive label based on the characteristics of the group designated to occupy it, generated in block 2018.

### EXEMPLARY PSEUDOCODE

### Code Example 1—Basic k-Means Clustering

```
import numpy as np
import pandas as pd
import itertools
from sklearn.cluster import KMeans
from sklearn.preprocessing import OneHotEncoder
# Shelf count
number_of_shelves = 3
max_footprint_per_shelf = 1000
# Sample dataset
data = pd.DataFrame({
    “color”: [“white”, “red”, “white”, “red”, “black”,
“white”, “green”, “black”, “white”],
    “shape”: [“rectangular”, “circular”, “circular”,
“rectangular”, “irregular”, “rectangular”, “triangular”,
“irregular”, “rectangular”],
    “material”: [“wood-paper”, “plastic”, “plastic”,
“plastic”, “ceramic”, “wood-paper”, “ceramic”, “metal”,
“wood-paper”],
    “super-type”: [“pantry”, “cleaning”, “dishware”,
“cleaning”, “dishware”, “medicine”, “dishware”, “tools”,
“stationery”],
    “type”:[“cereal”, “disinfectant”, “plate”, “sponge”,
“mug”, “bandages”, “bowl”, “screwdriver”, “notebook”],
    “footprint”:[600, 50, 490, 96, 64, 96, 314, 60, 660]
  })
# Get the number of objects
item_count = data.shape[0]
avg_items_per_shelf = item_count // number_of_shelves
max_items_per_shelf = avg_items_per_shelf + 1
min_items_per_shelf = avg_items_per_shelf − 1
# One-hot encoding of categories
encoder = OneHotEncoder( )
encoded_data = encoder.fit_transform(data).toarray( )
# Apply K-Means clustering
kmeans = KMeans(n_clusters=number_of_shelves,
random_state=42, n_init=10)
labels = kmeans.fit_predict(encoded_data)
########
# Alternatively, we may use a specialized KMeansConstrained
library with constraints like:
# size_min=min_items_per_shelf,
# size_max=min_items_per_shelf,
# footprint_max=max_footprint_per_shelf
########
# Or, we might write code to redistribute nodes to different
clusters here in order to apply post-processing constraints
#
# Add cluster labels back to the original dataframe
data[“cluster”] = labels
print(data)
```

### Code Example 2—Weighting Super-Type and Type Categories

Code Example 2 gives more weight to the super-type and type categories and less weight to color and shape categories. As a result, clustering by super-type and type may be prioritized, but clustering may also occur based on color, shape, and material if necessary. For example, there may be an overabundance of one super-type, such as dishware, which may need to be organized on multiple shelves. In such a case, the clustering algorithm may first try to place all dishware (e.g., bowls, plates, and cups) together on the same shelf. It may next try to place all plates together on a shelf and all bowls together on a shelf. Then it may try to place all ceramic plates together a shelf, and all plastic plates together on a shelf. It may next try to organize by color (e.g., all pink plates together) and shape (e.g., all square plates together) if necessary.

```
# Feature names excluding footprint
feature_names =
encoder.get_feature_names_out(data.drop(columns=[“footprint”]
).columns
# Adjusted category weights
category_weights = {
  “super-type”: 4.0,
  “type”: 2.0,
  “shape”: 0.5,
  “color”: 0.5,
  “material”: 1.0
}
# Create weight array
weights = np.array([category_weights[feature.split(“_”)[0]]
for feature in feature_names]
# Apply weights
encoded_data = encoded_data * weights
```

### Code Example 3—Cannot and Must Link Constraints with a Specialized Library

Cannot link and must link constraints may be used together with a specialized KMeansConstrained library. Cannot link constraints may include saying cleaning supplies and food cannot be grouped together. Must link constraints may include saying that plates and bowls need to be grouped together.

super_type_indices = {super_type: data.index[data[“super-
type”] == super_type].tolist( ) for super_type in data[“super-
type”].unique( )}
type_indices = {item_type: data.index[data[“type”] ==
item_type].tolist( ) for item_type in data[“type”].unique( )}
material_indices = {material: data.index[data[“material”] ==
material].tolist( ) for material in data[“material”].unique( )}
# Cannot-link constraint: “pantry” and “cleaning” cannot be
in the same category
cannot_link =
list(itertools.product(super_type_indices[“pantry”],
super_type_indices[“cleaning”]))
# Must-link constraint: “screwdriver” and “notebook” must be
in the same category
must_link =
list(itertools.product(type_indices[“screwdriver”],
type_indices[“notebook”]))
# Cannot-link constraint: “ceramic” and “plastic” cannot be
in the same category
cannot_link +=
list(itertools.product(material_indices[“ceramic”],
material_indices[“plastic”]))
#Node indices that must be linked
print(must_link)
#Must-link: [(7, 8)]
#Node indices that cannot be linked
print(cannot_link)
#Cannot-link: [(0, 1), (0, 3), (4, 1), (4, 2), (4, 3), (6,
1), (6, 2), (6, 3)]

### Code Example 4—Rebalancing in Post-Processing

Post-processing may be used to rebalance clusters and enforce maximum footprint constraints. For each cluster, the algorithm may find the nodes furthest from the centroid of the cluster. For each of these nodes, it may find the closest adjacent cluster where moving that node would not violate the maximum footprint constraint. If the current cluster's total footprint exceeds the maximum footprint constraint and moving the node would not cause the destination cluster to exceed the maximum footprint constraint, then the algorithm may move the node.

```
# Balance clusters exceeding footprint constraint
def balance_cluster_footprint(data, encoded_data, kmeans,
max_footprint_per_shelf):
  cluster_footprints =
data.groupby(“cluster”)[“footprint”].sum( ).to_dict( )
  while any (fp > max_footprint_per_shelf for fp in
cluster_footprints.values( )):
    for cluster_id in range(number_of_shelves):
      if cluster_footprints[cluster_id] <=
max_footprint_per_shelf:
        continue
      cluster_data = data[data[“cluster”] == cluster_id]
      cluster_centroid =
kmeans.cluster_centers_[cluster_id]
      distances =
np.linalg.norm(encoded_data[cluster_data.index] −
cluster_centroid, axis=1)
      sorted_indices = cluster_data.index[np.argsort(−
distances)] # Furthest first
      for idx in sorted_indices:
        node_footprint = data.loc[idx, “footprint”]
        distances_to_centroids =
np.linalg.norm(kmeans.cluster_centers_ − encoded_data[idx],
axis=1)
        for next_cluster_id in
np.argsort(distances_to_centroids):
          if next_cluster_id != cluster_id and
(cluster_footprints[next_cluster_id] + node_footprint) <=
max_footprint_per_shelf:
            data.at[idx, “cluster”] = next_cluster_id
            cluster_footprints[cluster_id] −=
node_footprint
            cluster_footprints[next_cluster_id] +=
node_footprint
            break
        if cluster_footprints[cluster_id] <=
max_footprint_per_shelf:
          break
  return data
# Balance cluster footprints
data = balance_cluster_footprint(data, encoded_data, kmeans,
max_footprint_per_shelf)
```

### Code Example 5—Python with Hierarchical Clustering Instead of k-Means

```
import pandas as pd
import numpy as np
from sklearn.preprocessing import OneHotEncoder
from sklearn.cluster import AgglomerativeClustering
import scipy.cluster.hierarchy as sch
import matplotlib.pyplot as plt
# Sample dataset
data = {
  “color”: [“white”, “red”, “white”, “red”, “black”,
“white”, “green”, “black”, “white”],
  “shape”: [“rectangular”, “circular”, “circular”,
“rectangular”, “irregular”, “rectangular”, “triangular”,
“irregular”, “rectangular”],
  “material”: [“wood-paper”, “plastic”, “plastic”,
“plastic”, “ceramic”, “wood-paper”, “ceramic”, “metal”,
“wood-paper”],
  “super-type”: [“pantry”, “cleaning”, “dishware”,
“cleaning”, “dishware”, “medicine”, “dishware”, “tools”,
“stationery”],
  “type”: [“cereal”, “disinfectant”, “plate”, “sponge”,
“mug”, “bandages”, “bowl”, “screwdriver”, “notebook”],
  “footprint”: [600, 50, 490, 96, 64, 96, 314, 60, 660]
}
df = pd.DataFrame(data)
# One-hot encoding of categories
encoder = OneHotEncoder( )
categorical_features = df.iloc[:, :−1] # Exclude “footprint”
categorical_encoded =
encoder.fit_transform(categorical_features).toarray( )
# Re-add “footprint”
X = np.hstack((categorical_encoded,
df[[‘footprint’]].values))
# Run hierarchical clustering
clustering = AgglomerativeClustering(n_clusters=3,
linkage=‘ward’)
clusters = clustering.fit_predict(X)
# Add cluster labels back to the original dataframe
df[‘cluster’] = clusters
print(df)
```

FIG. 21A-FIG. 21E illustrate an obstruction placement procedure 2100 in accordance with one embodiment. In steps 2102a-2102k of this process, a tidying robot 2126 may operate to approach a destination 2132 with access panels 2134 having handles 2124 allowing access to an interior of the destination 2138, as well as storage platforms 2136, such as closed storage location 2104 having handled cabinet doors 2106 and shelves 2108 for storing portable bins 2110. The portable bins 2110 may be configured to be lifted and carried by the tidying robot 2126.

In step 2102a, the tidying robot 2126 may approach a closed storage location 2104 such as a cabinet or closet having closed cabinet doors 2106, behind which are stored portable bins 2110 on shelves 2108. The lifting column 2128 may be raised to a height appropriate to engage with a desired cabinet door 2106 handle 2124 of the closed storage location 2104. In step 2102b, the tidying robot 2126 may extend its gripper arm 2130 toward the handle 2124 of the desired cabinet door 2106. The tidying robot 2126 may follow an algorithm to explore the closed storage location 2104 and identify different portable bins 2110 and their locations within it to detect the correct one, may store a lookup table of specific portable bin 2110 locations, etc.

In step 2102c, the gripper arm 2130 (or actuated gripper 2306) may engage with and close around the cabinet door 2106 handle 2124 in order to grasp it. In step 2102d, the gripper arm linear actuator 2142 may retract, the scoop arm linear actuator 2140 may retract, or the tidying robot 2126 may drive backwards to open the cabinet door 2106. Note that the base of the gripper arm 2130 may allow some deflection (e.g., by incorporating a spring) as the cabinet door 2106 likely rotates while opening. The tidying robot 2126 may also turn in its entirety or the lifting column 2128 may rotate slightly to account for the rotation of the opening cabinet door 2106.

In step 2102e, the movable scoop walls 2112 may rotate back into the scoop 2144 or otherwise out of the way so that sides of the scoop 2144 don't interfere with the scoop 2144 passing beneath portable bins 2110. Similarly, the gripper arm 2130 and pusher pads 2146 may be moved so as to avoid obstructing engagement of the scoop 2144 with the portable bin 2110. In this position, the scoop 2144 may be considered to be in a “forklift” configuration (forklift configuration 2114) for engaging with the desired portable bin 2110. In step 2102f, the tidying robot 2126 may extend the scoop arm linear actuator 2140 or may drive forward so that the scoop 2144 passes beneath the portable bin 2110 in the closed storage location 2104. The lifting column linear actuator 2148 may be extended to lift the portable bin 2110 slightly up off of the closed storage location 2104 shelf 2108.

In one embodiment, the portable bin 2110 may have a scoop slot 2116 that includes a scoop slot opening 2118. The scoop slot opening 2118 may allow the scoop 2144 to pass into the scoop slot 2116, and the scoop slot 2116 may allow the portable bin 2110 to remain engaged with the scoop 2144 as the scoop 2144 is manipulated into various positions and orientations. In step 2102f, the scoop arm linear actuator 2140 may extend and insert the scoop 2144 into the scoop slot opening 2118 until a known position is reached or a force detector detects resistance indicating that the scoop 2144 is fully seated within the scoop slot 2116.

In step 2102g, the tidying robot 2126 may back away from the closed storage location 2104 and/or retract the scoop arm linear actuator 2140, moving the portable bin 2110 out of the closed storage location 2104. In step 2102h, the tidying robot 2126 may tilt the scoop 2144 up and back while extending the gripper arm 2130 to grasp the cabinet door 2106. The tidying robot 2126 may then close the cabinet door 2106 by pushing with the gripper arm 2130.

In step 2102i, after closing the cabinet door 2106, the tidying robot 2126 may drive away while carrying the portable bin 2110. In step 2102j, the tidying robot 2126 may lower the portable bin 2110 onto the floor 2120. The portable bin 2110 may also be placed by the tidying robot 2126 onto a table, a countertop, or other stable, flat surface 2122. In step 2102k, the tidying robot 2126 may back up, leaving the portable bin 2110 on the floor 2120 or other surface. The portable bin 2110 may include legs or a slot under it so the tidying robot 2126 may easily remove its scoop 2144 from under the portable bin 2110.

FIG. 22A-FIG. 22D illustrate a process for tidying tidyable objects from a table into a bin 2200 in accordance with one embodiment. Steps 2202a-2202k illustrate a tidying robot 2126 completing the actions needed for this process. In step 2202a, the tidying robot 2126 may drive to an elevated surface 2204 such as a table that has tidyable objects 2206 on it, with the lifting column 2128 set at a height such that the scoop 2144 and pusher pads 2146 are higher than the top of the elevated surface 2204. The tidying robot 2126 may continue to drive toward the elevated surface 2204 in step 2202b with the first pusher pad 2210 and second pusher pad 2208 extended forward so that the target tidyable objects 2206 may fit between them.

The tidying robot 2126 may drive forward in step 2202c so that the tidyable objects 2206 are in front of the scoop 2144 and in between the first pusher pad 2210 and second pusher pad 2208. The second pusher pad arm 2212 and first pusher pad arm 2214 may be extended so that the first pusher pad 2210 and second pusher pad 2208 are past the tidyable objects 2206. In step 2202d, the first pusher pad 2210 and the second pusher pad 2208 may be closed into a wedge configuration so that there is no gap between the tips of the pusher pads. In step 2202c, the tidying robot 2126 may retract the first pusher pad arm linear actuator 2218 and second pusher pad arm linear actuator 2216 so that the tidyable objects 2206 are fully surrounded by the pusher pads 2146 and the scoop 2144.

In step 2202f, the tidying robot 2126 may close the second pusher pad 2208 so that the tidyable objects 2206 are pushed across the front edge 2224 of the scoop 2144. The first pusher pad 2210 may move slightly to make space and to prevent a gap from forming between the first pusher pad 2210 and the second pusher pad 2208. Alternatively, the first pusher pad 2210 may be closed instead. In step 2202g, the pusher pad arm 2222 pusher pad arm linear actuators 2220 may be retracted to further push the tidyable objects 2206 into the scoop 2144. In step 2202h, the first pusher pad 2210 and second pusher pad 2208 may be fully closed across the front of the scoop 2144.

In step 2202i, the tidying robot 2126 may tilt the scoop 2144 up and back, creating a “bowl” configuration in order to carry the tidyable objects 2206. In step 2202j, the tidying robot 2126 may drive to and may dock with a portable bin 2110. The tidying robot 2126 may lower the lifting column 2128 using the lifting column linear actuator 2148, thereby lowering the scoop 2144 to be just above the portable bin 2110. In step 2202j or previously, the tidying robot 2126 may rotate the pusher pad arms 2222 to move the pusher pads 2146 away from the front of the scoop 2144. The tidying robot 2126 may tilt the scoop 2144 forward in a front dump action 700 such as is illustrated with respect to FIG. 7. In step 2202k, the tidyable objects 2206 may fall off of the scoop 2144 and into the portable bin 2110.

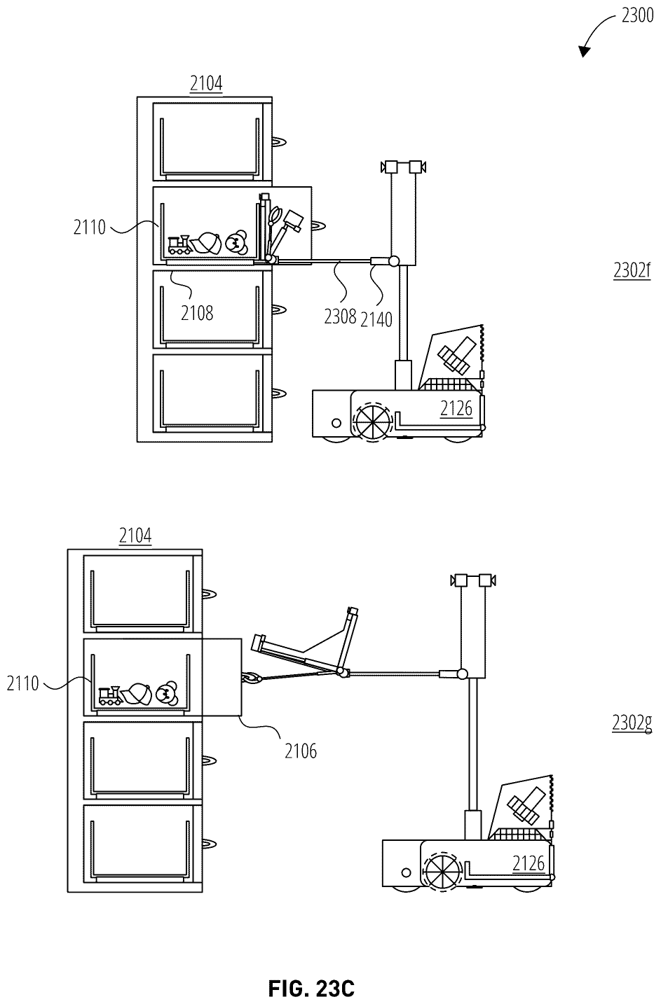

FIG. 23A-FIG. 23D illustrate a portable bin placement procedure 2300 in accordance with one embodiment. Steps 2302a-2302h illustrate a tidying robot 2126 completing the actions needed for this process. In step 2302a, the tidying robot 2126 may lower the scoop 2144 to ground level (or countertop/table level) so that the bottom of the scoop 2144 is flat, just above the found, table, or countertop surface. The movable scoop wall 2112 may be rotated, retracted, or otherwise repositioned so that the scoop 2144 is configured in a forklift configuration 2114 where the side walls of the scoop 2144 will not interfere with the scoop 2144 going under bins or sliding into a scoop slot 2116 of a portable bin 2110. In step 2302b the tidying robot 2126 may drive forward so that the scoop 2144 goes under the bottom of the bin. This may be facilitated by configuring the bin with legs or a slot, making it easy for bottom of the scoop 2144 to slide under the bin. In step 2302c, the tidying robot 2126 may lift the portable bin 2110 full of tidyable objects 2206 and may navigate along a return approach path 2304 to a closed storage location 2104 having cabinet doors 2106 with handles 2124 and shelves 2108 for storing portable bins 2110.

In step 2302d, the tidying robot 2126 may extend its actuated gripper 2306 and use the actuated gripper 2306 to open the closed storage location 2104 cabinet door 2106 behind which it wishes to place the portable bin 2110. In step 2302e, the tidying robot 2126 may align the scoop 2144 to be flat and level with the closed storage location 2104 shelf 2108.

In step 2302f, the tidying robot 2126 may drive forward or may extend the scoop arm 2308 scoop arm linear actuator 2140 so that the portable bin 2110 is held slightly above the closed storage location 2104 shelf 2108. The tidying robot 2126 may then lower the scoop 2144 slightly so the portable bin 2110 is supported by the closed storage location 2104 shelf 2108. In step 2302g, the tidying robot 2126 may back up, leaving the portable bin 2110 in the closed storage location 2104. The tidying robot 2126 may use the actuated gripper 2306 to close the closed storage location 2104 cabinet door 2106. The portable bin 2110 full of tidyable object 2206 is now put away in the closed storage location 2104 that has been closed, as shown in step 2302h.

FIG. 24A-FIG. 24C illustrate a process for emptying tidyable objects from a bin and sorting them on the floor 2400 in accordance with one embodiment. Steps 2402a-2402g illustrate a tidying robot 2126 completing the actions needed for this process. In step 2402a, the bottom of the scoop 2144 of the tidying robot 2126 may reside within the scoop slot 2116 under the portable bin 2110 full of tidyable objects 2206, which may be accomplished in a manner similar to that described previously. The left and right pusher pads 2146 may be closed in front of the portable bin 2110.

In step 2402b, the scoop 2144 may tilt forward into an inverted position 2404, but the portable bin 2110 may still be retained due to the bottom of the scoop 2144 being through the scoop slot 2116 on the portable bin 2110 while the pusher pads 2146 keep the portable bin 2110 from sliding forward.

In step 2402c, the tidyable objects 2206 may fall out of the portable bin 2110 onto the floor (or another destination location such as a play mat, table, countertop, bed, or toy chest). In step 2402d, the scoop 2144 may be tilted back up and back. The tidying robot 2126 may continue to carry the now empty portable bin 2110.

Tidyable objects 2206 may be sorted by the tidying robot 2126 on the floor in step 2402c. In step 2402f, the second pusher pad 2208 may be driven forward between tidyable objects 2206 in order to separate the target object(s), such as the target object 2406 shown, from objects that are intended to be left on the floor. Alternatively, the first pusher pad 2210 may be used to separate the target object(s) from those intended to remain on the floor, though this is not illustrated.

In step 2402g, the second pusher pad 2208 may rotate closed, pushing the target object 2406 onto the scoop 2144. The scoop 2144 may be then lifted up and back in order to carry the target object 2406 or target objects 2406 and then dump them into a target bin or another target location.

FIG. 25 depicts an embodiment of a robotic control system 2500 to implement components and process steps of the systems described herein. In one embodiment, some or all portions of the robotic control system 2500 and its operational logic may be contained within the physical components of a robot such as the tidying robot 100 introduced in FIG. 1A. In one embodiment, some or all portions of the robotic control system 2500 and its operational logic may be contained within a cloud server in communication with the tidying robot 100. In one embodiment, some or all portions of the robotic control system 2500 may be contained within a user's mobile computing device, such as the mobile computing device 1504 introduced in FIG. 15, including a smartphone, tablet, laptop, personal digital assistant, or other such mobile computing devices. In one embodiment, the portions of the robotic control system 2500 may be physically distributed among any two or three of the robot, the cloud server, and the mobile computing device. In one embodiment, aspects of the robotic control system 2500 on a cloud server may control more than one robot at a time, allowing multiple robots to work in concert within a working space. In one embodiment, aspects of the robotic control system 2500 on a mobile computing device may control more than one robot at a time, allowing multiple robots to work in concert within a working space.

Input devices 2504 (e.g., of a robot or companion device such as a mobile phone or personal computer) comprise transducers that convert physical phenomena into machine internal signals, typically electrical, optical, or magnetic signals. Signals may also be wireless in the form of electromagnetic radiation in the radio frequency (RF) range but also potentially in the infrared or optical range. Examples of input devices 2504 are contact sensors which respond to touch or physical pressure from an object or proximity of an object to a surface, mice which respond to motion through space or across a plane, microphones which convert vibrations in the medium (typically air) into device signals, scanners which convert optical patterns on two or three-dimensional objects into device signals. The signals from the input devices 2504 are provided via various machine signal conductors (e.g., busses or network interfaces) and circuits to memory 2506.

The memory 2506 is typically what is known as a first- or second-level memory device, providing for storage (via configuration of matter or states of matter) of signals received from the input devices 2504, instructions and information for controlling operation of the central processing unit or processor 2502, and signals from storage devices 2510. The memory 2506 and/or the storage devices 2510 may store computer-executable instructions and thus forming logic 2514 that when applied to and executed by the processor 2502 implement embodiments of the processes disclosed herein. Logic 2514 may include portions of a computer program, along with configuration data, that are run by the processor 2502 or another processor. Logic 2514 may include one or more machine learning models 2516 used to perform the disclosed actions. In one embodiment, portions of the logic 2514 may also reside on a mobile or desktop computing device accessible by a user to facilitate direct user control of the robot.

Information stored in the memory 2506 is typically directly accessible to the processor 2502 of the device. Signals input to the device cause the reconfiguration of the internal material/energy state of the memory 2506, creating in essence a new machine configuration, influencing the behavior of the robotic control system 2500 by configuring the processor 2502 with control signals (instructions) and data provided in conjunction with the control signals.

Second- or third-level storage devices 2510 may provide a slower but higher capacity machine memory capability. Examples of storage devices 2510 are hard disks, optical disks, large-capacity flash memories or other non-volatile memory technologies, and magnetic memories.

In one embodiment, memory 2506 may include virtual storage accessible through a connection with a cloud server using the network interface 2512, as described below. In such embodiments, some or all of the logic 2514 may be stored and processed remotely.

The processor 2502 may cause the configuration of the memory 2506 to be altered by signals in storage devices 2510. In other words, the processor 2502 may cause data and instructions to be read from storage devices 2510 in the memory 2506 which may then influence the operations of processor 2502 as instructions and data signals, and which may also be provided to the output devices 2508. The processor 2502 may alter the content of the memory 2506 by signaling to a machine interface of memory 2506 to alter the internal configuration and then converted signals to the storage devices 2510 alter its material internal configuration. In other words, data and instructions may be backed up from memory 2506, which is often volatile, to storage devices 2510, which are often non-volatile.

Output devices 2508 are transducers that convert signals received from the memory 2506 into physical phenomena such as vibrations in the air, patterns of light on a machine display, vibrations (i.e., haptic devices), or patterns of ink or other materials (i.e., printers and 3-D printers).

The network interface 2512 receives signals from the memory 2506 and converts them into electrical, optical, or wireless signals to other machines, typically via a machine network. The network interface 2512 also receives signals from the machine network and converts them into electrical, optical, or wireless signals to the memory 2506. The network interface 2512 may allow a robot to communicate with a cloud server, a mobile device, other robots, and other network-enabled devices.

In one embodiment, a global database 2518 may provide data storage available across the devices that comprise or are supported by the robotic control system 2500. The global database 2518 may include maps, robotic instruction algorithms, robot state information, static, movable, and tidyable object reidentification fingerprints, labels, and other data associated with known static, movable, and tidyable object reidentification fingerprints, or other data supporting the implementation of the disclosed solution. The global database 2518 may be a single data structure or may be distributed across more than one data structure and storage platform, as may best suit an implementation of the disclosed solution. In one embodiment, the global database 2518 is coupled to other components of the robotic control system 2500 through a wired or wireless network, and in communication with the network interface 2512.

In one embodiment, a robot instruction database 2520 may provide data storage available across the devices that comprise or are supported by the robotic control system 2500. The robot instruction database 2520 may include the programmatic routines that direct specific actuators of the tidying robot 100, such as are described with respect to FIG. 1A-FIG. 1D, as well as other embodiments of a tidying robot such as are disclosed herein, to actuate and cease actuation in sequences that allow the tidying robot to perform individual and aggregate motions to complete tasks.

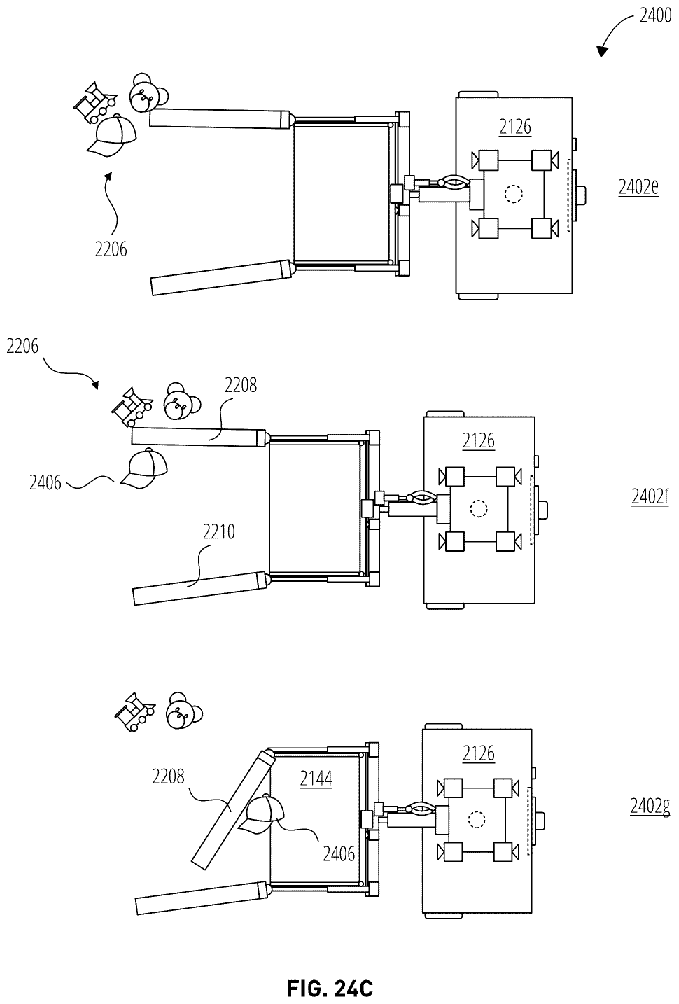

FIG. 26 illustrates sensor input analysis 2600 in accordance with one embodiment. Sensor input analysis 2600 may inform the tidying robot 100 of the dimensions of its immediate environment 2602 and the location of itself and other objects within that environment 2602.

The tidying robot 100 as previously described includes a sensing system 106. This sensing system 106 may include at least one of cameras 2604, IMU sensors 2606, lidar sensor 2608, odometry 2610, and actuator force feedback sensor 2612. These sensors may capture data describing the environment 2602 around the tidying robot 100.

Image data 2614 from the cameras 2604 may be used for object detection and classification 2616. Object detection and classification 2616 may be performed by algorithms and models configured within the robotic control system 2500 of the tidying robot 100. In this manner, the characteristics and types of objects in the environment 2602 may be determined.

Image data 2614, object detection and classification 2616 data, and other sensor data 2618 may be used for a global/local map update 2620. The global and/or local map may be stored by the tidying robot 100 and may represent its knowledge of the dimensions and objects within its decluttering environment 2602. This map may be used in navigation and strategy determination associated with decluttering tasks. In one embodiment, image data 2614 may undergo processing as described with respect to the image processing routine 2700 illustrated in FIG. 27.

The tidying robot 100 may use a combination of camera 2604, lidar sensor 2608 and the other sensors to maintain a global or local area map of the environment and to localize itself within that. Additionally, the robot may perform object detection and object classification and may generate visual re-identification fingerprints for each object. The robot may utilize stereo cameras along with a machine learning/neural network software architecture (e.g., semi-supervised or supervised convolutional neural network) to efficiently classify the type, size and location of different objects on a map of the environment.

The robot may determine the relative distance and angle to each object. The distance and angle may then be used to localize objects on the global or local area map. The robot may utilize both forward and backward facing cameras to scan both to the front and to the rear of the robot.

image data 2614, object detection and classification 2616 data, other sensor data 2618, and global/local map update 2620 data may be stored as observations, current robot state, current object state, and sensor data 2622. The observations, current robot state, current object state, and sensor data 2622 may be used by the robotic control systems 2500 of the tidying robot 100 in determining navigation paths and task strategies.

FIG. 27 illustrates an image processing routine 2700 in accordance with one embodiment. Detected images 2702 captured by the robot sensing system may undergo segmentation, such that areas of the segmented image 2704 may be identified as different objects, and those objects may be classified. Classified objects may then undergo perspective transform 2706, such that a map, as shown by the top down view at the bottom, may be updated with objects detected through segmentation of the image.

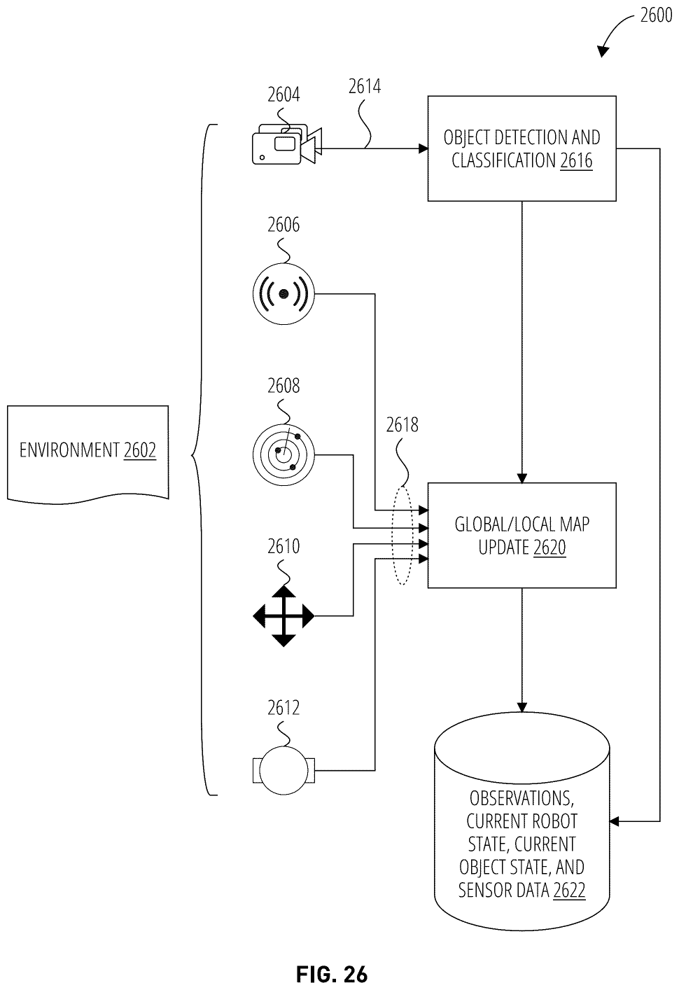

FIG. 28 illustrates a video-feed segmentation routine 2800 in accordance with one embodiment. Although the example video-feed segmentation routine 2800 depicts a particular sequence of operations, the sequence may be altered without departing from the scope of the present disclosure. For example, some of the operations depicted may be performed in parallel or in a different sequence that does not materially affect the function of the video-feed segmentation routine 2800. In other examples, different components of an example device or system that implements the video-feed segmentation routine 2800 may perform functions at substantially the same time or in a specific sequence.

According to some examples, the method includes receiving and processing live video with depth at block 2802. The live video feed may capture an environment to be tidied. For example, the mobile computing device 1504 illustrated in FIG. 15 may be configured to receive and process live video with depth using a camera configured as part of the mobile computing device 1504 in conjunction with the robotic control system 2500. This live video may be used to begin mapping the environment to be tidied, and to support the configuration and display of an AR user interface 3600 such as is described with respect to FIG. 36A. Alternatively, the tidying robot previously disclosed may be configured to receive and process live video with depth using their cameras 134 in conjunction with the robotic control system 2500. This may support the robot's initialization, configuration, and operation as disclosed herein. The live video feed may include images of a scene 2810 across the environment to be tidied. These may be processed to display an augmented reality view to a user on a global map of the environment to be tidied.

According to some examples, the method includes running a panoptic segmentation model 2808 to assign labels at block 2804. For example, the panoptic segmentation model 2808 illustrated in FIG. 28 may run a model to assign labels. The model may assign a semantic label (such as an object type), an instance identifier, and a movability attribute (such as static, movable, and tidyable) for each pixel in an image of a scene 2810 (such as is displayed in a frame of captured video). The panoptic segmentation model 2808 may be configured as part of the logic 2514 of the robotic control system 2500 in one embodiment. The panoptic segmentation model 2808 may in this manner produce a segmented image 2812 for each image of a scene 2810. Elements detected in the segmented image 2812 may in one embodiment be labeled as shown:
a. floor
b. rug
c. bedframe
d. nightstand
e. drawer
f. bedspread
g. box
h. lamp
i. books
j. picture
k. wall
l. curtains
m. headboard
n. pillow
o. stuffed animal
p. painting

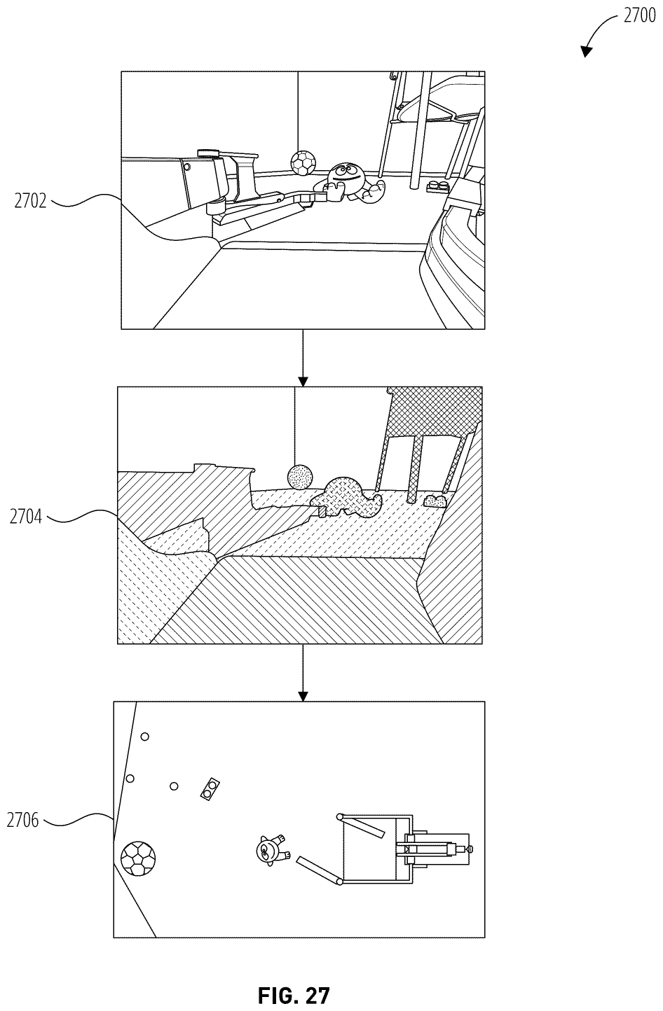

According to some examples, the method includes separating the segmented image into static objects 2816, movable objects 2818, and tidyable objects 2820 at block 2806. For example, the robotic control system 2500 illustrated in FIG. 25 may separate static, movable, and tidyable objects. Using the segmented image 2812 and assigned labels, static structures in the represented scene, such as floors, walls, and large furniture, may be separated out as static objects 2816 from movable objects 2818 like chairs, doors, and rugs, and tidyable objects 2820 such as toys, books, and clothing. Upon completion of the video-feed segmentation routine 2800, the mobile device, tidying robot, and robotic control system may act to perform the static object identification routine 2900 illustrated in FIG. 29 based on the objects separated into static objects, movable objects, and tidyable objects 2814.

FIG. 29 illustrates a static object identification routine 2900 in accordance with one embodiment. The mobile device, such as a user's smartphone or tablet or the tidying robot, may use a mobile device camera to detect static objects in order to localize itself within the environment, since such objects may be expected to remain in the same position.
The indoor room structure such as the floor segmentation, wall segmentation, and ceiling segmentation may be used to orient the mobile device camera relative to the floor plane. This may provide the relative vertical position and orientation of the mobile device camera relative to the floor, but not necessarily an exact position on the map.
Scale invariant keypoints may be generated using the pixels in the segmented image 2812 that correspond with static objects, and these keypoints may be stored as part of a local point cloud.
Reidentification fingerprints may also be generated for each static object in the image frame and stored as part of a local point cloud.
Matching takes place between the local point cloud (based on the current mobile device camera frame) and the global point cloud (based on visual keypoints and static objects on the global map). This is used to localize the mobile device camera relative to the global map.

The mobile device camera may be the cameras 134 mounted on the tidying robot as previously described. The mobile device camera may also be a camera configured as part of a user's smartphone, tablet, or other commercially available mobile computing device.

Although the example static object identification routine 2900 depicts a particular sequence of operations, the sequence may be altered without departing from the scope of the present disclosure. For example, some of the operations depicted may be performed in parallel or in a different sequence that does not materially affect the function of the static object identification routine 2900. In other examples, different components of an example device or system that implements the static object identification routine 2900 may perform functions at substantially the same time or in a specific sequence. This static object identification routine 2900 may be performed by the robotic control system 2500 described with respect to FIG. 25.

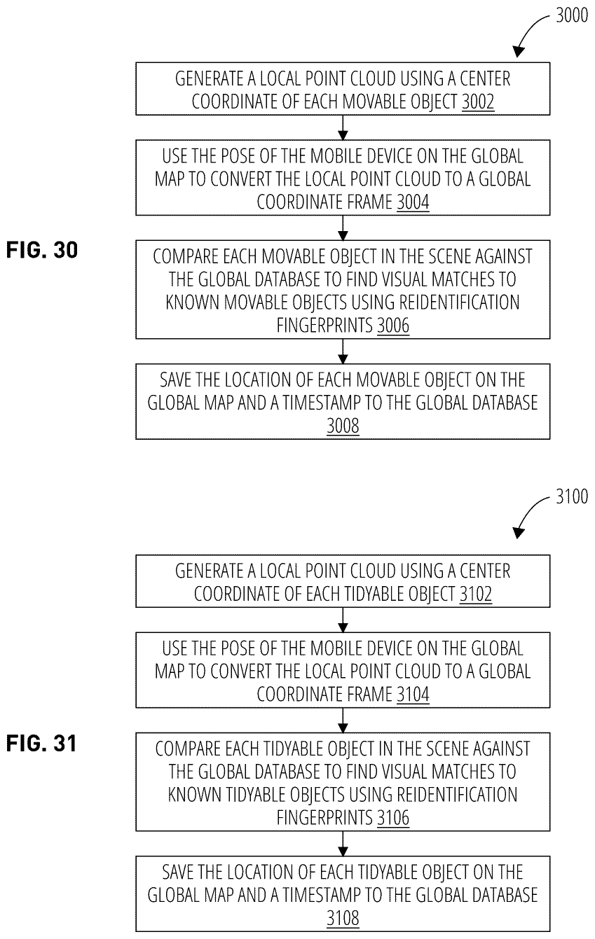

According to some examples, the method includes generating reidentification fingerprints, in each scene, for each static, movable, and tidyable object at block 2902. This may be performed using a segmented image including static scene structure elements and omitting other elements. These reidentification fingerprints may act as query sets (query object fingerprints 3208) used in the object identification with fingerprints 3200 process described with respect to FIG. 32A and FIG. 32B. According to some examples, the method includes placing the reidentification fingerprints into a global database at block 2904. The global database may store data for known static, movable, and tidyable objects. This data may include known object fingerprints to be used as described with respect to FIG. 32A and FIG. 32B.

According to some examples, the method includes generating keypoints for a static scene with each movable object removed at block 2906. According to some examples, the method includes determining a basic room structure using segmentation at block 2908. The basic room structure may include at least one of a floor, a wall, and a ceiling. According to some examples, the method includes determining an initial pose of the mobile device camera relative to a floor plane at block 2910.

According to some examples, the method includes generating a local point cloud including a grid of points from inside of the static objects and keypoints from the static scene at block 2912. According to some examples, the method includes comparing each static object in the static scene against the global database to find a visual match using the reidentification fingerprints at block 2914. This may be performed as described with respect to object identification with fingerprints 3200 of FIG. 32A and FIG. 32B. According to some examples, the method includes determining matches between the local static point cloud and the global point cloud using matching static objects and matching keypoints from the static scene at block 2916.

According to some examples, the method includes determining a current pose of the mobile device camera relative to a global map at block 2918. The global map may be a previously saved map of the environment to be tidied. According to some examples, the method includes merging the local static point cloud into the global point cloud and remove duplicates at block 2920. According to some examples, the method includes updating the current pose of the mobile device camera on the global map at block 2922.

According to some examples, the method includes saving the location of each static object on the global map and a timestamp to the global database at block 2924. In one embodiment, new reidentification fingerprints for the static objects may also be saved to the global database. The new reidentification fingerprints to be saved may be filtered to reduce the number of fingerprints saved for an object.

According to some examples, the method includes updating the global database with an expected location of each static object on the global map based on past location records at block 2926. According to some examples, if past location records are inconsistent for a static object, indicating that the static object has been moving, the method includes reclassifying the static object as a movable object at block 2928.

Reclassifying the static object as a movable object may include generating an inconsistent static object location alert. The inconsistent static object location alert may be provided to the robotic control system of a tidying robot, such as that illustrated in FIG. 25, as feedback to refine, simplify, streamline, or reduce the amount of data transferred to instruct the tidying robot to perform at least one robot operation. The static object may then be reclassified as a movable object by updating the object's movability attribute in the global database. The global map may also be updated to reflect the reclassified movable object. Operational task rules may be prioritized based on the movability attributes and/or the updated movability attributes, thereby optimizing the navigation of the tidying robot or increasing the efficiency in power utilization by the tidying robot.

According to some examples, the method includes instructing a tidying robot, using a robot instruction database, such as the robot instruction database 2520 described with respect to FIG. 25, to perform at least one task at block 2930. Tasks may include sorting objects on the floor, tidying specific objects, tidying a cluster of objects, pushing objects to the side of a room, executing a sweep pattern, and executing a vacuum pattern.

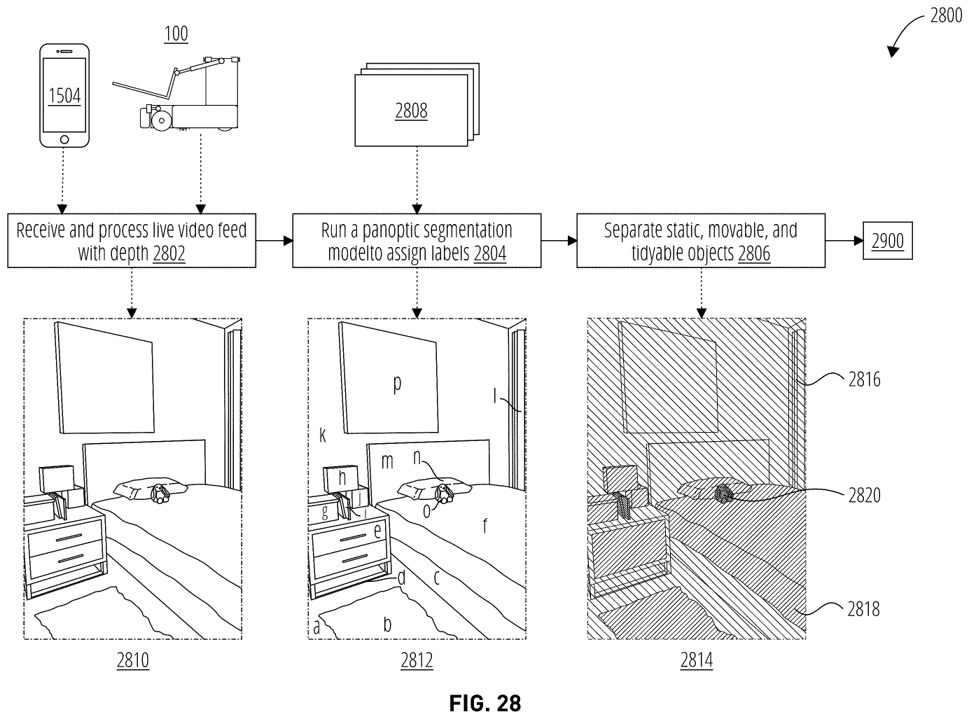

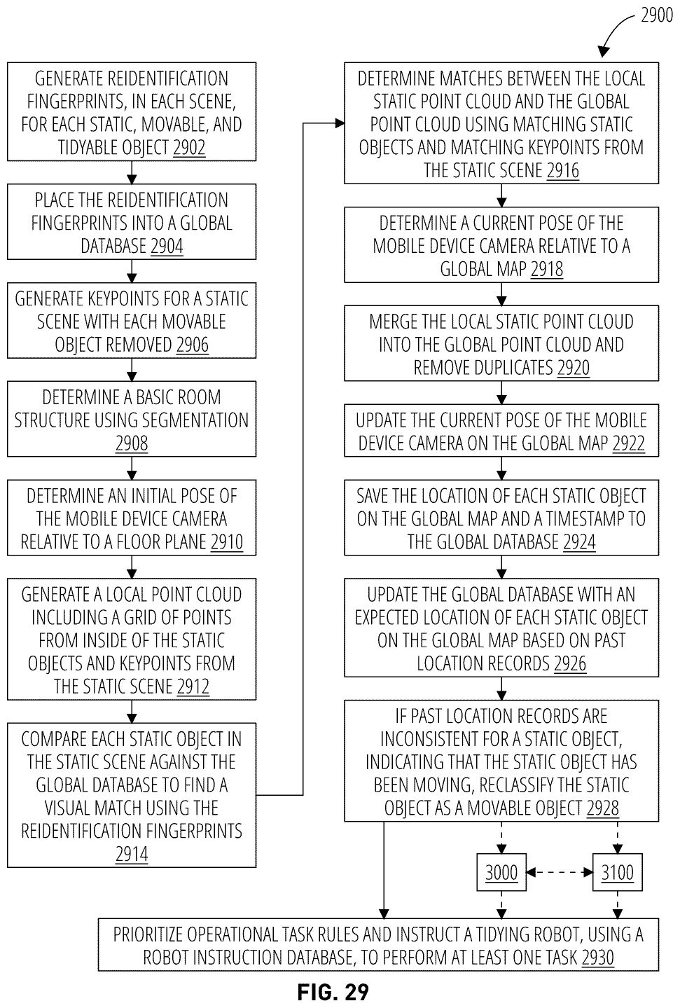

In one embodiment, the robotic control system may perform steps to identify moveable objects or tidyable objects after it has identified static objects. The static object identification routine 2900 may in one embodiment be followed by the movable object identification routine 3000 or the tidyable object identification routine 3100 described below with respect to FIG. 30 and FIG. 31, respectively. Either of these processes may continue on to the performance of the other, or to the instruction of the tidying robot at block 2930.

FIG. 30 illustrates a movable object identification routine 3000 in accordance with one embodiment. Although the example movable object identification routine 3000 depicts a particular sequence of operations, the sequence may be altered without departing from the scope of the present disclosure. For example, some of the operations depicted may be performed in parallel or in a different sequence that does not materially affect the function of the movable object identification routine 3000. In other examples, different components of an example device or system that implements the movable object identification routine 3000 may perform functions at substantially the same time or in a specific sequence.

According to some examples, the method includes generating a local point cloud using a center coordinate of each movable object at block 3002. According to some examples, the method includes using the pose of the mobile device (either a user's mobile computing device or the tidying robot) on the global map to convert the local point cloud to a global coordinate frame at block 3004. According to some examples, the method includes comparing each movable object in the scene against the global database to find visual matches to known movable objects using reidentification fingerprints at block 3006.

According to some examples, the method includes saving the location of each movable object on the global map and a timestamp to the global database at block 3008. In one embodiment, new reidentification fingerprints for the movable objects may also be saved to the global database. The new reidentification fingerprints to be saved may be filtered to reduce the number of fingerprints saved for an object.

FIG. 31 illustrates a tidyable object identification routine 3100 in accordance with one embodiment. Although the example tidyable object identification routine 3100 depicts a particular sequence of operations, the sequence may be altered without departing from the scope of the present disclosure. For example, some of the operations depicted may be performed in parallel or in a different sequence that does not materially affect the function of the tidyable object identification routine 3100. In other examples, different components of an example device or system that implements the tidyable object identification routine 3100 may perform functions at substantially the same time or in a specific sequence.

According to some examples, the method includes generating a local point cloud using a center coordinate of each tidyable object at block 3102. According to some examples, the method includes using the pose of the mobile device (either a user's mobile computing device or the tidying robot) on the global map to convert the local point cloud to a global coordinate frame at block 3104. According to some examples, the method includes comparing each tidyable object in the scene against the global database to find visual matches to known tidyable objects using reidentification fingerprints at block 3106.

According to some examples, the method includes saving the location of each tidyable object on the global map and a timestamp to the global database at block 3108. In one embodiment, new reidentification fingerprints for the tidyable objects may also be saved to the global database. The new reidentification fingerprints to be saved may be filtered to reduce the number of fingerprints saved for an object. In one embodiment, the user may next use an AR user interface to identify home locations for tidyable objects. These home locations may also be saved in the global database.

FIG. 32A and FIG. 32B illustrate object identification with fingerprints 3200 in accordance with one embodiment. FIG. 32A shows an example where a query set of fingerprints does not match the support set. FIG. 32B shows an example where the query set does match the support set.

A machine learning algorithm called meta-learning may be used to re-identify objects detected after running a panoptic segmentation model 2808 on a frame from an image of a scene 2810 as described with respect to FIG. 28. This may also be referred to as few-shot learning.

Images of objects are converted into embeddings using a convolutional neural network (CNN). The embeddings may represent a collection of visual features that may be used to compare visual similarity between two images. In one embodiment, the CNN may be specifically trained to focus on reidentifying whether an object is an exact visual match (i.e, determine if it is an image of the same object).

A collection of embeddings that represent a particular object may be referred to as a re-identification fingerprint. When re-identifying an object, a support set or collection of embeddings for each known object and a query set including several embeddings for the object being re-identified may be used. For example, for query object 3202, query object fingerprint 3208 may comprise the query set and may include query object embedding 3212, query object embedding 3216, and query object embedding 3220. Known objects 3204 and 3206 may each be associated with known object fingerprint 3210 and known object fingerprint 3236, respectively. Known object fingerprint 3210 may include known object embedding 3214, known object embedding 3218, and known object embedding 3222. Known object fingerprint 3236 may include known object embedding 3238, known object embedding 3240, and known object embedding 3242.

Embeddings may be compared in a pairwise manner using a distance function to generate a distance vector that represents the similarity of visual features. For example, distance function 3224 may compare the embeddings of query object fingerprint 3208 and known object fingerprint 3210 in a pairwise manner to generate distance vectors 3228. Similarly, the embeddings of query object fingerprint 3208 and known object fingerprint 3236 may be compared pairwise to generate distance vectors 3244.

A probability of match may then be generated using a similarity function that takes all the different distance vector(s) as input. For example, similarity function 3226 may use distance vectors 3228 as input to generate a probability of a match 3230 for query object 3202 and known object 3204. The similarity function 3226 may likewise use distance vectors 3244 as input to generate a probability of a match 3246 for query object 3202 and known object 3206. Note that because an object may look visually different when viewed from different angles it is not necessary for all of the distance vector(s) to be a strong match.

Additional factors may also be taken into account when determining the probability of a match such as object position on the global match and the object type as determined by the panoptic segmentation model. This is especially important when a small support set is used.

Taking these factors into account, the probability of a match 3230 may indicate no match 3232 between query object 3202 and known object 3204. On the other hand, the probability of a match 3246 may indicate a match 3234 between query object 3202 and known object 3206. Query object 3202 may thus be re-identified with high confidence as known object 3206 in one embodiment.

Once an object has been re-identified with high confidence, embeddings from the query set (query object fingerprint 3208) may be used to update the support set (known object fingerprint 3236). This may improve the reliability of re-identifying an object again in the future. However, the support set may not grow indefinitely and may have a maximum number of samples.

In one embodiment, a prototypical network may be chosen, where different embeddings for each object in the support set are combined into an “average embedding” or “representative embedding” which may then be compared with the query set to generate a distance vector as an input to help determine the probability of a match. In one embodiment, more than one “representative embedding” for an object may be generated if the object looks visually different from different angles.

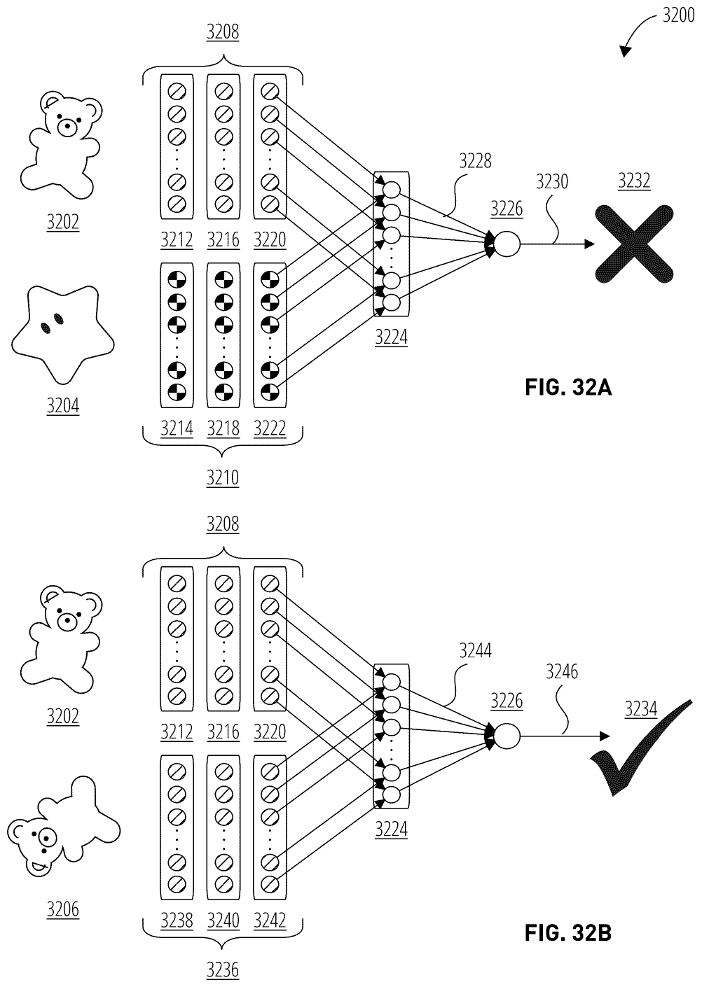

FIG. 33 illustrates a robotic control algorithm 3300 in accordance with one embodiment. At block 3302, a left camera and a right camera, or some other configuration of robot cameras, of a robot such as that disclosed herein, may provide input that may be used to generate scale invariant keypoints within a robot's working space.

“Scale invariant keypoint” or “visual keypoint” in this disclosure refers to a distinctive visual feature that may be maintained across different perspectives, such as photos taken from different areas. This may be an aspect within an image captured of a robot's working space that may be used to identify a feature of the area or an object within the area when this feature or object is captured in other images taken from different angles, at different scales, or using different resolutions from the original capture.

Scale invariant keypoints may be detected by a robot or an augmented reality robotic interface installed on a mobile device based on images taken by the robot's cameras or the mobile device's cameras. Scale invariant keypoints may help a robot or an augmented reality robotic interface on a mobile device to determine a geometric transform between camera frames displaying matching content. This may aid in confirming or fine-tuning an estimate of the robot's or mobile device's location within the robot's working space.

Scale invariant keypoints may be detected, transformed, and matched for use through algorithms well understood in the art, such as (but not limited to) Scale-Invariant Feature Transform (SIFT), Speeded-Up Robust Features (SURF), Oriented Robust Binary features (ORB), and SuperPoint.

Objects located in the robot's working space may be detected at block 3304 based on the input from the left camera and the right camera, thereby defining starting locations for the objects and classifying the objects into categories. At block 3306, re-identification fingerprints may be generated for the objects, wherein the re-identification fingerprints are used to determine visual similarity of objects detected in the future with the objects. The objects detected in the future may be the same objects, redetected as part of an update or transformation of the global area map, or may be similar objects located similarly at a future time, wherein the re-identification fingerprints may be used to assist in more rapidly classifying the objects.

At block 3308, the robot may be localized within the robot's working space. Input from at least one of the left camera, the right camera, light detecting and ranging (LIDAR) sensors, and inertial measurement unit (IMU) sensors may be used to determine a robot location. The robot's working space may be mapped to create a global area map that includes the scale invariant keypoints, the objects, and the starting locations of the objects. The objects within the robot's working space may be re-identified at block 3310 based on at least one of the starting locations, the categories, and the re-identification fingerprints. Each object may be assigned a persistent unique identifier at block 3312.

At block 3314, the robots may receive a camera frame from an augmented reality robotic interface installed as an application on a mobile device operated by a user, and may update the global area map with the starting locations and scale invariant keypoints using a camera frame to global area map transform based on the camera frame. In the camera frame to global area map transform, the global area map may be searched to find a set of scale invariant keypoints that match the those detected in the mobile camera frame by using a specific geometric transform. This transform may maximize the number of matching keypoints and minimize the number of non-matching keypoints while maintaining geometric consistency.

At block 3316, user indicators may be generated for objects, wherein user indicators may include next target, target order, dangerous, too big, breakable, messy, and blocking travel path. The global area map and object details may be transmitted to the mobile device at block 3318, wherein object details may include at least one of visual snapshots, the categories, the starting locations, the persistent unique identifiers, and the user indicators of the objects. This information may be transmitted using wireless signaling such as BlueTooth or Wifi, as supported by the communications 194 module introduced in FIG. 1C and the network interface 2512 introduced in FIG. 25.

The updated global area map, the objects, the starting locations, the scale invariant keypoints, and the object details, may be displayed on the mobile device using the augmented reality robotic interface. The augmented reality robotic interface may accept user inputs to the augmented reality robotic interface, wherein the user inputs indicate object property overrides including change object type, put away next, don't put away, and modify user indicator, at block 3320. The object property overrides may be transmitted from the mobile device to the robot, and may be used at block 3322 to update the global area map, the user indicators, and the object details. Returning to block 3318, the robot may re-transmit its updated global area map to the mobile device to resynchronize this information.

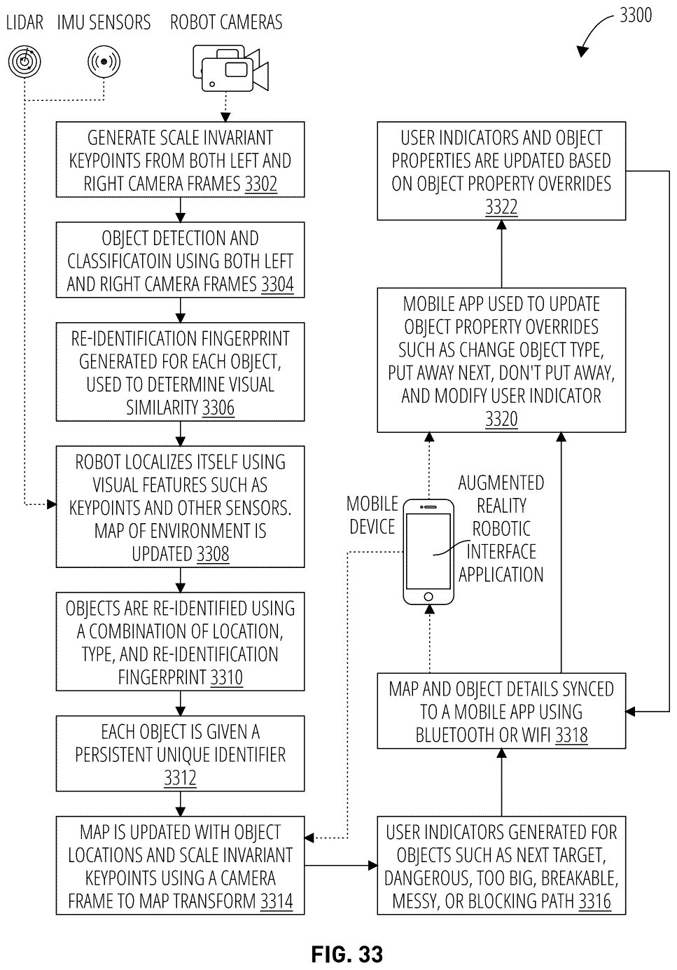

FIG. 34 illustrates an AR user routine 3400 in accordance with one embodiment. The AR user routine 3400 describes a high-level process for how the user may interact with the AR user interface using a mobile device to create operational task rules such as setting home locations for objects. Although the example AR user routine 3400 depicts a particular sequence of operations, the sequence may be altered without departing from the scope of the present disclosure. For example, some of the operations depicted may be performed in parallel or in a different sequence that does not materially affect the function of the AR user routine 3400. In other examples, different components of an example device or system that implements the AR user routine 3400 may perform functions at substantially the same time or in a specific sequence.

According to some examples, the method includes processing live video into a segmented view at block 3402. For example, the robotic control system 2500 illustrated in FIG. 25 may process live video into a segmented view. A live video feed captured by, for example, a mobile device camera, may be processed to generate a segmented view, separating a scene into static objects, movable objects, and tidyable objects.

According to some examples, the method includes using static objects to update the global map and localize the mobile device at block 3404. For example, the robotic control system 2500 illustrated in FIG. 25 may use static objects to update the global map and localize the mobile device. The static part of the scene captured in the live video feed and segmented as static objects may be used to update the global map and localize the mobile device within the environment in a way that is resilient to objects being moved.

According to some examples, the method includes uniquely identifying movable objects at block 3406. For example, the robotic control system 2500 illustrated in FIG. 25 may uniquely identify movable objects. Movable objects may be uniquely identified against a database of known objects. The position of these objects may be updated on the global map. The database of known objects may also be updated as needed based on identification of the movable objects.

According to some examples, the method includes uniquely identifying tidyable objects at block 3408. For example, the robotic control system 2500 illustrated in FIG. 25 may uniquely identify tidyable objects. Tidyable objects may be identified against a database of known objects. The position of these objects may be updated on the global map. The database of known objects may also be updated as needed based on the identification of the tidyable objects.

According to some examples, the method includes displaying the AR user interface to the user at block 3410. For example, the mobile computing device 1504 illustrated in FIG. 15 may display the AR user interface to the user. The AR user interface may guide the user in configuring a map and setting home locations for tidyable objects.

According to some examples, the method includes identification by a user of home locations for tidyable objects using tidyable object home location identification routine 3500. According to some examples, the method includes saving updates to a global known tidyable objects database at block 3412 when the tidyable object home location identification routine 3500 is complete.

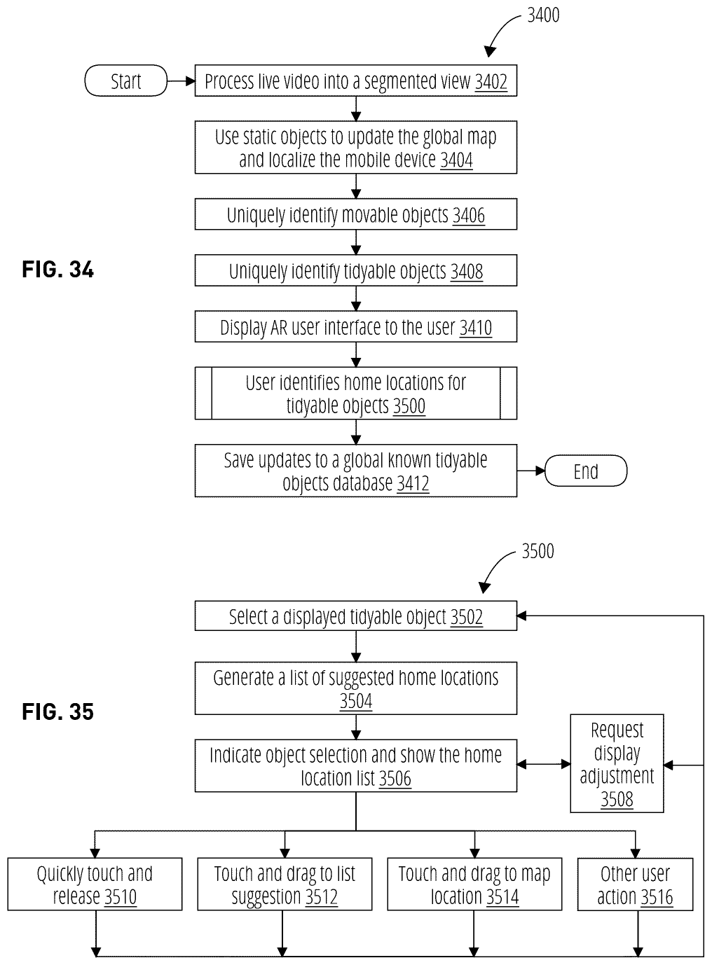

FIG. 35 illustrates a tidyable object home location identification routine 3500 in accordance with one embodiment. Although the example tidyable object home location identification routine 3500 depicts a particular sequence of operations, the sequence may be altered without departing from the scope of the present disclosure. For example, some of the operations depicted may be performed in parallel or in a different sequence that does not materially affect the function of the tidyable object home location identification routine 3500. In other examples, different components of an example device or system that implements the tidyable object home location identification routine 3500 may perform functions at substantially the same time or in a specific sequence.

According to some examples, the method includes selecting a displayed tidyable object at block 3502. For example, the user 1502 illustrated in FIG. 15 may select a displayed tidyable object. Tidyable objects identified at block 3408 of the AR user routine 3400 may be displayed in the AR user interface. The user may interact with the AR user interface to touch, tap, click on, or otherwise indicate the selection of a particular tidyable object in the AR user interface, as is described in additional detail with respect to the AR user interface 3600 illustrated in FIG. 36A-FIG. 36I.

According to some examples, the method includes generating a list of suggested home locations at block 3504. For example, the robotic control system 2500 illustrated in FIG. 25 may generate a list of suggested home locations. A list of suggested home locations for the user-selected tidyable object may be generated. In one embodiment, the list may comprise a set of all home locations previously indicated in a user-configured map. In one embodiment, categories pertaining to the presently selected tidyable object may be used to refine a list of possible home locations to prioritize the display of those home locations previously identified for similarly categorized objects.

According to some examples, the method includes indicating object selection and showing the home location list at block 3506. For example, the mobile computing device 1504 illustrated in FIG. 15 may indicate object selection and show the home location list. The tidyable object indicated by the user may be displayed as selected in the AR user interface using such techniques as colored outlines, halos, bounding boxes, periodic motions or transformations, and other techniques as will be readily understood by one of ordinary skill in the art. The list of home locations previously identified may also be displayed in the AR user interface. In one embodiment, this list may be a text list comprising labels for locations the user has previously configured in the map for the environment to be tidied. In another embodiment, the user or a machine learning process may associate thumbnails captured using the mobile device camera with identified home locations, and the list displayed in the AR user interface may be a set of these thumbnails. Combinations thereof, and other list display formats which are well understood in the art, may also be used.

According to some examples, the method includes requesting display adjustment at block 3508. For example, the user 1502 illustrated in FIG. 15 may request display adjustment. In one embodiment, the user may interact with the AR user interface to adjust which portion of the list of home locations is displayed or to request a different list of home locations be displayed. The user may wish to adjust the view displayed in the AR user interface by zooming or panning to different portions of the environment.

According to some examples, the method includes quickly touching and releasing the selected object at block 3510. For example, the user 1502 illustrated in FIG. 15 may quickly touch and release. In one embodiment, the user may tap the selected object on the mobile device touchscreen display, i.e., may quickly touch and release the object without dragging. In one embodiment, the quick touch and release action may set the selected object's current location as its home location.

According to some examples, the method includes touching and dragging the selected object to a list suggestion at block 3512. For example, the user 1502 illustrated in FIG. 15 may touch and drag the object to a list suggestion. In one embodiment, the user may touch the selected object in the AR user interface, and may, while still touching the object on their mobile device touchscreen display, drag their finger along the display surface toward a displayed element in the home location list. In one embodiment, a visual overlap of the object with a home location list element in the displayed AR user interface may set the listed location as the home location for the selected object. In another embodiment, the home location may not be set until the user releases their finger from their mobile device touchscreen display.

According to some examples, the method includes touching and dragging the selected object to a map location at block 3514. For example, the user 1502 illustrated in FIG. 15 may touch and drag an object to map location. In one embodiment, the user may touch the selected object in the AR user interface, and may, while still touching the object on their mobile device touchscreen display, drag their finger along the display surface toward a map location shown in the AR user interface. In one embodiment, when the user releases their finger from their mobile device touchscreen display, that map location may be set as the selected object's home location.

According to some examples, the method includes other user actions at block 3516. It will be readily apprehended by one of ordinary skill in the art that a number of user interactions with a mobile device touchscreen display may be interpretable as triggers for any number of algorithmic actions supported by the robotic control system. The user may re-tap a selected object to deselect it. A user may be presented with a save and exit control, or a control to exit the AR user interface without saving. Other tabs in an application that includes the AR user interface may provide the user with additional actions. It will also be readily apprehended that a computing device without a touch screen may also support use of the AR user interface, and may thus be used to perform the same operational actions at a user's instigation, though the user actions initiating those actions may differ. The user may click a mouse instead of tapping a screen. The user may use voice commands. The user may use the tab key, arrow keys, and other keys on a keyboard connected to the computing device. This process represents an exemplary user interaction with the AR user interface in support of the disclosed solution.

Once a user interaction for one selected tidyable object is completed, this process may repeat, allowing the selection of a next object and a next, until the user is finished interacting with the AR user interface.

FIG. 36A-FIG. 36I illustrate exemplary user interactions with an AR user interface 3600 providing an augmented reality view in accordance with one embodiment. FIG. 36A and FIG. 36B show exemplary AR user interactions for confirming and modifying non-standard location labels such as may be developed using the non-standard location categorization routine 1700, then setting a home location of a toy bear to be the chair the bear is currently sitting on.

The disclosed system may perform the non-standard location categorization routine 1700 introduced with respect to FIG. 17, and may offer the non-standard location labels generated thereby to a user via an augmented reality view 3602 on a mobile device such as the mobile computing device 1504 of FIG. 15, as shown in FIG. 36A. The user may tap to confirm the non-standard location label 3604 for a storage location such as the bin shown to generate a user input signal. The AR user interface 3600 may accept that user input signal, and may thenceforth use the confirmed label to refer to the displayed storage location.

The user may tap to modify the non-standard location label 3606 for a storage location such as the other bin illustrated in FIG. 36A. As will be readily understood by one of ordinary skill in the art, an additional visual element not illustrated herein may allow the user to tap alternative options or tap to key in a custom name. These user actions may produce user input signals that may be accepted by the AR user interface 3600 and may interpret them as appropriate to accept another label provided by the user.

The user may finally tap to select an object 3608 such as the bear to generate a user input signal. The AR user interface 3600 may accept that user input signal and identify the selected object. With an object selected and identified 3610, the AR user interface 3600 may display a list of suggested home locations 3612, as shown in FIG. 36B. The user may then perform a quick touch and release action 3614 to set the bear's home location to its current location, the AR user interface 3600 accepting this additional user input signal.

FIG. 36C and FIG. 36D illustrate exemplary AR user interactions for setting a home location of a stuffed rabbit to be a bin across the room. The user may tap to select an object 3608 such as the rabbit, then perform a drag to a map location action 3616 to set that map location, i.e., the dragged-to bin, as the rabbit's home location.

FIG. 36E and FIG. 36F illustrate exemplary AR user interactions for setting a home location of a first book to be a coffee table. The user may tap to select an object 3608 such as the first book. The user may then perform a drag to suggested home location action 3618 to identify one of the home locations in the suggested home locations 3612 bar (i.e., the coffee table) as the desired home location for that book.

FIG. 36G and FIG. 36H illustrate exemplary AR user interactions for setting a home location of a second book and other books to be the coffee table. The user may tap to select an object 3608 such as the second book. The user may then select the check box to set selection for multiple objects of the same type 3620. In this way, when the user performs the drag to suggested home location action 3618 (i.e., the coffee table) for the selected book, this also sets the coffee table as the home location for other objects of type “book”.

In FIG. 36I, the AR user interface 3600 guides the user to explore another scene 3622 in order to continue mapping and configuring operational task rules in other areas of the home.

In the augmented reality interface, a bar of suggested home locations 3612 may be displayed for a specific object, for an object type, or for a group of objects. These suggested home locations may be generated in several ways:
Previous location of target object: There may be a global database of known tidyable objects that gets updated both when the robot re-identifies a specific object and when a mobile device re-identifies a specific object. Suggested home locations 3612 may be generated based on where an object has been previously located in the environment.
Home location of similar objects: The home location of objects with similar properties (e.g., type, size, or pattern) may be used to generate recommendations. For example, if the home location of other stuffed animals is set to a bed, the bed may be recommended as a home location for other stuffed animals.
Label matching: Bin labels may include a human- and robot-readable category name, such as “LEGO” or “balls”. These labels may be used to generate recommendations for objects that have a similar type.
Previous location of similar objects: There may be a global database of known tidyable objects that may include previous locations of objects that have similar properties (e.g., type, size or pattern) that may be used to generate recommendations. For example, if a shelf commonly has books on it, the shelf may be recommended as a home location for a target object of type “book”.

FIG. 37 illustrates a robot operation state diagram 3700 in accordance with one embodiment. A tidying robot may begin in a sleep 3702 state. In this sleep 3702 state, the robot may be sleeping and charging at the base station 200.

When the robot wakes up 3704, it may transition to an initialize 3706 state. During the initialize 3706 state, the robot may perform a number of system checks and functions preparatory to its operation, including loading existing maps.

Once the robot is ready 3708, it may transition to an explore for updates 3710 state. During the explore for updates 3710 state, the robot may update its global map and the robot may be localized within that map by processing video frames captured by the robot's cameras and other sensor data. The robot keeps exploring 3712 until the map is updated and the robot is localized 3714.

Once the map is updated and the robot is localized 3714, the robot may transition to an explore for tasks 3716 state. In its explore for tasks 3716 state, the robot may compare a prioritized task list against map information to find its next task for execution. In another embodiment, the robot may be instructed to navigate a pattern throughout the environment looking for tasks to perform. In one embodiment, the prioritized task list may indicate the robot is to perform a process such as the exemplary multi-stage tidying routine. Where the robot finds objects to sort 3718, it may sort those objects on the floor or upon another surface such as a table or countertop. Where the robot finds specific objects to tidy 3720, it may follow a tidying strategy to tidy them after sorting them as needed. Where the robot finds a cluster of objects to tidy 3722, it may follow a tidying strategy to do so. Where the robot finds objects to be pushed to the side 3724, it may perform such actions. Where the robot finds an area that needs sweeping 3726, it may sweep the area once it is cleared of tidyable objects. Where the robot finds an area that needs vacuuming 3728, it may do so once the area is tidied and swept to remove any heavy dirt and debris that may impede or damage the vacuuming system. In one embodiment, the robot may determine that an area needs to be mopped after it has been swept and/or vacuumed and may subsequently perform a mopping task. Once the robot determines a task is finished 3730, it may mark the task complete 3732, then it continues exploring 3734. The robot may then transition back through the explore for updates 3710 state and the explore for tasks 3716 state.

If the robot selects a new goal location 3736, it may transition from the explore for tasks 3716 state to the new goal location selected 3738 state, allowing it to view and map previously unobserved scenes in the environment. The robot navigates to the new location 3740 and returns to the explore for updates 3710 state.

While the robot is in the explore for tasks 3716 state, if it determines its battery is low or there is nothing to tidy 3742, it may transition to the return to dock 3744 state. In this state, the robot may select a point near its base station 200 as its goal location, may navigate to that point, and may then dock with the base station 200 to charge. When the robot is docked and charging 3746, it may return to the sleep 3702 state.

FIG. 38 illustrates an example routine 3800 for a tidying robot such as that introduced with respect to FIG. 1A. Although the example routine 3800 depicts a particular sequence of operations, the sequence may be altered without departing from the scope of the present disclosure. For example, some of the operations depicted may be performed in parallel or in a different sequence that does not materially affect the function of the routine 3800. In other examples, different components of an example device or system that implements the routine 3800 may perform functions at substantially the same time or in a specific sequence.

According to some examples, the method includes receiving a starting location, a target cleaning area, attributes of the target cleaning area, and obstructions in a path of the robot navigating in the target cleaning area at block 3802. For example, the tidying robot 100 illustrated in FIG. 1A may receive a starting location, a target cleaning area, attributes of the target cleaning area, and obstructions in a path of the robot navigating in the target cleaning area.

According to some examples, the method includes determining a tidying strategy including a vacuuming strategy and an obstruction handling strategy at block 3804. The vacuuming strategy may include choosing a vacuum cleaning pattern for the target cleaning area, identifying the obstructions in the target cleaning area, determining how to handle the obstructions, and vacuuming the target cleaning area. Handling the obstructions may include moving the obstructions and avoiding the obstructions. Moving the obstructions may include pushing them aside, executing a pickup strategy to pick them up in the scoop, carrying them to another location out of the way, etc. The obstruction may, for example, be moved to a portion of the target cleaning area that has been vacuumed, in close proximity to the path, to allow the robot to quickly return and continue, unobstructed, along the path. In one embodiment, the robot may execute an immediate removal strategy, in which it may pick an obstruction up in its scoop, then immediately navigate to a garget storage bine and place the obstruction into the bin. The robot may then navigate back to the position where it picked up the obstruction, and may resume vacuuming from there. In one embodiment, the robot may execute an in-situ removal strategy, where it picks the object up, then continues to vacuum. When the robot is near the target storage bin, it may place the obstruction in the bin, then continue vacuuming from there. It may adjust its pattern to vacuum any portions of the floor it missed due to handling the obstruction. Once vacuuming is complete, or if the robot determines it does not have adequate battery power, the robot may return to the base station to complete the vacuuming strategy.

According to some examples, the method includes executing the tidying strategy to at least one of vacuum the target cleaning area, move an obstruction, and avoid the obstruction at block 3806. The obstruction may include at least one of a tidyable object and a moveable object.

If the robot determines that the obstruction is pickable at decision block 3808, that is, the obstruction is an object the robot is capable of picking up, the method may progress to block 3816. If the robot decides the obstruction is not pickable, it may then determine whether the obstruction is relocatable at decision block 3810, that is, the obstruction is an object the robot is capable of moving and relocating, even though it cannot pick it up. If the robot determines the obstruction is relocatable, the method may include pushing the obstruction to a different location at block 3812. The obstruction may be pushed with the pusher pads, the scoop, and/or the chassis. If the robot determines the object is not relocatable, according to some examples, the method includes altering the path of the robot to go around and avoid the obstruction at block 3814.

According to some examples, the method includes determining and executing a pickup strategy at block 3816. The pickup strategy may include an approach path for the robot to take to reach the obstruction, a grabbing height for initial contact with the obstruction, a grabbing pattern for moving the pusher pads while capturing the obstruction, and a carrying position of the pusher pads and the scoop that secures the obstruction in a containment area on the robot for transport. The containment area may include at least two of the pusher pad arms, the pusher pads, and the scoop. Executing the pickup strategy may include extending the pusher pads out and forward with respect to the pusher pad arms and raising the pusher pads to the grabbing height. The robot may then approach the obstruction via the approach path, coming to a stop when the obstruction is positioned between the pusher pads. The robot may execute the grabbing pattern to allow capture of the obstruction within the containment area. The robot may confirm the obstruction is within the containment area. If the obstruction is within the containment area, the robot may exert pressure on the obstruction with the pusher pads to hold the obstruction stationary in the containment area and raise at least one of the scoop and the pusher pads, holding the obstruction, to the carrying position.

If the obstruction is not within the containment area, the robot may alter the pickup strategy with at least one of a different reinforcement learning based strategy, a different rules based strategy, and relying upon different observations, current object state, and sensor data, and may then execute the altered pickup strategy. According to some examples, the method includes capturing the obstruction with the pusher pads at block 3818. According to some examples, the method then includes placing the obstruction in the scoop at block 3820. In one embodiment, the robot may navigate to a target storage bin or an object collection bin, then execute a drop strategy to place the obstruction in the bin. In one embodiment, the robot may turn aside from its vacuuming path to an already vacuumed area, then execute a drop strategy to place the obstruction on the floor. In one embodiment, the object collection bin may be on top of the base station.

According to some examples, the robot may determine whether or not the dirt collector is full at decision block 3822. If the dirt collector is full, the robot may navigate to the base station at block 3824. Otherwise, the robot may return to block 3806 and continue executing the tidying strategy.

FIG. 39 illustrates an example basic routine 3900 for a system such as the tidying robot 100 and base station 200 disclosed herein and illustrated interacting in FIG. 8. Although the example basic routine 3900 depicts a particular sequence of operations, the sequence may be altered without departing from the scope of the present disclosure. For example, some of the operations depicted may be performed in parallel or in a different sequence that does not materially affect the function of the basic routine 3900. In other examples, different components of an example device or system that implements the basic routine 3900 may perform functions at substantially the same time or in a specific sequence.

The basic routine 3900 may begin with the tidying robot 100 previously illustrated in a sleeping and charging state at the base station 200 previously illustrated. The robot may wake up from the sleeping and charging state at block 3902. The robot may scan the environment at block 3904 to update its local or global map and localize itself with respect to its surroundings and its map. In one embodiment, the tidying robot 100 may utilize its sensing system, including cameras and/or LIDAR sensors to localize itself in its environment. If this localization fails, the tidying robot 100 may execute an exploration cleaning pattern, such as a random walk in order to update its map and localize itself as it cleans.

At block 3906, the robot may determine a tidying strategy including at least one of a vacuuming strategy and an object isolation strategy. The tidying strategy may include choosing a vacuum cleaning pattern. For example, the robot may choose to execute a simple pattern of back and forth lines to clear a room where there are no obstacles detected. In one embodiment, the robot may choose among multiple planned cleaning patterns.

“Vacuum cleaning pattern” refers to a pre-determined path to be traveled by the tidying robot with its robot vacuum system engaged for the purposes of vacuuming all or a portion of a floor. The vacuum cleaning pattern may be configured to optimize efficiency by, e.g., minimizing the number of passes performed or the number of turns made. The vacuum cleaning pattern may account for the locations of known static objects and known movable objects which the tidying robot may plan to navigate around, and known tidyable objects which the tidying robot may plan to move out of its path. The vacuum cleaning pattern may be interrupted by tidyable objects or movable objects not anticipated at the time the pattern was selected, such that the tidying robot may be configured to engage additional strategies flexibly to complete a vacuum cleaning pattern under unanticipated circumstances it may encounter.

The robot may start vacuuming, and may at block 3908 vacuum the floor following the planned cleaning pattern. As cleaning progresses, maps may be updated at block 3910 to mark cleaned areas, keeping track of which areas have been cleaned. As long as the robot's path according to its planned cleaning pattern is unobstructed, the cleaning pattern is incomplete, and the robot has adequate battery power, the robot may return to block 3908 and continue cleaning according to its pattern.

Where the robot determines its path is obstructed at decision block 3912, the robot may next determine at decision block 3914 if the object obstructing its path may be picked up. If the object cannot be picked up, the robot may drive around the object at block 3916 and return to block 3908 to continue vacuuming/cleaning. If the object may be picked up, the robot may pick up the object and determine a goal location for that object at block 3918. Once the goal location is chosen, the robot may at block 3920 drive to the goal location with the object and may deposit the object at the goal location. The robot may then return to block 3908 and continue vacuuming.

In one embodiment, if the robot encounters an obstruction in its path at decision block 3912, it may determine the type of obstruction, and based on the obstruction type, the robot may determine an action plan for handling the obstruction. The action plan may be an action plan to move object(s) aside 4000 or an action plan to pick up objects in path 4100, as will be described in additional detail below. The action plan to pick up objects in path 4100 may may lead to the determination of additional action plans, such as the action plan to drop object(s) at a drop location 4200. The robot may execute the action plan(s). If the action plan fails, the robot may execute an action plan to drive around object(s) 4300 and may return to block 3908 and continue vacuuming. If the action plan to handle the obstruction succeeds, the robot may return to its vacuuming task at block 3908 following its chosen cleaning pattern.

The robot may in one embodiment return to the point at which vacuuming was interrupted to address the obstructing object to continue vacuuming. In another embodiment, the robot may restart vacuuming at the goal location, following a new path that allows it to complete its vacuuming task from that point. In one embodiment, the robot may continue to carry the object while vacuuming, waiting to deposit the object until after vacuuming is complete, or until the robot has reached a location near the goal location.

Once vacuuming is complete, or if a low battery condition is detected before vacuuming is complete at decision block 3922, the robot may at block 3924 navigate back to its base station. Upon arriving at the base station, the robot may dock with the base station at block 3926. In one embodiment, the base station may be equipped to auto-empty dirt from the robot's dirt collector at block 3928, if any dust, dirt, or debris is detected in the dirt collector. In one embodiment, the base station may comprise a bin, such as the base station 200 and object collection bin 202 illustrated in FIG. 2A and FIG. 2B. The robot may deposit any objects it is carrying in this bin. The robot may return to block 3902, entering a sleeping and/or charging mode while docked at the base station.

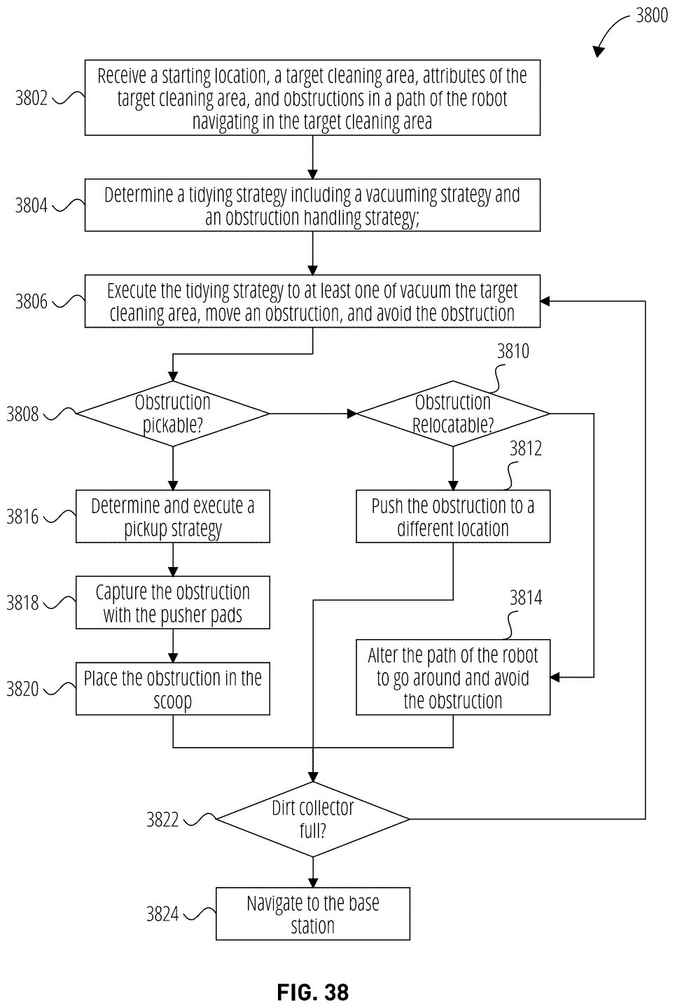

FIG. 40 illustrates an action plan to move object(s) aside 4000 in accordance with one embodiment. The tidying robot 100 may execute the action plan to move object(s) aside 4000 supported by the observations, current robot state, current object state, and sensor data 2622 introduced earlier with respect to FIG. 26.

The action plan to move object(s) aside 4000 may begin with recording an initial position for the tidying robot 100 at block 4002. The tidying robot 100 may then determine a destination for the object(s) to be moved using its map at block 4004. The tidying robot 100 may use its map, which may include noting which areas have already been vacuumed and determining a target location for the object(s) that has already been vacuumed, is in close proximity, and/or will not obstruct the continued vacuuming pattern.

The robot may at block 4006 choose a strategy to move the object(s). The robot may determine if it is able to move the object(s) via the strategy at decision block 4008. If it appears the object(s) are not moveable via the strategy selected, the tidying robot 100 may return to its initial potion at block 4012. Alternatively, the tidying robot 100 may return to block 4006 and select a different strategy.

If the object(s) appear to be able to be moved, the robot may execute the strategy for moving the object(s) at block 4010. Executing the strategy may include picking up object(s) and dropping them at a determined destination location. Alternatively, the obstructing object(s) may be aligned with the outside of a robot's arm, and the robot may then use a sweeping motion to push the object(s) to the side, out of its vacuuming path. For example, the robot may pivot away from cleaned areas to navigate to a point where the robot may be pushed into the cleaned area by the robot pivoting back toward those cleaned areas.

If it is determined during execution of the strategy at block 4010 the object(s) cannot be moved, or if the strategy fails, the robot may navigate back to a starting position at block 4012. Alternatively, the robot may navigate to a different position that allows for continuation of the vacuuming pattern, skipping the area of obstruction. The action plan to move object(s) aside 4000 may then be exited.

In one embodiment, the robot may store the obstruction location on its map. The robot may issue an alert to notify a user of the instruction. The user may be able to clear the obstruction physically from the path, and then clear it from the robot's map through a user interface, either on the robot or through a mobile application in communication with the robot. The robot may in one embodiment be configured to revisit areas of obstruction once the rest of its cleaning pattern has been completed.

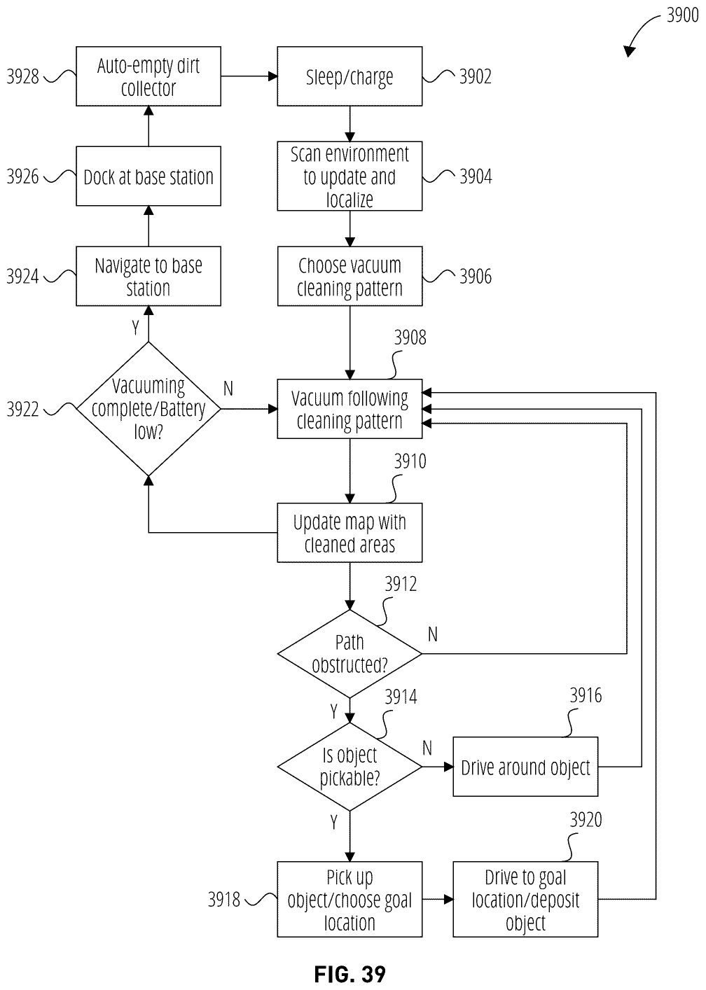

FIG. 41 illustrates an action plan to pick up objects in path 4100 in accordance with one embodiment. The tidying robot 100 may execute the action plan to pick up objects in path 4100 supported by the observations, current robot state, current object state, and sensor data 2622 introduced earlier with respect to FIG. 26.

The action plan to pick up objects in path 4100 may begin with recording an initial position for the tidying robot 100 at block 4102. The tidying robot 100 may make a determination at decision block 4104 whether its scoop is full or has capacity to pick up additional objects. If the scoop is full, the tidying robot 100 may, before proceeding, empty its scoop by depositing the objects therein at a desired drop location by following action plan to drop object(s) at a drop location 4200. The drop location may be a bin, a designated place on the floor that will be vacuumed before objects are deposited, or a designated place on the floor that has already been vacuumed.

Once it is determined that the scoop has capacity to pick up the objects, the tidying robot 100 may at block 4106 choose a strategy to pick up the obstructing objects it has detected. The tidying robot 100 may determine if it is able to pick the objects up via the selected strategy at decision block 4108. If it appears the object(s) are not pickable via the strategy selected, the tidying robot 100 may return to its initial potion at block 4114. Alternatively, the tidying robot 100 may return to block 4106 and select a different strategy.

If it is determined during execution of the strategy at block 4110 the object(s) cannot be picked up, or if the strategy fails, the robot may navigate back to a starting position at block 4114. Alternatively, the robot may navigate to a different position that allows for continuation of the vacuuming pattern, skipping the area of obstruction. The action plan to pick up objects in path 4100 may then be exited.

Once the objects are picked up through execution of the pickup strategy at block 4110, the tidying robot 100 may in one embodiment re-check scoop capacity at decision block 4112. If the scoop is full, the tidying robot 100 may perform the action plan to drop object(s) at a drop location 4200 to empty the scoop.

In one embodiment, the tidying robot 100 may immediately perform the action plan to drop object(s) at a drop location 4200 regardless of remaining scoop capacity in order to immediately drop the objects in a bin. In one embodiment, the tidying robot 100 may include features that allow it to haul a bin behind it, or carry a bin with it. In such an embodiment, the robot may perform an immediate rear dump into the bin behind it, or may set down the bin it is carrying before executing the pickup strategy, then immediately deposit the objects in the bin and retrieve the bin.

In one embodiment, if the scoop is not full and still has capacity, the tidying robot 100 may return to the initial position at block 4114 and continue cleaning while carrying the objects in its scoop, exiting the action plan to pick up objects in path 4100. Alternately, the robot may navigate to a different position that allows for continuation of the vacuuming pattern and may exit the action plan to pick up objects in path 4100.

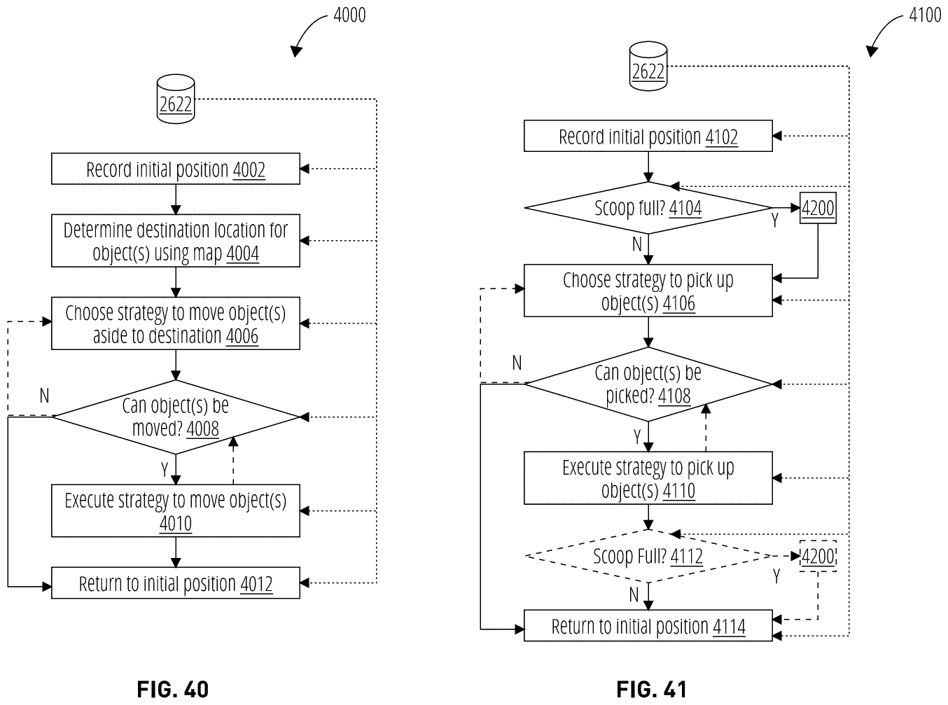

FIG. 42 illustrates an action plan to drop object(s) at a drop location 4200 in accordance with one embodiment. The tidying robot 100 may execute the action plan to drop object(s) at a drop location 4200 supported by the observations, current robot state, current object state, and sensor data 2622 introduced earlier with respect to FIG. 26.

The action plan to drop object(s) at a drop location 4200 may begin at block 4202 with the tidying robot 100 recording an initial position. The tidying robot 100 may then navigate to the drop location at block 4204. The drop location may be a bin or a designated place on the floor that will be vacuumed before dropping, or may have already been vacuumed.

At block 4206, the tidying robot 100 may choose a strategy for dropping the objects. The drop strategy may include performing a rear dump or a front dump, and may involve coordinated patterns of movement by the pusher pad arms to successfully empty the scoop, based on the types of objects to be deposited.

The tidying robot 100 may then execute the strategy to drop the objects at block 4208. In one embodiment, similar to other action plans disclosed herein, a failure in the drop strategy may be detected, wherein the tidying robot 100 may select a different strategy, return to other actions, or alert a user that an object is stuck in the scoop. Finally, at block 4210, the tidying robot 100 may return to the initial position, exiting the action plan to drop object(s) at a drop location 4200 and continuing to vacuum or perform other tasks.

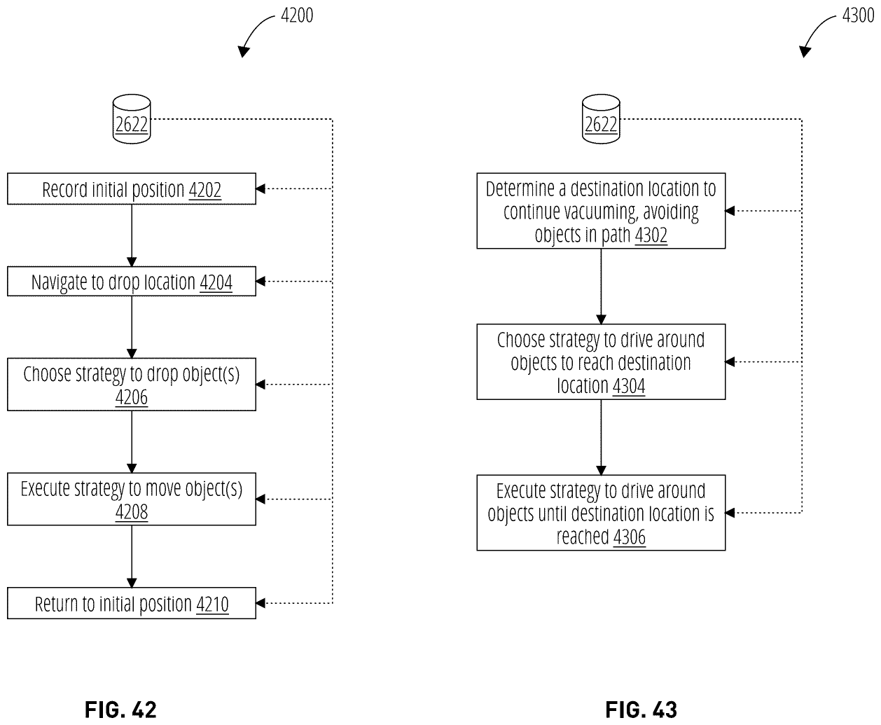

FIG. 43 illustrates an action plan to drive around object(s) 4300 in accordance with one embodiment. The tidying robot 100 may execute the action plan to drive around object(s) 4300 supported by the observations, current robot state, current object state, and sensor data 2622 introduced earlier with respect to FIG. 26.

The action plan to drive around object(s) 4300 may begin at block 4302 with the tidying robot 100 determining a destination location to continue vacuuming after navigating around and avoiding the objects currently obstructing the vacuuming path. In one embodiment, the tidying robot 100 may use a map including the location of the objects and which areas have already been vacuumed to determine the desired target location beyond obstructing objects where it may best continue its vacuuming pattern.

At block 4304, the tidying robot 100 may choose a strategy to drive around the objects to reach the selected destination location. The tidying robot 100 may then execute the strategy at block 4306. In one embodiment, the robot may plot waypoint(s) to a destination location on a local map using an algorithm to navigate around objects. The robot may then navigate to the destination location following those waypoints.

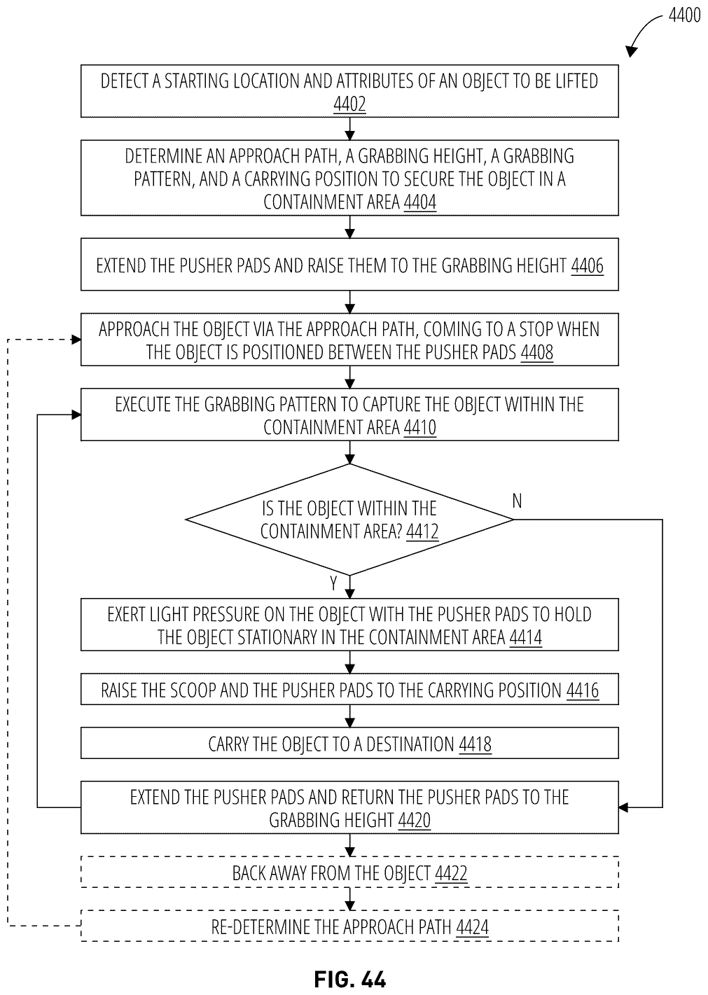

The disclosed algorithm may comprise a capture process 4400 as illustrated in FIG. 44. The capture process 4400 may be performed by a tidying robot 100 such as that introduced with respect to FIG. 1A. This robot may have the sensing system, control system, mobility system, pusher pads, pusher pad arms, and scoop illustrated in FIG. 1A through FIG. 1D, or similar systems and features performing equivalent functions as is well understood in the art.

The capture process 4400 may begin in block 4402 where the robot detects a starting location and attributes of an object to be lifted. Starting location may be determined relative to a learned map of landmarks within a room the robot is programmed to declutter. Such a map may be stored in memory within the electrical systems of the robot. These systems are described in greater detail with regard to FIG. 25. Object attributes may be detected based on input from a sensing system, which may comprise cameras, LIDAR, or other sensors. In some embodiments, data detected by such sensors may be compared to a database of common objects to determine attributes such as deformability and dimensions. In some embodiments, the robot may use known landmark attributes to calculate object attributes such as dimensions. In some embodiments, machine learning may be used to improve attributes detection and analysis.

In block 4404, the robot may determine an approach path to the starting location. The approach path may take into account the geometry of the surrounding space, obstacles detected around the object, and how components the robot may be configured as the robot approaches the object. The robot may further determine a grabbing height for initial contact with the object. This grabbing height may take into account an estimated center of gravity for the object in order for the pusher pads to move the object with the lowest chance of slipping off of, under, or around the object, or deflecting the object in some direction other than into the scoop. The robot may determine a grabbing pattern for movement of the pusher pads during object capture, such that objects may be contacted from a direction and with a force applied in intervals optimized to direct and impel the object into the scoop. Finally, the robot may determine a carrying position of the pusher pads and a scoop that secures the object in a containment area for transport after the object is captured. This position may take into account attributes such as the dimensions of the object, its weight, and its center of gravity.

In block 4406, the robot may extend its pusher pads out and forward with respect to the pusher pad arms and raise the pusher pads to the grabbing height. This may allow the robot to approach the object as nearly as possible without having to leave room for this extension after the approach. Alternately, the robot may perform some portion of the approach with arms folded in close to the chassis and scoop to prevent impacting obstacles along the approach path. In some embodiments, the robot may first navigate the approach path and deploy arms and scoop to clear objects out of and away from the approach path. In block 4408, the robot may finally approach the object via the approach path, coming to a stop when the object is positioned between the pusher pads.

In block 4410, the robot may execute the grabbing pattern determined in block 4402 to capture the object within the containment area. The containment area may be an area roughly described by the dimensions of the scoop and the disposition of the pusher pad arms with respect to the scoop. It may be understood to be an area in which the objects to be transported may reside during transit with minimal chances of shifting or being dislodged or dropped from the scoop and pusher pad arms. In decision block 4412, the robot may confirm that the object is within the containment area. If the object is within the containment area, the robot may proceed to block 4414.

In block 4414, the robot may exert a light pressure on the object with the pusher pads to hold the object stationary in the containment area. This pressure may be downward in some embodiments to hold an object extending above the top of the scoop down against the sides and surface of the scoop. In other embodiments this pressure may be horizontally exerted to hold an object within the scoop against the back of the scoop. In some embodiments, pressure may be against the bottom of the scoop in order to prevent a gap from forming that may allow objects to slide out of the front of the scoop.

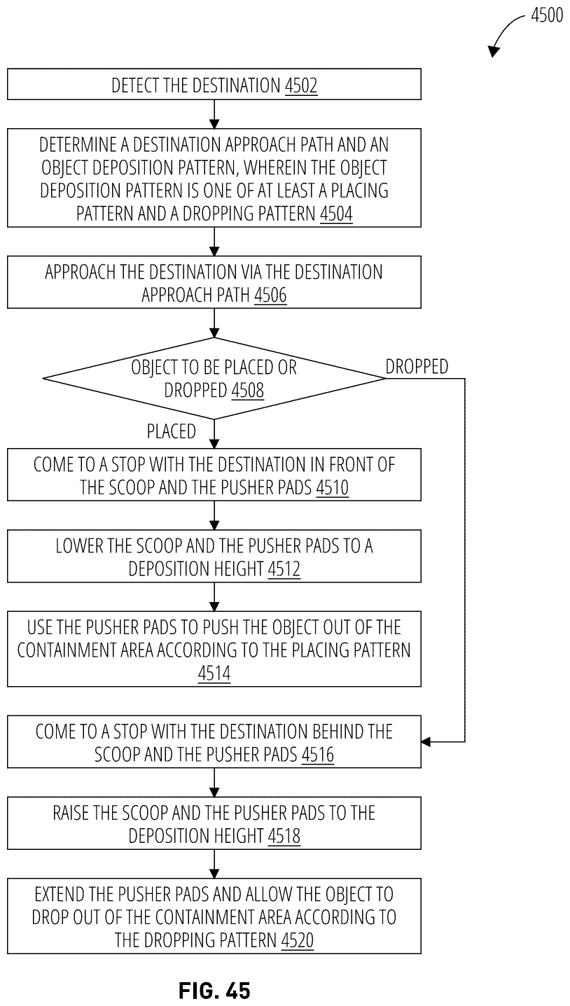

In block 4416, the robot may raise the scoop and the pusher pads to the carrying position determined in block 4402. The robot may then at block 4418 carry the object to a destination. The robot may follow a transitional path between the starting location and a destination where the object will be deposited. To deposit the object at the destination, the robot may follow the deposition process 4500 illustrated in FIG. 45.

If at decision block 4412 the object is not detected within the containment area, or is determined to be partially or precariously situated within the containment area, the robot may at block 4420 extend the pusher pads fall out of the scoop and forward with respect to the pusher pad arms and returns the pusher pads to the grabbing height. The robot may then return to block 4410. In some embodiments, the robot may at block 4422 back away from the object if simply releasing and reattempting to capture the object is not feasible. This may occur if the object has been repositioned or moved by the initial attempt to capture it. In block 4424, the robot may re-determine the approach path to the object. The robot may then return to block 4408.

FIG. 45 illustrates a deposition process 4500 in accordance with one embodiment. The deposition process 4500 may be performed by a tidying robot 100 such as that introduced with respect to FIG. 1A as part of the algorithm disclosed herein. This robot may have the sensing system, control system, mobility system, pusher pads, pusher pad arms, and scoop illustrated in FIG. 1A through FIG. 1D or similar systems and features performing equivalent functions as is well understood in the art.

In block 4502, the robot may detect the destination where an object carried by the robot is intended to be deposited. In block 4504, the robot may determine a destination approach path to the destination. This path may be determined so as to avoid obstacles in the vicinity of the destination. In some embodiments, the robot may perform additional navigation steps to push objects out of and away from the destination approach path. The robot may also determine an object deposition pattern, wherein the object deposition pattern is one of at least a placing pattern and a dropping pattern. Some neatly stackable objects such as books, other media, narrow boxes, etc., may be most neatly decluttered by stacking them carefully. Other objects may not be neatly stackable, but may be easy to deposit by dropping into a bin. Based on object attributes, the robot may determine which object deposition pattern is most appropriate to the object.

In block 4506, the robot may approach the destination via the destination approach path. How the robot navigates the destination approach path may be determined based on the object deposition pattern. If the object being carried is to be dropped over the back of the robot's chassis, the robot may traverse the destination approach path in reverse, coming to a stop with the back of the chassis nearest the destination. Alternatively, for objects to be stacked or placed in front of the scoop, i.e., at the area of the scoop that is opposite the chassis, the robot may travel forward along the destination approach path so as to bring the scoop nearest the destination.

At decision block 4508, the robot may proceed in one of at least two ways, depending on whether the object is to be placed or dropped. If the object deposition pattern is intended to be a placing pattern, the robot may proceed to block 4510. If the object deposition pattern is intended to be a dropping pattern, the robot may proceed to block 4516.

For objects to be placed via the placing pattern, the robot may come to a stop with the destination in front of the scoop and the pusher pads at block 4510. In block 4512, the robot may lower the scoop and the pusher pads to a deposition height. For example, if depositing a book on an existing stack of books, the deposition height may be slightly above the top of the highest book in the stack, such that the book may be placed without disrupting the stack or dropping the book from a height such that it might have enough momentum to slide off the stack or destabilize the stack. Finally, at block 4514, the robot may use its pusher pads to push the object out of the containment area and onto the destination. In one embodiment, the scoop may be tilted forward to drop objects, with or without the assistance of the pusher pads pushing the objects out from the scoop.

If in decision block 4508 the robot determines that it will proceed with an object deposition pattern that is a dropping pattern, the robot may continue to block 4516. At block 4516, the robot may come to a stop with the destination behind the scoop and the pusher pads, and by virtue of this, behind the chassis for a robot such as the one introduced in FIG. 1A. In block 4518, the robot may raise the scoop and the pusher pads to the deposition height. In one embodiment the object may be so positioned that raising the scoop and pusher pad arms from the carrying position to the deposition height results in the object dropping out of the containment area into the destination area. Otherwise, in block 4520, the robot may extend the pusher pads and allow the object to drop out of the containment area, such that the object comes to rest at or in the destination area. In one embodiment, the scoop may be tilted forward to drop objects, with or without the assistance of the pusher pads pushing the objects out from the scoop.

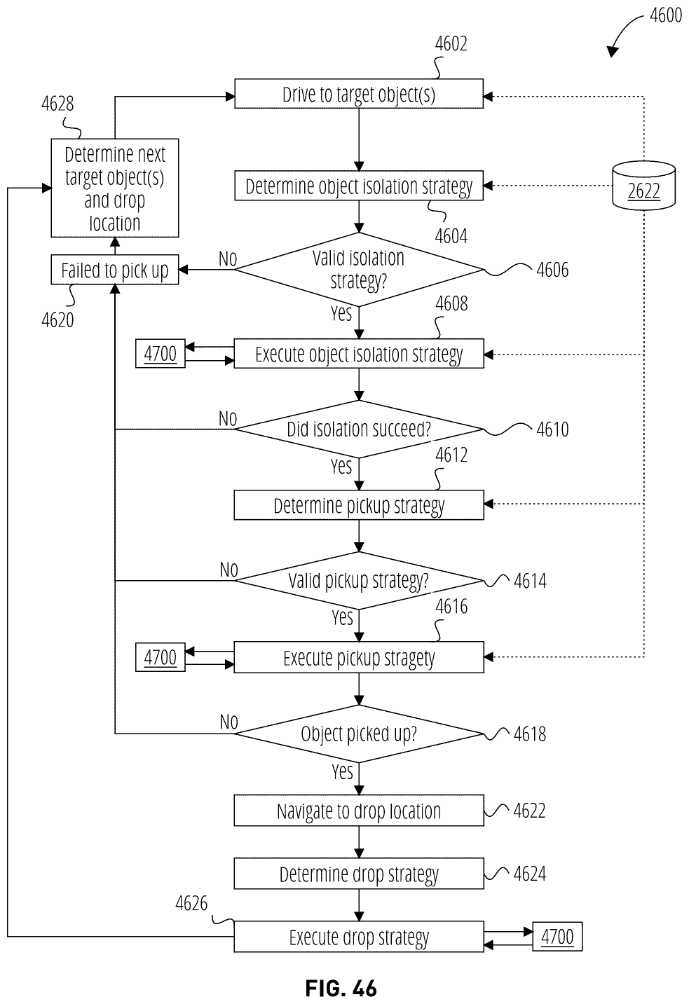

FIG. 46 illustrates a main navigation, collection, and deposition process 4600 in accordance with one embodiment. According to some examples, the method includes driving to target object(s) at block 4602. For example, the tidying robot 100 such as that introduced with respect to FIG. 1A may drive to target object(s) using a local map or global map to navigate to a position near the target object(s), relying upon observations, current robot state, current object state, and sensor data 2622 determined as illustrated in FIG. 26.

According to some examples, the method includes determining an object isolation strategy at block 4604. For example, the robotic control system 2500 illustrated in FIG. 25 may determine an object isolation strategy in order to separate the target object(s) from other objects in the environment based on the position of the object(s) in the environment. The object isolation strategy may be determined using a machine learning model or a rules based approach, relying upon observations, current robot state, current object state, and sensor data 2622 determined as illustrated in FIG. 26. In some cases, object isolation may not be needed, and related blocks may be skipped. For example, in an area containing few items to be picked up and moved, or where such items are not in a proximity to each other, furniture, walls, or other obstacles, that would lead to interference in picking up target objects, object isolation may not be needed.

In some cases, a valid isolation strategy may not exist. For example, the robotic control system 2500 illustrated in FIG. 25 may be unable to determine a valid isolation strategy. If it is determined at decision block 4606 that there is no valid isolation strategy, the target object(s) may be marked as failed to pick up at block 4620. The main navigation, collection, and deposition process 4600 may then advance to block 4628, where the next target object(s) are determined.

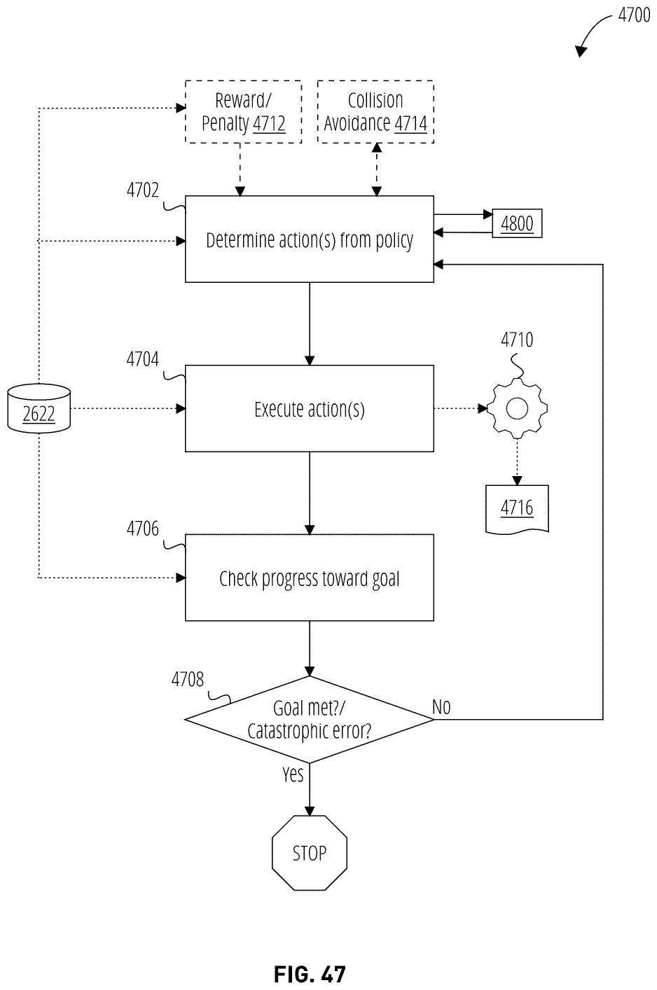

If there is a valid isolation strategy determined at decision block 4606, the tidying robot 100 may execute the object isolation strategy to separate the target object(s) from other objects at block 4608. The isolation strategy may follow strategy steps for isolation strategy, pickup strategy, and drop strategy 4700 illustrated in FIG. 47. The isolation strategy may be a reinforcement learning based strategy using rewards and penalties in addition to observations, current robot state, current object state, and sensor data 2622, or a rules based strategy relying upon observations, current robot state, current object state, and sensor data 2622 determined as illustrated in FIG. 26. Reinforcement learning based strategies relying on rewards and penalties are described in greater detail with reference to FIG. 47.

Rules based strategies may use conditional logic to determine the next logic based on observations, current robot state, current object state, and sensor data 2622 such as are developed in FIG. 26. Each rules based strategy may have a list of available actions it may consider. In one embodiment, a movement collision avoidance system may be used to determine the range of motion involved with each action. Rules based strategies for object isolation may include:
Navigating robot to a position facing the target object(s) to be isolated, but far enough away to open pusher pad arms and pusher pads and lower the scoop.
Opening the pusher pad arms and pusher pads, lowering the pusher pad arms and pusher pads, and lowering the scoop
Turning robot slightly in-place so that target object(s) are centered in a front view
Opening pusher pad arms and pusher pads to be slightly wider than target object(s)
Driving forward slowly until the end of the pusher pad arms and pusher pads is positioned past the target object(s)
Slightly closing the pusher pad arms and pusher pads into a V-shape so that the pusher pad arms and pusher pads surround the target object(s)
Driving backwards 100 centimeters, moving the target object(s) into an open space

According to some examples, the method includes determining whether or not the isolation succeeded at decision block 4610. For example, the robotic control system 2500 illustrated in FIG. 25 may determine whether or not the target object(s) were successfully isolated. If the isolation strategy does not succeed, the target object(s) may be marked as failed to pickup at block 4620. The main navigation, collection, and deposition process 4600 advances to block 4628, where a next target object is determined. In some embodiments, rather than determining a next target object, a different strategy may be selected for the same target object. For example, if target object(s) are not able to be isolated by the current isolation strategy, a different isolation strategy may be selected and isolation retried.

If the target object(s) were successfully isolated, the method then includes determining a pickup strategy at block 4612. For example, the robotic control system 2500 illustrated in FIG. 25 may determine the pickup strategy. The pickup strategy for the particular target object(s) and location may be determined using a machine learning model or a rules based approach, relying upon observations, current robot state, current object state, and sensor data 2622 determined as illustrated in FIG. 26.

In some cases, a valid pickup strategy may not exist. For example, the robotic control system 2500 illustrated in FIG. 25 may be unable to determine a valid pickup strategy. If it is determined at decision block 4614 that there is no valid pickup strategy, the target object(s) may be marked as failed to pick up at block 4620, as previously noted. The pickup strategy may need to take into account:
An initial default position for the pusher pad arms and the scoop before starting pickup.
A floor type detection for hard surfaces versus carpet, which may affect pickup strategies
A final scoop and pusher pad arm position for carrying

If there is a valid pickup strategy determined at decision block 4614, the tidying robot 100 such as that introduced with respect to FIG. 1A may execute a pickup strategy at block 4616. The pickup strategy may follow strategy steps for isolation strategy, pickup strategy, and drop strategy 4700 illustrated in FIG. 47. The pickup strategy may be a reinforcement learning based strategy or a rules based strategy, relying upon observations, current robot state, current object state, and sensor data 2622 determined as illustrated in FIG. 26. Rules based strategies for object pickup may include:
Navigating the robot to a position facing the target object(s), but far enough away to open the pusher pad arms and pusher pads and lower the scoop
Opening the pusher pad arms and pusher pads, lowering the pusher pad arms and pusher pads, and lowering the scoop
Turning the robot slightly in-place so that the target object(s) are centered in the front view
Driving forward until the target object(s) are in a “pickup zone” against the edge of the scoop
Determining a center location of target object(s) against the scoop-on the right, left or center
   If on the right, closing the right pusher pad arm and pusher pad first with the left pusher pad arm and pusher pad closing behind
   Otherwise, closing the left pusher pad arm and pusher pad first with the right pusher pad arm and pusher pad closing behind
Determining if target object(s) were successfully pushed into the scoop
   If yes, then pickup was successful
   If no, lift pusher pad arms and pusher pads and then try again at an appropriate part of the strategy.

According to some examples, the method includes determining whether or not the target object(s) were picked up at decision block 4618. For example, the robotic control system 2500 illustrated in FIG. 25 may determine whether or not the target object(s) were picked up. Pickup success may be evaluated using:
Object detection within the area of the scoop and pusher pad arms (i.e., the containment area as previously illustrated) to determine if the object is within the scoop/pusher pad arms/containment area
Force feedback from actuator force feedback sensors indicating that the object is retained by the pusher pad arms
Tracking motion of object(s) during pickup into area of scoop and retaining the state of those object(s) in memory (memory is often relied upon as objects may no longer be visible when the scoop is in its carrying position).
Detecting an increased weight of the scoop during lifting indicating the object is in the scoop
Utilizing a classification model for whether an object is in the scoop
Using force feedback, increased weight, and/or a dedicated camera to re-check that an object is in the scoop while the robot is in motion

If the pickup strategy fails, the target object(s) may be marked as failed to pick up at block 4620, as previously described. If the target object(s) were successfully picked up, the method includes navigating to drop location at block 4622. For example, the tidying robot 100 such as that introduced with respect to FIG. 1A may navigate to a predetermined drop location. The drop location may be a container or a designated area of the ground or floor. Navigation may be controlled by a machine learning model or a rules based approach.

According to some examples, the method includes determining a drop strategy at block 4624. For example, the robotic control system 2500 illustrated in FIG. 25 may determine a drop strategy. The drop strategy may need to take into account the carrying position determined for the pickup strategy. The drop strategy may be determined using a machine learning model or a rules based approach. Rules based strategies for object drop may include:
Navigate the robot to a position 100 centimeters away from the side of a bin
Turn the robot in place to align it facing the bin
Drive toward the bin maintaining an alignment centered on the side of the bin.
Stop three centimeters from the side of the bin.
Verify that the robot is correctly positioned against the side of the bin
   If yes, lift the scoop up and back to drop target object(s) into the bin
   If no, drive away from bin and restart the process

Object drop strategies may involve navigating with a rear camera if attempting a back drop, or with the front camera if attempting a forward drop.

According to some examples, the method includes executing the drop strategy at block 4626. For example, the tidying robot 100 such as that introduced with respect to FIG. 1A may execute the drop strategy. The drop strategy may follow strategy steps for isolation strategy, pickup strategy, and drop strategy 4700 illustrated in FIG. 47. The drop strategy may be a reinforcement learning based strategy or a rules based strategy. Once the drop strategy has been executed at block 4626, the method may proceed to determining the next target object(s) at block 4628. For example, the robotic control system 2500 illustrated in FIG. 25 may determine next target object(s). Once new target object(s) have been determined, the process may be repeated for the new target object(s).

Strategies such as the isolation strategy, pickup strategy, and drop strategy referenced above may be simple strategies, or may incorporate rewards and collision avoidance elements. These strategies may follow general approaches such as the strategy steps for isolation strategy, pickup strategy, and drop strategy 4700 illustrated in FIG. 47.

In some embodiments, object isolation strategies may include:
Using pusher pad arms and pusher pads on the floor in a V-shape to surround object(s) and backing up
Precisely grasping the object(s) and backing up with pusher pad arms and pusher pads in a V-shape
Loosely rolling a large object away with pusher pad arms and pusher pads elevated
Spreading out dense clutter by loosely grabbing a pile and backing up
Placing a single pusher pad arm/pusher pad on the floor between target object(s) and clutter, then turning.
Putting small toys in the scoop, then dropping them to separate them
Using a single pusher pad arm/pusher pad to move object(s) away from a wall

In some embodiments, pickup strategies may include:
Closing the pusher pad arms/pusher pads on the floor to pick up a simple object
Picking up piles of small objects like small plastic building blocks by closing pusher pad arms/pusher pads on the ground
Picking up small, rollable objects like balls by batting them lightly on their tops with pusher pad arms/pusher pads, thus rolling them into the scoop
Picking up deformable objects like clothing using pusher pad arms/pusher pads to repeatedly compress the object(s) into the scoop
Grabbing an oversized, soft object like a large stuffed animal by grabbing and compressing it with the pusher pad arms/pusher pads
Grabbing a large ball by rolling it and holding it against the scoop with raised pusher pad arms/pusher pads
Picking up flat objects like puzzle pieces by passing the pusher pads over them sideways to cause instability
Grasping books and other large flat objects
Picking up clothes with pusher pad arms/pusher pads, lifting them above the scoop, and then dropping them into the scoop
Rolling balls by starting a first pusher pad arm movement and immediately starting a second pusher pad arm movement

In some embodiments, drop strategies may include:
Back dropping into a bin
Front dropping into a bin
Forward releasing onto the floor
Forward releasing against a wall
Stacking books or other flat objects
Directly dropping a large object using pusher pad arms/pusher pads instead of relying on the scoop

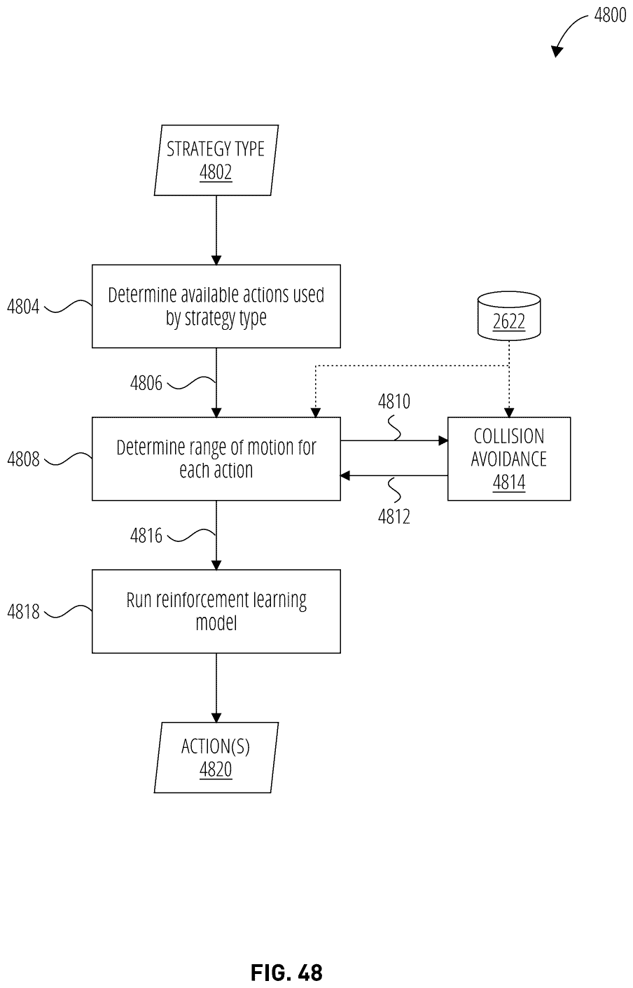

FIG. 47 illustrates strategy steps for isolation strategy, pickup strategy, and drop strategy 4700 in accordance with one embodiment. According to some examples, the method includes determining action(s) from a policy at block 4702. For example, the robotic control system 2500 illustrated in FIG. 25 may determine action(s) from the policy. The next action(s) may be based on the policy along with observations, current robot state, current object state, and sensor data 2622. The determination may be made through the process for determining an action from a policy 4800 illustrated in FIG. 48.

In one embodiment, strategies may incorporate a reward or penalty 4712 in determining action(s) from a policy at block 4702. These rewards or penalties 4712 may primarily be used for training the reinforcement learning model and, in some embodiments, may not apply to ongoing operation of the robot. Training the reinforcement learning model may be performed using simulations or by recording the model input/output/rewards/penalties during robot operation. Recorded data may be used to train reinforcement learning models to choose actions that maximize rewards and minimize penalties. In some embodiments, rewards or penalties 4712 for object pickup using reinforcement learning may include:
Small penalty added every second
Reward when target object(s) first touches edge of scoop
Reward when target object(s) pushed fully into scoop
Penalty when target object(s) lost from scoop
Penalty for collision with obstacle or wall (exceeding force feedback maximum)
Penalty for picking up non-target object
Penalty if robot gets stuck or drives over object

In some embodiments, rewards or penalties 4712 for object isolation (e.g., moving target object(s) away from a wall to the right) using reinforcement learning may include:
Small penalty added every second
Reward when right pusher pad arm is in-between target object(s) and wall
Reward when target object(s) distance from wall exceeds ten centimeters
Penalty for incorrectly colliding with target object(s).
Penalty for collision with obstacle or wall (exceeding force feedback maximum)
Penalty if robot gets stuck or drives over object

In some embodiments, rewards or penalties 4712 for object dropping using reinforcement learning may include:
Small penalty added every second
Reward when robot correctly docks against bin
Reward when target object(s) is successfully dropped into bin
Penalty for collision that moves bin
Penalty for collision with obstacle or wall (exceeding force feedback maximum)
Penalty if robot gets stuck or drives over object

In at least one embodiment, techniques described herein may use a reinforcement learning approach where the problem is modeled as a Markov decision process (MDP) represented as a tuple (S, O, A, P, r, γ), where S is the set of states in the environment, O is the set of observations, A is the set of actions, P: S×A×S is the state transition probability function, r: S×→ [symbol] is the reward function, and γ is a discount factor.

In at least one embodiment, the goal of training may be to learn a deterministic policy π: O→A such that taking action aₜ=π(oₜ) at time t maximizes the sum of discounted future rewards from state St:

$${R}_{t} = {\sum }_{i = t}^{∞} {γ}^{i - t} r ( {s}_{i} , {a}_{i} )$$

In at least one embodiment, after taking action aₜ, the environment transitions from state sₜ, to state sₜ₊₁ by sampling from P. In at least one embodiment, the quality of taking action at in state sₜ is measured by Q(sₜ, aₜ)=[Rₜ|sₜ, aₜ], known as the Q-function.

In one embodiment, data from a movement collision avoidance system 4714 may be used in determining action(s) from a policy at block 4702. Each strategy may have an associated list of available actions which it may consider. A strategy may use the movement collision avoidance system to determine the range of motion for each action involved in executing the strategy. For example, the movement collision avoidance system may be used to see if the scoop may be lowered to the ground without hitting the pusher pad arms or pusher pads (if they are closed under the scoop), an obstacle such as a nearby wall, or an object (like a ball) that may have rolled under the scoop.

According to some examples, the method includes executing action(s) at block 4704. For example, the tidying robot 100 such as that introduced with respect to FIG. 1A may execute the action(s) determined from block 4702. The actions may be based on the observations, current robot state, current object state, and sensor data 2622. the actions may be performed through motion of the robot motors and other actuators 4710 of the tidying robot 100. The real world environment 4716 may be affected by the motion of the tidying robot 100. The changes in the environment 4716 may be detected as described with respect to FIG. 26.

According to some examples, the method includes checking progress toward a goal at block 4706. For example, the robotic control system 2500 illustrated in FIG. 25 may check the progress of the tidying robot 100 toward the goal. If this progress check determines that the goal of the strategy has been met, or that a catastrophic error has been encountered at decision block 4708, execution of the strategy will be stopped. If the goal has not been met and no catastrophic error has occurred, the strategy may return to block 4702.

FIG. 48 illustrates process for determining an action from a policy 4800 in accordance with one embodiment. The process for determining an action from a policy 4800 may take into account a strategy type 4802, and may, at block 4804 determined the available actions to be used based on the strategy type 4802. Reinforcement learning algorithms or rules based algorithms may take advantage of both simple actions and pre-defined composite actions. Examples of simple actions controlling individual actuators may include:
Moving the left pusher pad arm to a new position (rotating up or down)
Moving the left pusher pad wrist to a new position (rotating left or right)
Moving the right pusher pad arm to a new position (rotating up or down)
Moving the right pusher pad wrist to a new position (rotating left or right)
Lifting the scoop to a new position (rotating up or down)
Changing the scoop angle (with a second motor or actuator for front dropping)
Driving a left wheel
Driving a right wheel

Examples of pre-defined composite actions may include:
Driving the robot following a path to a position/waypoint
Turning the robot in place left or right
Centering the robot with respect to object(s)
Aligning pusher pad arms with objects' top/bottom/middle
Driving forward until an object is against the edge of the scoop
Closing both pusher pad arms, pushing object(s) with a smooth motion
Lifting the scoop and pusher pad arms together while grasping object(s)
Closing both pusher pad arms, pushing object(s) with a quick tap and slight release
Setting the scoop lightly against the floor/carpet
Pushing the scoop down against the floor/into the carpet
Closing the pusher pad arms until resistance is encountered/pressure is applied and hold that position
Closing the pusher pad arms with vibration and left/right turning to create instability and slight bouncing of flat objects over scoop edge

At block 4808, the process for determining an action from a policy 4800 may take the list of available actions 4806 determined at block 4804, and may determine a range of motion 4812 for each action. The range of motion 4812 may be determined based on the observations, current robot state, current object state, and sensor data 2622 available to the robotic control system 2500. Action types 4810 may also be indicated to the movement collision avoidance system 4814, and the movement collision avoidance system 4814 may determine the range of motion 4812.

Block 4808 of process for determining an action from a policy 4800 may determine an observations list 4816 based on the ranges of motion 4812 determined. An example observations list 4816 may include:
Detected and categorized objects in the environment
Global or local environment map
State 1: Left arm position 20 degrees turned in
State 2: Right arm position 150 degrees turned in
State 3: Target object 15 centimeters from scoop edge
State 4: Target object 5 degrees right of center
Action 1 max range: Drive forward 1 centimeter max
Action 2 max range: Drive backward 10 centimeters max
Action 3 max range: Open left arm 70 degrees max
Action 4 max range: Open right arm 90 degrees max
Action 5 max range: Close left arm 45 degrees max
Action 6 max range: Close right arm 0 degrees max
Action 7 max range: Turn left 45 degrees max
Action 8 max range: Turn right 45 degrees max

At block 4818, a reinforcement learning model may be run based on the observations list 4816. The reinforcement learning model may return action(s) 4820 appropriate for the strategy the tidying robot 100 is attempting to complete based on the policy involved.

FIG. 49 depicts a robotics system 4900 in one embodiment. The robotics system 4900 receives inputs from one or more sensors 4902 and one or more cameras 4904 and provides these inputs for processing by localization logic 4906, mapping logic 4908, and perception logic 4910. Outputs of the processing logic are provided to the robotics system 4900 path planner 4912, pick-up planner 4914, and motion controller 4916, which in turn drives the system's motor and servo controller 4918.

The cameras may be disposed in a front-facing stereo arrangement, and may include a rear-facing camera or cameras as well. Alternatively, a single front-facing camera may be utilized, or a single front-facing along with a single rear-facing camera. Other camera arrangements (e.g., one or more side or oblique-facing cameras) may also be utilized in some cases.

One or more of the localization logic 4906, mapping logic 4908, and perception logic 4910 may be located and/or executed on a mobile robot, or may be executed in a computing device that communicates wirelessly with the robot, such as a cell phone, laptop computer, tablet computer, or desktop computer. In some embodiments, one or more of the localization logic 4906, mapping logic 4908, and perception logic 4910 may be located and/or executed in the “cloud”, i.e., on computer systems coupled to the robot via the Internet or other network.

The perception logic 4910 is engaged by an image segmentation activation 4944 signal, and utilizes any one or more of well-known image segmentation and objection recognition algorithms to detect objects in the field of view of the camera 4904. The perception logic 4910 may also provide calibration and objects 4920 signals for mapping purposes. The localization logic 4906 uses any one or more of well-known algorithms to localize the mobile robot in its environment. The localization logic 4906 outputs a local to global transform 4922 reference frame transformation and the mapping logic 4908 combines this with the calibration and objects 4920 signals to generate an environment map 4924 for the pick-up planner 4914, and object tracking 4926 signals for the path planner 4912.

In addition to the object tracking 4926 signals from the mapping logic 4908, the path planner 4912 also utilizes a current state 4928 of the system from the system state settings 4930, synchronization signals 4932 from the pick-up planner 4914, and movement feedback 4934 from the motion controller 4916. The path planner 4912 transforms these inputs into navigation waypoints 4936 that drive the motion controller 4916. The pick-up planner 4914 transforms local perception with image segmentation 4938 inputs from the perception logic 4910, the 4924 from the mapping logic 4908, and synchronization signals 4932 from the path planner 4912 into manipulation actions 4940 (e.g., of robotic graspers, scoops) to the motion controller 4916. Embodiments of algorithms utilized by the path planner 4912 and pick-up planner 4914 are described in more detail below.

In one embodiment simultaneous localization and mapping (SLAM) algorithms may be utilized to generate the global map and localize the robot on the map simultaneously. A number of SLAM algorithms are known in the art and commercially available.

The motion controller 4916 transforms the navigation waypoints 4936, manipulation actions 4940, and local perception with image segmentation 4938 signals to target movement 4942 signals to the motor and servo controller 4918.

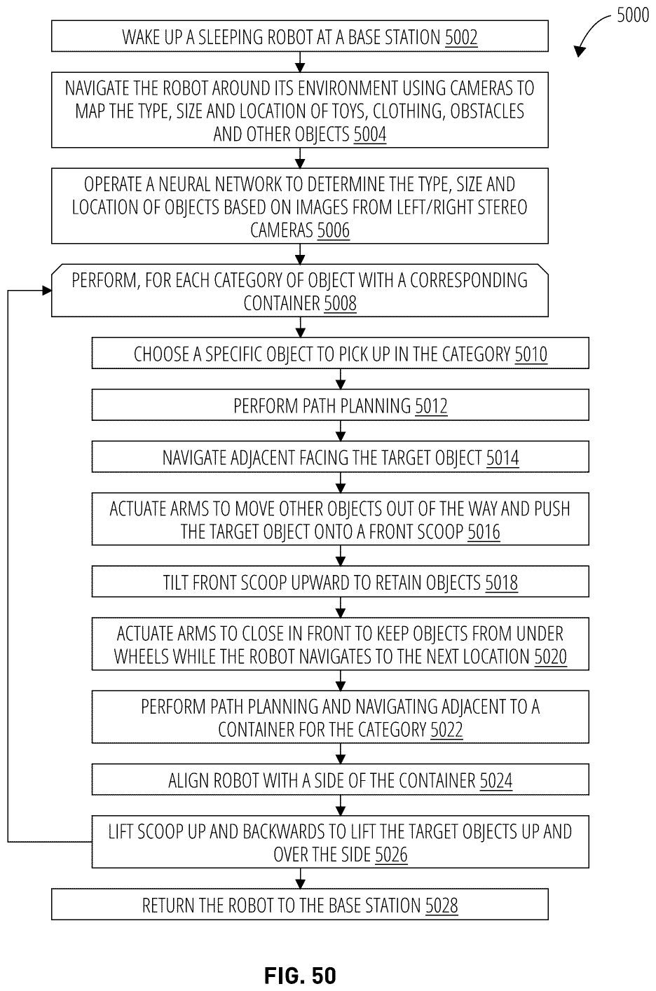

FIG. 50 depicts a robotic process 5000 in one embodiment. In block 5002, the robotic process 5000 wakes up a sleeping robot at a base station. In block 5004, the robotic process 5000 navigates the robot around its environment using cameras to map the type, size and location of toys, clothing, obstacles and other objects. In block 5006, the robotic process 5000 operates a neural network to determine the type, size and location of objects based on images from left/right stereo cameras. In opening loop block 5008, the robotic process 5000 performs, for each category of object with a corresponding container. In block 5010, the robotic process 5000 chooses a specific object to pick up in the category. In block 5012, the robotic process 5000 performs path planning. In block 5014, the robotic process 5000 navigates adjacent to and facing the target object. In block 5016, the robotic process 5000 actuates arms to move other objects out of the way and push the target object onto a front scoop. In block 5018, the robotic process 5000 tilts the front scoop upward to retain them on the scoop (creating a “bowl” configuration of the scoop). In block 5020, the robotic process 5000 actuates the arms to close in front to keep objects from under the wheels while the robot navigates to the next location. In block 5022, the robotic process 5000 performs path planning and navigating adjacent to a container for the current object category for collection. In block 5024, the robotic process 5000 aligns the robot with a side of the container. In block 5026, the robotic process 5000 lifts the scoop up and backwards to lift the target objects up and over the side of the container. In block 5028, the robotic process 5000 returns the robot to the base station.

In a less sophisticated operating mode, the robot may opportunistically picks up objects in its field of view and drop them into containers, without first creating a global map of the environment. For example, the robot may simply explore until it finds an object to pick up and then explore again until it finds the matching container. This approach may work effectively in single-room environments where there is a limited area to explore.

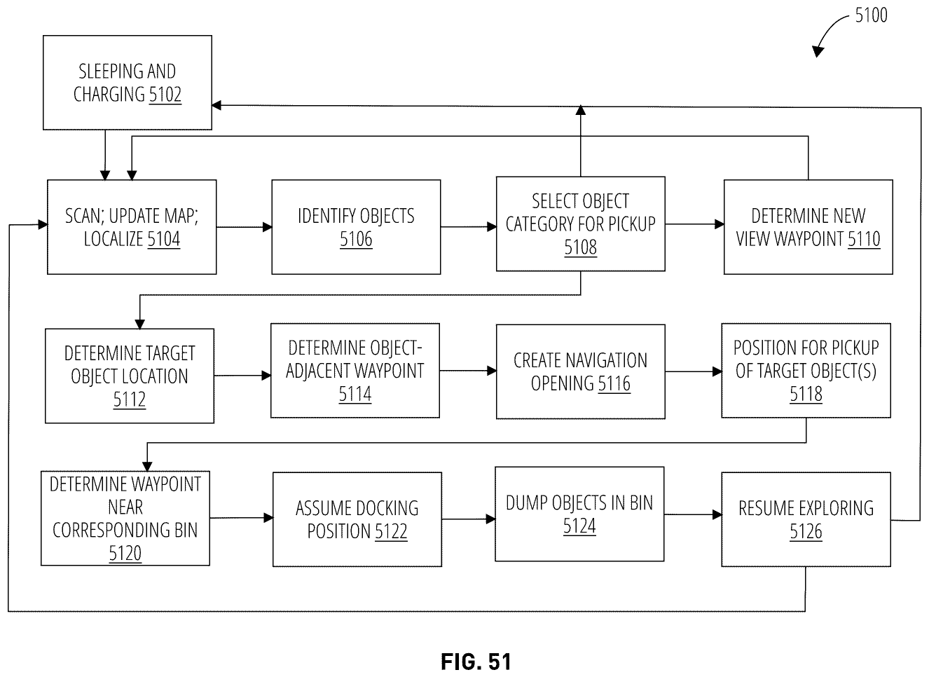

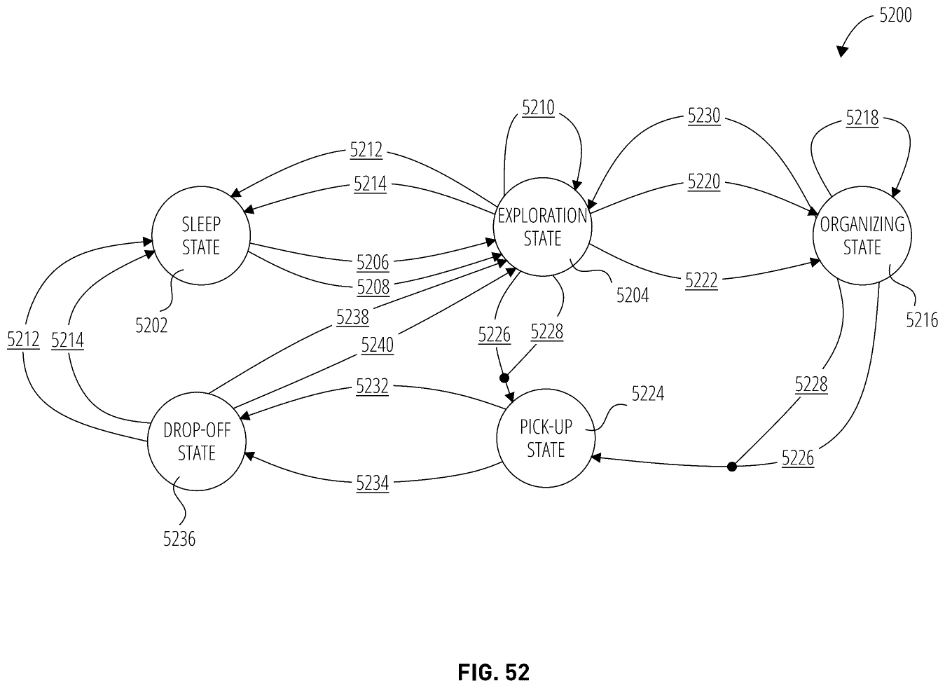

FIG. 51 also depicts a robotic process 5100 in one embodiment, in which the robotic system sequences through an embodiment of a state space map 5200 as depicted in FIG. 52.

The sequence begins with the robot sleeping (sleep state 5202) and charging at the base station (block 5102). The robot is activated, e.g., on a schedule, and enters an exploration mode (environment exploration state 5204, activation action 5206, and schedule start time 5208). In the environment exploration state 5204, the robot scans the environment using cameras (and other sensors) to update its environmental map and localize its own position on the map (block 5104, explore for configured interval 5210). The robot may transition from the environment exploration state 5204 back to the sleep state 5202 on condition that there are no more objects to pick up 5212, or the battery is low 5214.

From the environment exploration state 5204, the robot may transition to the object organization state 5216, in which it operates to move the items on the floor to organize them by category 5218. This transition may be triggered by the robot determining that objects are too close together on the floor 5220, or determining that the path to one or more objects is obstructed 5222. If none of these triggering conditions is satisfied, the robot may transition from the environment exploration state 5204 directly to the object pick-up state 5224 on condition that the environment map comprises at least one drop-off container for a category of objects 5226, and there are unobstructed items for pickup in the category of the container 5228. Likewise the robot may transition from the object organization state 5216 to the object pick-up state 5224 under these latter conditions. The robot may transition back to the environment exploration state 5204 from the object organization state 5216 on condition that no objects are ready for pick-up 5230.

In the environment exploration state 5204 and/or the object organization state 5216, image data from cameras is processed to identify different objects (block 5106). The robot selects a specific object type/category to pick up, determines a next waypoint to navigate to, and determines a target object and location of type to pick up based on the map of environment (block 5108, block 5110, and block 5112).

In the object pick-up state 5224, the robot selects a goal location that is adjacent to the target object(s) (block 5114). It uses a path planning algorithm to navigate itself to that new location while avoiding obstacles. The robot actuates left and right pusher arms to create an opening large enough that the target object may fit through, but not so large that other unwanted objects are collected when the robot drives forwards (block 5116). The robot drives forwards so that the target object is between the left and right pusher arms, and the left and right pusher arms work together to push the target object onto the collection scoop (block 5118).

The robot may continue in the object pick-up state 5224 to identify other target objects of the selected type to pick up based on the map of environment. If other such objects are detected, the robot selects a new goal location that is adjacent to the target object. It uses a path planning algorithm to navigate itself to that new location while avoiding obstacles, while carrying the target object(s) that were previously collected. The robot actuates left and right pusher arms to create an opening large enough that the target object may fit through, but not so large that other unwanted objects are collected when the robot drives forwards. The robot drives forwards so that the next target object(s) are between the left and right pusher arms. Again, the left and right pusher arms work together to push the target object onto the collection scoop.

On condition that all identified objects in category are picked up 5232, or if the scoop is at capacity 5234, the robot transitions to the object drop-off state 5236 and uses the map of the environment to select goal location that is adjacent to bin for the type of objects collected and uses a path planning algorithm to navigate itself to that new location while avoiding obstacles (block 5120). The robot backs up towards the bin into a docking position where back of the robot is aligned with the back of the bin (block 5122). The robot lifts the scoop up and backwards rotating over a rigid arm at the back of the robot (block 5124). This lifts the target objects up above the top of the bin and dumps them into the bin.

From the object drop-off state 5236, the robot may transition back to the environment exploration state 5204 on condition that there are more items to pick up 5238, or it has an incomplete map of the environment 5240. the robot resumes exploring and the process may be repeated (block 5126) for each other type of object in the environment having an associated collection bin.

The robot may alternatively transition from the object drop-off state 5236 to the sleep state 5202 on condition that there are no more objects to pick up 5212 or the battery is low 5214. Once the battery recharges sufficiently, or at the next activation or scheduled pick-up interval, the robot resumes exploring and the process may be repeated (block 5126) for each other type of object in the environment having an associated collection bin.

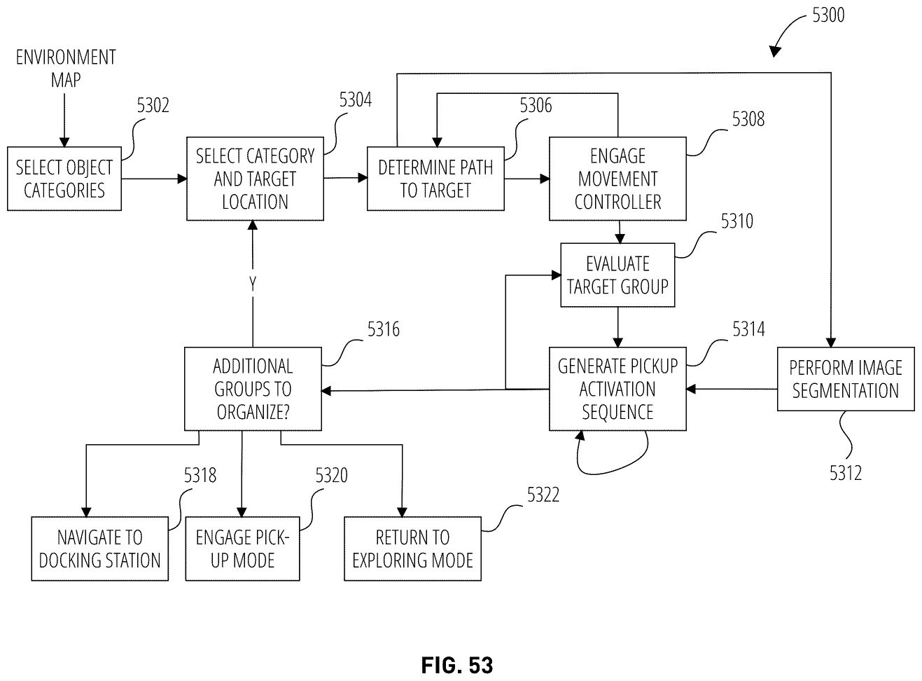

FIG. 53 depicts a robotic control algorithm 5300 for a robotic system in one embodiment. The robotic control algorithm 5300 begins by selecting one or more category of objects to organize (block 5302). Within the selected category or categories, a grouping is identified that determines a target category and starting location for the path (block 5304). Any of a number of well-known clustering algorithms may be utilized to identify object groupings within the category or categories.

A path is formed to the starting goal location, the path comprising zero or more waypoints (block 5306). Movement feedback is provided back to the path planning algorithm. The waypoints may be selected to avoid static and/or dynamic (moving) obstacles (objects not in the target group and/or category). The robot's movement controller is engaged to follow the waypoints to the target group (block 5308). The target group is evaluated upon achieving the goal location, including additional qualifications to determine if it may be safely organized (block 5310).

The robot's perception system is engaged (block 5312) to provide image segmentation for determination of a sequence of activations generated for the robot's manipulators (e.g., arms) and positioning system (e.g., wheels) to organize the group (block 5314). The sequencing of activations is repeated until the target group is organized, or fails to organize (failure causing regression to block 5310). Engagement of the perception system may be triggered by proximity to the target group. Once the target group is organized, and on condition that there is sufficient battery life left for the robot and there are more groups in the category or categories to organize, these actions are repeated (block 5316).

In response to low battery life the robot navigates back to the docking station to charge (block 5318). However, if there is adequate battery life, and on condition that the category or categories are organized, the robot enters object pick-up mode (block 5320), and picks up one of the organized groups for return to the drop-off container. Entering pickup mode may also be conditioned on the environment map comprising at least one drop-off container for the target objects, and the existence of unobstructed objects in the target group for pick-up. On condition that no group of objects is ready for pick up, the robot continues to explore the environment (block 5322).

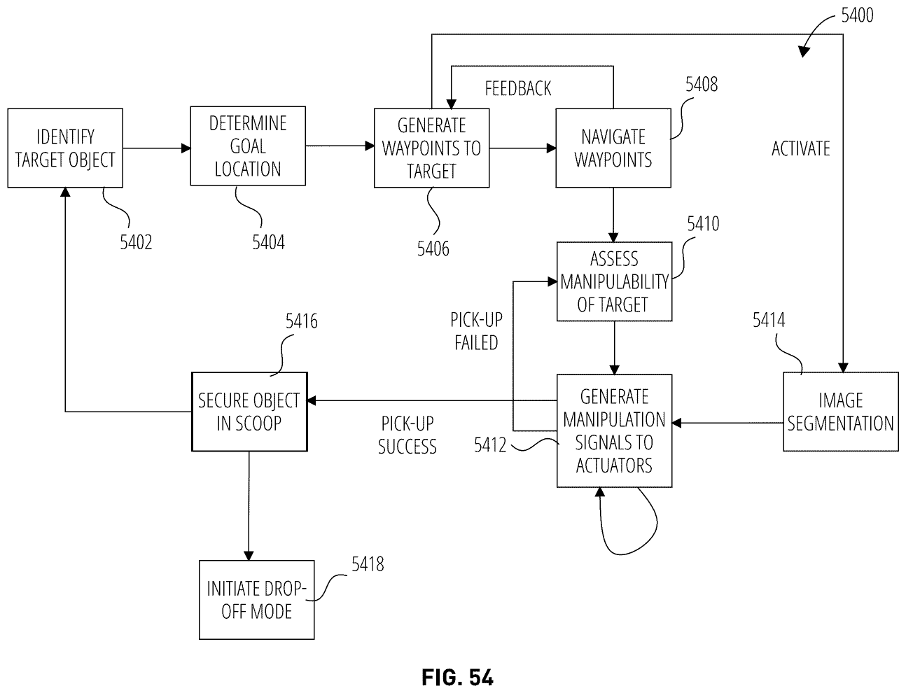

FIG. 54 depicts a robotic control algorithm 5400 for a robotic system in one embodiment. A target object in the chosen object category is identified (block 5402) and a goal location for the robot is determined as an adjacent location of the target object (block 5404). A path to the target object is determined as a series of waypoints (block 5406) and the robot is navigated along the path while avoiding obstacles (block 5408).

Once the adjacent location is reached, as assessment of the target object is made to determine if may be safely manipulated (block 5410). On condition that the target object may be safely manipulated, the robot is operated to lift the object using the robot's manipulator arm, e.g., scoop (block 5412). The robot's perception module may by utilized at this time to analyze the target object and nearby objects to better control the manipulation (block 5414).

The target object, once on the scoop or other manipulator arm, is secured (block 5416). On condition that the robot does not have capacity for more objects, or it's the last object of the selected category (ies), object drop-off mode is initiated (block 5418). Otherwise the robot may begin the process again at block 5402.

The following figures set forth, without limitation, exemplary cloud-based systems that may be used to implement at least one embodiment.

In at least one embodiment, cloud computing is a style of computing in which dynamically scalable and often virtualized resources are provided as a service over the Internet. In at least one embodiment, users need not have knowledge of, expertise in, or control over technology infrastructure, which may be referred to as “in the cloud,” that supports them. In at least one embodiment, cloud computing incorporates infrastructure as a service, platform as a service, software as a service, and other variations that have a common theme of reliance on the Internet for satisfying the computing needs of users. In at least one embodiment, a typical cloud deployment, such as in a private cloud (e.g., enterprise network), or a data center in a public cloud (e.g., Internet) may consist of thousands of servers (or alternatively, virtual machines (VMs)), hundreds of Ethernet, Fiber Channel or Fiber Channel over Ethernet (FCOE) ports, switching and storage infrastructure, etc. In at least one embodiment, cloud may also consist of network services infrastructure like IPsec virtual private network (VPN) hubs, firewalls, load balancers, wide area network (WAN) optimizers etc. In at least one embodiment, remote subscribers may access cloud applications and services securely by connecting via a VPN tunnel, such as an IPsec VPN tunnel.

In at least one embodiment, cloud computing is a model for enabling convenient, on-demand network access to a shared pool of configurable computing resources (e.g., networks, servers, storage, applications, and services) that may be rapidly provisioned and released with minimal management effort or service provider interaction.

In at least one embodiment, cloud computing is characterized by on-demand self-service, in which a consumer may unilaterally provision computing capabilities, such as server time and network storage, as needed automatically without need for human interaction with each service's provider. In at least one embodiment, cloud computing is characterized by broad network access, in which capabilities are available over a network and accessed through standard mechanisms that promote use by heterogeneous thin or thick client platforms (e.g., mobile phones, laptops, and personal digital assistants (PDAs)). In at least one embodiment, cloud computing is characterized by resource pooling, in which a provider's computing resources are pooled to serve multiple consumers using a multi-tenant model, with different physical and virtual resources dynamically assigned and reassigned according to consumer demand. In at least one embodiment, there is a sense of location independence in that a customer generally has no control or knowledge over an exact location of provided resources, but may be able to specify location at a higher level of abstraction (e.g., country, state, or datacenter). In at least one embodiment, examples of resources include storage, processing, memory, network bandwidth, and virtual machines. In at least one embodiment, cloud computing is characterized by rapid elasticity, in which capabilities may be rapidly and elastically provisioned, in some cases automatically, to quickly scale out and rapidly released to quickly scale in. In at least one embodiment, to a consumer, capabilities available for provisioning often appear to be unlimited and may be purchased in any quantity at any time. In at least one embodiment, cloud computing is characterized by measured service, in which cloud systems automatically control and optimize resource use by leveraging a metering capability at some level of abstraction appropriate to a type of service (e.g., storage, processing, bandwidth, and active user accounts). In at least one embodiment, resource usage may be monitored, controlled, and reported providing transparency for both a provider and consumer of a utilized service.

In at least one embodiment, cloud computing may be associated with various services. In at least one embodiment, cloud Software as a Service (SaaS) may refer to a service in which a capability provided to a consumer is to use a provider's applications running on a cloud infrastructure. In at least one embodiment, applications are accessible from various client devices through a thin client interface such as a web browser (e.g., web-based email). In at least one embodiment, the consumer does not manage or control underlying cloud infrastructure including network, servers, operating systems, storage, or even individual application capabilities, with a possible exception of limited user-specific application configuration settings.

In at least one embodiment, cloud Platform as a Service (PaaS) may refer to a service in which capability is provided to a consumer to deploy onto the cloud infrastructure consumer-created or acquired applications created using programming languages and tools supported by a provider. In at least one embodiment, a consumer does not manage or control underlying cloud infrastructure including networks, servers, operating systems, or storage, but has control over deployed applications and possibly application hosting environment configurations.

In at least one embodiment, cloud Infrastructure as a Service (IaaS) may refer to a service in which a capability provided to a consumer is to provision processing, storage, networks, and other fundamental computing resources where a consumer is able to deploy and run arbitrary software, which may include operating systems and applications. In at least one embodiment, a consumer does not manage or control underlying cloud infrastructure, but has control over operating systems, storage, deployed applications, and possibly limited control of select networking components (e.g., host firewalls).

In at least one embodiment, cloud computing may be deployed in various ways. In at least one embodiment, a private cloud may refer to a cloud infrastructure that is operated solely for an organization. In at least one embodiment, a private cloud may be managed by an organization or a third party and may exist on-premises or off-premises. In at least one embodiment, a community cloud may refer to a cloud infrastructure that is shared by several organizations and supports a specific community that has shared concerns (e.g., mission, security, policy, and compliance considerations). In at least one embodiment, a community cloud may be managed by organizations or a third party and may exist on-premises or off-premises. In at least one embodiment, a public cloud may refer to a cloud infrastructure that is made available to the general public or a large industry group and is owned by an organization providing cloud services. In at least one embodiment, a hybrid cloud may refer to a cloud infrastructure that is a composition of two or more clouds (private, community, or public) that remain unique entities but are bound together by standardized or proprietary technology that supports data and application portability (e.g., cloud bursting for load-balancing between clouds). In at least one embodiment, a cloud computing environment is service-oriented with a focus on statelessness, low coupling, modularity, and semantic interoperability.

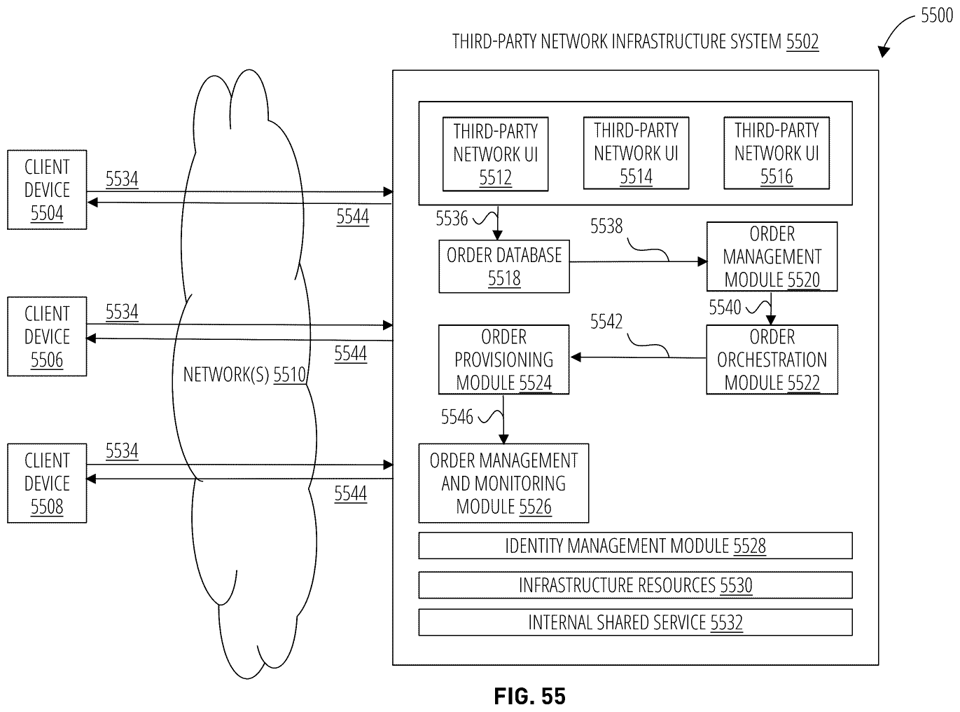

FIG. 55 illustrates one or more components of a system environment 5500 in which services may be offered as third-party network services, in accordance with at least one embodiment. In at least one embodiment, a third-party network may be referred to as a cloud, cloud network, cloud computing network, and/or variations thereof. In at least one embodiment, system environment 5500 includes one or more client computing devices 5504, 5506, and 5508 that may be used by users to interact with a third-party network infrastructure system 5502 that provides third-party network services, which may be referred to as cloud computing services. In at least one embodiment, third-party network infrastructure system 5502 may comprise one or more computers and/or servers.

It may be appreciated that third-party network infrastructure system 5502 depicted in FIG. 55 may have other components than those depicted. Further, FIG. 55 depicts an embodiment of a third-party network infrastructure system. In at least one embodiment, third-party network infrastructure system 5502 may have more or fewer components than depicted in FIG. 55, may combine two or more components, or may have a different configuration or arrangement of components.

In at least one embodiment, client computing devices 5504, 5506, and 5508 may be configured to operate a client application such as a web browser, a proprietary client application, or some other application, which may be used by a user of a client computing device to interact with third-party network infrastructure system 5502 to use services provided by third-party network infrastructure system 5502. Although exemplary system environment 5500 is shown with three client computing devices, any number of client computing devices may be supported. In at least one embodiment, other devices such as devices with sensors, etc. may interact with third-party network infrastructure system 5502. In at least one embodiment, network 5510 may facilitate communications and exchange of data between client computing devices 5504, 5506, and 5508 and third-party network infrastructure system 5502.

In at least one embodiment, services provided by third-party network infrastructure system 5502 may include a host of services that are made available to users of a third-party network infrastructure system on demand. In at least one embodiment, various services may also be offered including, without limitation, online data storage and backup solutions, Web-based e-mail services, hosted office suites and document collaboration services, database management and processing, managed technical support services, and/or variations thereof. In at least one embodiment, services provided by a third-party network infrastructure system may dynamically scale to meet the needs of its users.

In at least one embodiment, a specific instantiation of a service provided by third-party network infrastructure system 5502 may be referred to as a “service instance.” In at least one embodiment, in general, any service made available to a user via a communication network, such as the Internet, from a third-party network service provider's system is referred to as a “third-party network service.” In at least one embodiment, in a public third-party network environment, servers and systems that make up a third-party network service provider's system are different from a customer's own on-premises servers and systems. In at least one embodiment, a third-party network service provider's system may host an application, and a user may, via a communication network such as the Internet, on demand, order and use an application.

In at least one embodiment, a service in a computer network third-party network infrastructure may include protected computer network access to storage, a hosted database, a hosted web server, a software application, or other service provided by a third-party network vendor to a user. In at least one embodiment, a service may include password-protected access to remote storage on a third-party network through the Internet. In at least one embodiment, a service may include a web service-based hosted relational database and a script-language middleware engine for private use by a networked developer. In at least one embodiment, a service may include access to an email software application hosted on a third-party network vendor's website.

In at least one embodiment, third-party network infrastructure system 5502 may include a suite of applications, middleware, and database service offerings that are delivered to a customer in a self-service, subscription-based, elastically scalable, reliable, highly available, and secure manner. In at least one embodiment, third-party network infrastructure system 5502 may also provide “big data” related computation and analysis services. In at least one embodiment, the term “big data” is generally used to refer to extremely large data sets that may be stored and manipulated by analysts and researchers to visualize large amounts of data, detect trends, and/or otherwise interact with data. In at least one embodiment, big data and related applications may be hosted and/or manipulated by an infrastructure system on many levels and at different scales. In at least one embodiment, tens, hundreds, or thousands of processors linked in parallel may act upon such data in order to present it or simulate external forces on data or what it represents. In at least one embodiment, these data sets may involve structured data, such as that organized in a database or otherwise according to a structured model, and/or unstructured data (e.g., emails, images, data blobs (binary large objects), web pages, complex event processing). In at least one embodiment, by leveraging the ability of an embodiment to relatively quickly focus more (or fewer) computing resources upon an objective, a third-party network infrastructure system may be better available to carry out tasks on large data sets based on demand from a business, government agency, research organization, private individual, group of like-minded individuals or organizations, or other entity.

In at least one embodiment, third-party network infrastructure system 5502 may be adapted to automatically provision, manage and track a customer's subscription to services offered by third-party network infrastructure system 5502. In at least one embodiment, third-party network infrastructure system 5502 may provide third-party network services via different deployment models. In at least one embodiment, services may be provided under a public third-party network model in which third-party network infrastructure system 5502 is owned by an organization selling third-party network services, and services are made available to the general public or different industry enterprises. In at least one embodiment, services may be provided under a private third-party network model in which third-party network infrastructure system 5502 is operated solely for a single organization and may provide services for one or more entities within an organization. In at least one embodiment, third-party network services may also be provided under a community third-party network model in which third-party network infrastructure system 5502 and services provided by third-party network infrastructure system 5502 are shared by several organizations in a related community. In at least one embodiment, third-party network services may also be provided under a hybrid third-party network model, which is a combination of two or more different models.

In at least one embodiment, services provided by third-party network infrastructure system 5502 may include one or more services provided under Software as a Service (Saas) category, Platform as a Service (PaaS) category, Infrastructure as a Service (IaaS) category, or other categories of services including hybrid services. In at least one embodiment, a customer, via a subscription order, may order one or more services provided by third-party network infrastructure system 5502. In at least one embodiment, third-party network infrastructure system 5502 then performs processing to provide services in a customer's subscription order.

In at least one embodiment, services provided by third-party network infrastructure system 5502 may include, without limitation, application services, platform services, and infrastructure services. In at least one embodiment, application services may be provided by a third-party network infrastructure system via a SaaS platform. In at least one embodiment, the SaaS platform may be configured to provide third-party network services that fall under the SaaS category. In at least one embodiment, the SaaS platform may provide capabilities to build and deliver a suite of on-demand applications on an integrated development and deployment platform. In at least one embodiment, the SaaS platform may manage and control underlying software and infrastructure for providing SaaS services. In at least one embodiment, by utilizing services provided by a SaaS platform, customers may utilize applications executing on a third-party network infrastructure system. In at least one embodiment, customers may acquire application services without a need for customers to purchase separate licenses and support. In at least one embodiment, various different SaaS services may be provided. In at least one embodiment, examples include, without limitation, services that provide solutions for sales performance management, enterprise integration, and business flexibility for large organizations.

In at least one embodiment, platform services may be provided by third-party network infrastructure system 5502 via a PaaS platform. In at least one embodiment, the PaaS platform may be configured to provide third-party network services that fall under the PaaS category. In at least one embodiment, examples of platform services may include without limitation services that allow organizations to consolidate existing applications on a shared, common architecture, as well as an ability to build new applications that leverage shared services provided by a platform. In at least one embodiment, the PaaS platform may manage and control underlying software and infrastructure for providing PaaS services. In at least one embodiment, customers may acquire PaaS services provided by third-party network infrastructure system 5502 without a need for customers to purchase separate licenses and support.

In at least one embodiment, by utilizing services provided by a PaaS platform, customers may employ programming languages and tools supported by a third-party network infrastructure system and also control deployed services. In at least one embodiment, platform services provided by a third-party network infrastructure system may include database third-party network services, middleware third-party network services, and third-party network services. In at least one embodiment, database third-party network services may support shared service deployment models that allow organizations to pool database resources and offer customers a Database as a Service in the form of a database third-party network. In at least one embodiment, middleware third-party network services may provide a platform for customers to develop and deploy various business applications, and third-party network services may provide a platform for customers to deploy applications, in a third-party network infrastructure system.

In at least one embodiment, various different infrastructure services may be provided by an IaaS platform in a third-party network infrastructure system. In at least one embodiment, infrastructure services facilitate management and control of underlying computing resources, such as storage, networks, and other fundamental computing resources for customers utilizing services provided by a SaaS platform and a PaaS platform.

In at least one embodiment, third-party network infrastructure system 5502 may also include infrastructure resources 5530 for providing resources used to provide various services to customers of a third-party network infrastructure system. In at least one embodiment, infrastructure resources 5530 may include pre-integrated and optimized combinations of hardware, such as servers, storage, and networking resources to execute services provided by a Paas platform and a Saas platform, and other resources.

In at least one embodiment, resources in third-party network infrastructure system 5502 may be shared by multiple users and dynamically re-allocated per demand. In at least one embodiment, resources may be allocated to users in different time zones. In at least one embodiment, third-party network infrastructure system 5502 may allow a first set of users in a first time zone to utilize resources of a third-party network infrastructure system for a specified number of hours and then allow a re-allocation of the same resources to another set of users located in a different time zone, thereby maximizing utilization of resources.

In at least one embodiment, a number of internal shared services 5532 may be provided that are shared by different components or modules of third-party network infrastructure system 5502 to support the provision of services by third-party network infrastructure system 5502. In at least one embodiment, these internal shared services may include, without limitation, a security and identity service, an integration service, an enterprise repository service, an enterprise manager service, a virus scanning and white list service, a high availability, backup and recovery service, service for enabling third party network support, an email service, a notification service, a file transfer service, and/or variations thereof.

In at least one embodiment, third-party network infrastructure system 5502 may provide comprehensive management of third-party network services (e.g., SaaS, PaaS, and IaaS services) in a third-party network infrastructure system. In at least one embodiment, third-party network management functionality may include capabilities for provisioning, managing, and tracking a customer's subscription received by third-party network infrastructure system 5502, and/or variations thereof.

In at least one embodiment, as depicted in FIG. 55, third-party network management functionality may be provided by one or more modules, such as an order management module 5520, an order orchestration module 5522, an order provisioning module 5524, an order management and monitoring module 5526, and an identity management module 5528. In at least one embodiment, these modules may include or be provided using one or more computers and/or servers, which may be general-purpose computers, specialized server computers, server farms, server clusters, or any other appropriate arrangement and/or combination.

In at least one embodiment, at a service request step 5534, a customer using a client device, such as client computing devices 5504, 5506, or 5508, may interact with third-party network infrastructure system 5502 by requesting one or more services provided by third-party network infrastructure system 5502 and placing an order for a subscription for one or more services offered by third-party network infrastructure system 5502. In at least one embodiment, a customer may access a third-party network User Interface (UI) such as third-party network UI 5512, third-party network UI 5514, and/or third-party network UI 5516 and place a subscription order via these UIs. In at least one embodiment, order information received by third-party network infrastructure system 5502 in response to a customer placing an order may include information identifying a customer and one or more services offered by a third-party network infrastructure system 5502 that a customer intends to subscribe to.

In at least one embodiment, at a storing information step 5536, order information received from a customer may be stored in an order database 5518. In at least one embodiment, if this is a new order, a new record may be created for an order. In at least one embodiment, order database 5518 may be one of several databases operated by third-party network infrastructure system 5502 and operated in conjunction with other system elements.

In at least one embodiment, at a forwarding information step 5538, order information may be forwarded to an order management module 5520 that may be configured to perform billing and accounting functions related to an order, such as verifying an order, and upon verification, booking an order.

In at least one embodiment, at a communicating information step 5540, information regarding an order may be communicated to an order orchestration module 5522 that is configured to orchestrate the provisioning of services and resources for an order placed by a customer. In at least one embodiment, order orchestration module 5522 may use services of order provisioning module 5524 for provisioning. In at least one embodiment, order orchestration module 5522 supports the management of business processes associated with each order and applies business logic to determine whether an order may proceed to provisioning.

In at least one embodiment, at a receiving a new order step 5542, upon receiving an order for a new subscription, order orchestration module 5522 sends a request to order provisioning module 5524 to allocate resources and configure resources needed to fulfill a subscription order. In at least one embodiment, an order provisioning module 5524 supports an allocation of resources for services ordered by a customer. In at least one embodiment, an order provisioning module 5524 provides a level of abstraction between third-party network services provided by third-party network infrastructure system 5502 and a physical implementation layer that is used to provision resources for providing requested services. In at least one embodiment, this allows order orchestration module 5522 to be isolated from implementation details, such as whether or not services and resources are actually provisioned in real-time or pre-provisioned and allocated/assigned upon request.

In at least one embodiment, at a service provided step 5544, once services and resources are provisioned, a notification may be sent to subscribing customers indicating that a requested service is now ready for use. In at least one embodiment, information (e.g., a link) may be sent to a customer that allows a customer to start using the requested services.

In at least one embodiment, at a notification step 5546, a customer's subscription order may be managed and tracked by an order management and monitoring module 5526. In at least one embodiment, order management and monitoring module 5526 may be configured to collect usage statistics regarding a customer's use of subscribed services. In at least one embodiment, statistics may be collected for the amount of storage used, the amount of data transferred, the number of users, the amount of system up time and system down time, and/or variations thereof.

In at least one embodiment, third-party network infrastructure system 5502 may include an identity management module 5528 that is configured to provide identity services, such as access management and authorization services in third-party network infrastructure system 5502. In at least one embodiment, identity management module 5528 may control information about customers who wish to utilize services provided by third-party network infrastructure system 5502. In at least one embodiment, such information may include information that authenticates the identities of such customers and information that describes which actions those customers are authorized to perform relative to various system resources (e.g., files, directories, applications, communication ports, memory segments, etc.). In at least one embodiment, identity management module 5528 may also include management of descriptive information about each customer and about how and by whom that descriptive information may be accessed and modified.

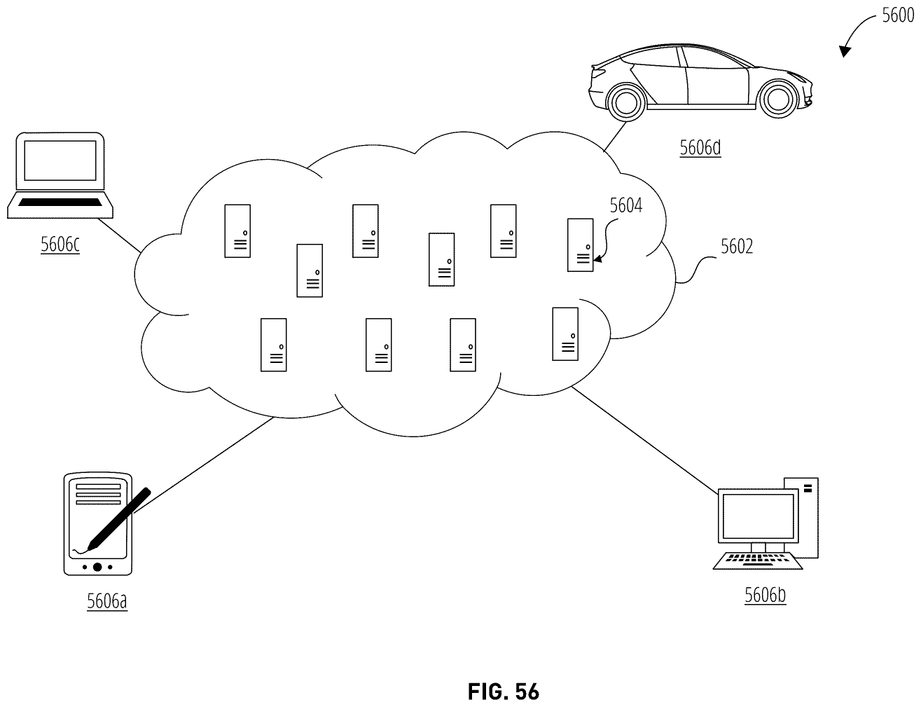

FIG. 56 illustrates a computing environment 5600 including cloud computing environment 5602, in accordance with at least one embodiment. In at least one embodiment, cloud computing environment 5602 comprises one or more computer systems/servers 5604 with which computing devices such as, personal digital assistant (PDA) or computing device 5606a, computing device 5606b, computing device 5606c, and/or computing device 5606d communicate. In at least one embodiment, this allows for infrastructure, platforms, and/or software to be offered as services from cloud computing environment 5602, so as to not require each client to separately maintain such resources. It is understood that the types of computing devices 5606a-5606d shown in FIG. 56 (a mobile or handheld device, a desktop computer, a laptop computer, and an automobile computer system) are intended to be illustrative, and that cloud computing environment 5602 may communicate with any type of computerized device over any type of network and/or network/addressable connection (e.g., using a web browser).

In at least one embodiment, a computer system/server 5604, which may be denoted as a cloud computing node, is operational with numerous other general purpose or special purpose computing system environments or configurations. In at least one embodiment, examples of computing systems, environments, and/or configurations that may be suitable for use with computer system/server 5604 include, but are not limited to, personal computer systems, server computer systems, thin clients, thick clients, hand-held or laptop devices, multiprocessor systems, microprocessor-based systems, set-top boxes, programmable consumer electronics, network personal computers (PCs), minicomputer systems, mainframe computer systems, and distributed cloud computing environments that include any of the above systems or devices, and/or variations thereof.

In at least one embodiment, computer system/server 5604 may be described in a general context of computer system-executable instructions, such as program modules, being executed by a computer system. In at least one embodiment, program modules include routines, programs, objects, components, logic, data structures, and so on, that perform particular tasks or implement particular abstract data types. In at least one embodiment, an exemplary computer system/server 5604 may be practiced in distributed cloud computing environments where tasks are performed by remote processing devices that are linked through a communications network. In at least one embodiment, in a distributed cloud computing environment, program modules may be located in both local and remote computer system storage media including memory storage devices.

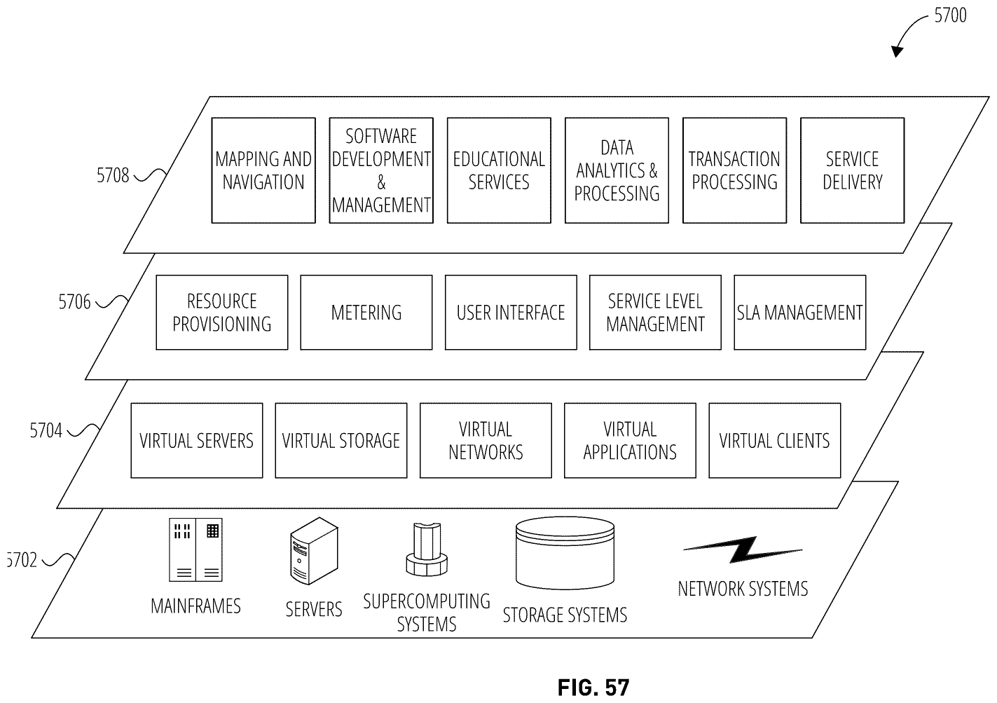

FIG. 57 illustrates a set of functional abstraction layers 5700 provided by cloud computing environment 5602 (FIG. 56), in accordance with at least one embodiment. It may be understood in advance that the components, layers, and functions shown in FIG. 57 are intended to be illustrative, and components, layers, and functions may vary.

In at least one embodiment, hardware and software layer 5702 includes hardware and software components. In at least one embodiment, examples of hardware components include mainframes, various RISC (Reduced Instruction Set Computer) architecture-based servers, various computing systems, supercomputing systems, storage devices, networks, networking components, and/or variations thereof. In at least one embodiment, examples of software components include network application server software, various application server software, various database software, and/or variations thereof.

In at least one embodiment, virtualization layer 5704 provides an abstraction layer from which the following exemplary virtual entities may be provided: virtual servers, virtual storage, virtual networks, including virtual private networks, virtual applications, virtual clients, and/or variations thereof.

In at least one embodiment, management layer 5706 provides various functions. In at least one embodiment, resource provisioning provides dynamic procurement of computing resources and other resources that are utilized to perform tasks within a cloud computing environment. In at least one embodiment, metering provides usage tracking as resources are utilized within a cloud computing environment, and billing or invoicing for consumption of these resources. In at least one embodiment, resources may comprise application software licenses. In at least one embodiment, security provides identity verification for users and tasks, as well as protection for data and other resources. In at least one embodiment, a user interface provides access to a cloud computing environment for both users and system administrators. In at least one embodiment, service level management provides cloud computing resource allocation and management such that the needed service levels are met. In at least one embodiment, Service Level Agreement (SLA) management provides pre-arrangement for, and procurement of, cloud computing resources for which a future need is anticipated in accordance with an SLA.

In at least one embodiment, workloads layer 5708 provides functionality for which a cloud computing environment is utilized. In at least one embodiment, examples of workloads and functions which may be provided from this layer include mapping and navigation, software development and management, educational services, data analytics and processing, transaction processing, and service delivery.

Various functional operations described herein may be implemented in logic that is referred to using a noun or noun phrase reflecting the operation or function. For example, an association operation may be carried out by an “associator” or “correlator”. Likewise, switching may be carried out by a “switch”, selection by a “selector”, and so on. “Logic” refers to machine memory circuits and non-transitory machine readable media comprising machine-executable instructions (software and firmware), and/or circuitry (hardware) which by way of its material and/or material-energy configuration comprises control and/or procedural signals, and/or settings and values (such as resistance, impedance, capacitance, inductance, current/voltage ratings, etc.), that may be applied to influence the operation of a device. Magnetic media, electronic circuits, electrical and optical memory (both volatile and nonvolatile), and firmware are examples of logic. Logic specifically excludes pure signals or software per se (however does not exclude machine memories comprising software and thereby forming configurations of matter).

Within this disclosure, different entities (which may variously be referred to as “units,” “circuits,” other components, etc.) may be described or claimed as “configured” to perform one or more tasks or operations. This formulation—[entity] configured to [perform one or more tasks]—is used herein to refer to structure (i.e., something physical, such as an electronic circuit). More specifically, this formulation is used to indicate that this structure is arranged to perform the one or more tasks during operation. A structure may be said to be “configured to” perform some task even if the structure is not currently being operated. A “credit distribution circuit configured to distribute credits to a plurality of processor cores” is intended to cover, for example, an integrated circuit that has circuitry that performs this function during operation, even if the integrated circuit in question is not currently being used (e.g., a power supply is not connected to it). Thus, an entity described or recited as “configured to” perform some task refers to something physical, such as a device, circuit, memory storing program instructions executable to implement the task, etc. This phrase is not used herein to refer to something intangible.

The term “configured to” is not intended to mean “configurable to.” An unprogrammed field programmable gate array (FPGA), for example, would not be considered to be “configured to” perform some specific function, although it may be “configurable to” perform that function after programming.

Reciting in the appended claims that a structure is “configured to” perform one or more tasks is expressly intended not to invoke 35 U.S.C. § 112(f) for that claim element. Accordingly, claims in this application that do not otherwise include the “means for” [performing a function] construct should not be interpreted under 35 U.S.C § 112(f).

As used herein, the term “based on” is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor that is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

As used herein, the phrase “in response to” describes one or more factors that trigger an effect. This phrase does not foreclose the possibility that additional factors may affect or otherwise trigger the effect. That is, an effect may be solely in response to those factors, or may be in response to the specified factors as well as other, unspecified factors. Consider the phrase “perform A in response to B.” This phrase specifies that B is a factor that triggers the performance of A. This phrase does not foreclose that performing A may also be in response to some other factor, such as C. This phrase is also intended to cover an embodiment in which A is performed solely in response to B.

As used herein, the terms “first,” “second,” etc. are used as labels for nouns that they precede, and do not imply any type of ordering (e.g., spatial, temporal, logical, etc.), unless stated otherwise. For example, in a register file having eight registers, the terms “first register” and “second register” may be used to refer to any two of the eight registers, and not, for example, just logical registers 0 and 1.

When used in the claims, the term “or” is used as an inclusive or and not as an exclusive or. For example, the phrase “at least one of x, y, or z” means any one of x, y, and z, as well as any combination thereof.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Having thus described illustrative embodiments in detail, it will be apparent that modifications and variations are possible without departing from the scope of the disclosure as claimed. The scope of disclosed subject matter is not limited to the depicted embodiments but is rather set forth in the following Claims.

What is claimed is:

1. A method comprising:
initializing a global map of an environment to be tidied with bounded areas;
navigating a tidying robot to a bounded area entrance;
identifying static objects, moveable objects, and tidyable objects within the bounded area;
identifying closed storage locations and open storage locations;
performing an identifying feature inspection subroutine;
performing a closed storage exploration subroutine;
performing an automated organization assessment subroutine;
developing non-standard location categories and non-standard location labels based on results from the identifying feature inspection subroutine, the closed storage exploration subroutine, and the automated organization assessment subroutine;
adding the non-standard location labels to the global map; and
applying the appropriate non-standard location labels as home location attributes for detected tidyable objects.

2. The method of claim 1, further comprising:
determining the bounded areas by detecting areas surrounded by static objects in the environment to be tidied.

3. The method of claim 1, further comprising:
updating a tidying strategy to include drop locations assigned the non-standard location labels in the global map; and
executing the tidying strategy.

4. The method of claim 1, further comprising:
displaying an augmented reality view of the global map of the environment to be tidied to a user; and
accepting a user input signal based on the augmented reality view indicating at least one of:
selection of a non-standard location displayed in the augmented reality view;
alteration of a non-standard location label displayed in the augmented reality view for the selected non-standard location;
selection of a tidyable object displayed in the augmented reality view; and
assignment of the non-standard location label for the selected non-standard location to the home location attributes of the selected tidyable object.

5. The method of claim 1, the identifying feature inspection subroutine comprising:
classifying each of the identified static objects, moveable objects, and tidyable objects within the bounded area by type;
determining characteristics of the identified objects;
selecting a base room type using classifications of the identified objects;
determining a prominence score for each of the identified objects;
selecting a prominent object from the identified objects; and
creating a non-standard location label for the bounded area using the base room type, the type of the prominent object, and the characteristics of the prominent object.

6. The method of claim 5, wherein the characteristics include at least one of color, size, shape, detected text, subject, super-type, type, and sub-type.

7. The method of claim 1, the closed storage exploration subroutine comprising:
navigating to a closed storage location;
opening the closed storage location;
maneuvering robot cameras to inspect shelves if present;
on condition the closed storage location has bins:
remove the bins and deposit bin contents onto a surface for inspection;
classifying tidyable objects and characterizing tidyable objects found in the closed storage location, thereby creating tidyable object classifications and tidyable object characteristics; and
creating a non-standard location label for the closed storage location based in part on the tidyable object classifications and the tidyable object characteristics.

8. The method of claim 7, the closed storage exploration subroutine further comprising:
performing the automated organization assessment subroutine for the closed storage location.

9. The method of claim 1, the automated organization assessment subroutine comprising:
identifying shelves or bins available for organizing;
determining how much space is available on the shelves or bins for organizing;
identifying tidyable objects to be organized;
moving tidyable objects to a staging area if needed;
classifying each of the tidyable objects to be organized by type;
determining the size of each of the tidyable objects to be organized;
determining characteristics of each of the tidyable objects to be organized;
algorithmically mapping the tidyable objects to be organized into related groups and into or on at least one location including the shelves, portions of the shelves, and the bins, based in part on the type, the size, and the characteristics of the tidyable objects to be organized; and
generating related non-standard location labels for the shelves, portions of the shelves, or the bins to which the groups of the tidyable objects are mapped.

10. The method of claim 9, wherein the tidyable objects are algorithmically mapped into related groups using constrained k-means clustering.

11. A tidying robotic system comprising:
a robot including:
a scoop;
pusher pad arms with pusher pads;
at least one of a hook on a rear edge of at least one pusher pad, a gripper arm with a passive gripper, and a gripper arm with an actuated gripper;
at least one wheel or one track for mobility of the robot;
robot cameras;
a processor; and
a memory storing instructions that, when executed by the processor, allow operation and control of the robot;
a robotic control system in at least one of the robot and a cloud server; and
logic, to:
initialize a global map of an environment to be tidied with bounded areas;
navigate the robot to a bounded area entrance;
identify static objects, moveable objects and tidyable objects within the bounded area;
identify closed storage locations and open storage locations;
perform an identifying feature inspection subroutine;
perform a closed storage exploration subroutine;
perform an automated organization assessment subroutine;
develop non-standard location categories and non-standard location labels based on results from the identifying feature inspection subroutine, the closed storage exploration subroutine, and the automated organization assessment subroutine;
add the non-standard location labels to the global map; and
apply the appropriate non-standard location labels as home location attributes for detected tidyable objects.

12. The tidying robotic system of claim 11, further comprising the logic to:
determine the bounded areas by detecting areas surrounded by static objects in the environment to be tidied.

13. The tidying robotic system of claim 11, further comprising the logic to:
update a tidying strategy to include drop locations assigned the non-standard location labels in the global map; and
execute the tidying strategy.

14. The tidying robotic system of claim 11, further comprising the logic to:
display an augmented reality view of the global map of the environment to be tidied to a user; and
accept a user input signal based on the augmented reality view indicating at least one of:
selection of a non-standard location displayed in the augmented reality view;
alteration of a non-standard location label displayed in the augmented reality view for the selected non-standard location;
selection of a tidyable object displayed in the augmented reality view; and
assignment of the non-standard location label for the selected non-standard location to the home location attributes of the selected tidyable object.

15. The tidying robotic system of claim 11, further comprising identifying feature inspection subroutine logic to:
classify each of the identified static objects, moveable objects, and tidyable objects within the bounded area by type;
determine characteristics of the identified objects;
select a base room type using classifications of the identified objects;
determine a prominence score for each of the identified objects;
select a prominent object from the identified objects; and
create a non-standard location label for the bounded area using the base room type, the type of the prominent object, and the characteristics of the prominent object.

16. The tidying robotic system of claim 15, wherein the characteristics include at least one of color, size, shape, detected text, subject, super-type, type, and sub-type.

17. The tidying robotic system of claim 11, further comprising closed storage exploration subroutine logic to:
navigate to a closed storage location;
open the closed storage location;
maneuver robot cameras to inspect shelves if present;
on condition the closed storage location has bins:
remove the bins and deposit bin contents onto a surface for inspection;
classify tidyable objects and characterizing tidyable objects found in the closed storage location, thereby creating tidyable object classifications and tidyable object characteristics; and
create a non-standard location label for the closed storage location based in part on the tidyable object classifications and the tidyable object characteristics.

18. The tidying robotic system of claim 17, the closed storage exploration subroutine logic further comprising:
perform the automated organization assessment subroutine for the closed storage location.

19. The tidying robotic system of claim 11, further comprising automated organization assessment subroutine logic to:
identify shelves or bins available for organizing;
determine how much space is available on the shelves or bins for organizing;
identify tidyable objects to be organized;
move tidyable objects to a staging area if needed;
classify each of the tidyable objects to be organized by type;
determine the size of each of the tidyable objects to be organized;
determine characteristics of each of the tidyable objects to be organized;
algorithmically map the tidyable objects to be organized into related groups and into or on at least one location including the shelves, portions of the shelves, and the bins, based in part on the type, the size, and the characteristics of the tidyable objects to be organized; and
generate related non-standard location labels for the shelves, portions of the shelves, or the bins to which the groups of the tidyable objects are mapped.

20. The tidying robotic system of claim 19, wherein the tidyable objects are algorithmically mapped into related groups using constrained k-means clustering.
